(19) United States
(12) Patent Application Publication
(10) Pub. No.: US 2026/0365420 A1
(43) Pub. Date: Nov. 19, 2026

(54) REFUSE BAG ROLL, REFUSE DISPOSAL SYSTEM, METHOD FOR DISPOSING OF REFUSE, AND METHOD FOR PROVIDING A REFUSE BAG ROLL

(71) Applicant: Marcus Trojan GmbH, Berlin (DE)

(72) Inventor: Marcus TROJAN, Berlin (DE)

(73) Assignee: Marcus Trojan GmbH, Berlin (DE)

(21) Appl. No.: 19/660,825

(22) Filed: Apr. 28, 2026

Related U.S. Application Data
(63) Continuation-in-part of application No. 18/847,474, filed on Mar. 12, 2024.

(30) Foreign Application Priority Data
Jul. 11, 2023 (EP) 23184832.6
Apr. 30, 2025 (EP) 25173652.6
Jun. 18, 2025 (EP) 25183625.0

(51) Int. Cl. B65F 1/00; G06K 19/06; G06Q 10/30

(52) U.S. Cl. CPC B65F 1/0006; B65F 1/0053; G06Q 10/30; B65F 2210/1123; B65F 2210/128; G06K 19/06037

(57) ABSTRACT

refuse bag roll comprises a plurality of refuse bags (10^{IV}) which have at least two refuse bag areas (16^{IV}-1, 16^{IV-}2, 16^{IV}-3 and 16^{IV}-4), which may be filled from a common side (“filling opening”), and which are each separable from the refuse bag non-destructively, so that the refuse bag areas (16^{IV}-1, 16^{IV-}2, 16^{IV}-3 and 16^{IV}-4) each form separate refuse bags after separation from the refuse bag.

The invention relates to a refuse bag roll, a refuse disposal system, a method for disposing of refuse and a method for providing a refuse bag roll.

Refuse bag rolls are generally known as household goods. An individual refuse bag may be separated from the open end of a refuse bag roll by means of a perforation or other material weakening. This other material weakening may be a thinning of a plastics material, for example. Normally, an individual refuse bag is separated by hand. However, the material weakening may also make it possible to cut the bag off using a tool such as a knife or scissors.

Such refuse bag rolls are typically manufactured in such a way that the individual refuse bags are each produced separately and then folded into sheets. These sheets are in turn fed to a joining device via feed tracks, where the sheets are joined one at a time to one another. Welding is a particularly suitable joining technique, for example by melting (with application of heat) and/or pressure welding (with application of pressure). The material weakening, such as the aforementioned perforation, is then introduced into the joint. This creates an endless strip of refuse bags. A strip with the desired number of refuse bags for the refuse bag roll is cut from this and wound up. A paper roll or similar is then applied to the wound-up refuse bags to prevent them from unwinding independently. Other fixing options are also possible. The individual refuse bags may have a certain complexity, for example it is regularly provided that a drawstring is provided at the top of an opening of the refuse bag and is guided in a guide and/or loops in order to pull the refuse bag closed after it has been filled and to hold it in the closed state.

The individual refuse bags on a refuse bag roll typically lie transversely to the length of the refuse bag roll, so that the later opening side of the refuse bag points to one side and the underside of the refuse bag, which is closed, points to the other side. The material weakenings extending transversely in relation to the refuse bag roll therefore separate the individual refuse bags on their long side. In principle, however, it is also possible to form refuse bag rolls in which the individual refuse bags are offset by 90°, that is to say in which the side of the refuse bag to be opened later is the side on which the material weakenings for separating the individual refuse bags are provided.

All of the above with regard to refuse bag rolls and refuse bags may be realized within the scope of the invention and in particular in embodiments.

DE 20 2021 103 927 U1 discloses a refuse bag roll which has film parts in several colours to enable a user to mark the filled refuse bags by colour and thus make it easier for the refuse disposal company to sort the refuse.

CN 107792564 a describes a refuse bag with a centre partition to form two container areas.

A refuse bag with two compartments is known from the CN 205312322 U.

It is the object of the present invention to promote waste separation and to provide improved refuse bags, refuse bag rolls, a refuse disposal system and a method for disposing of refuse.

The object is achieved by a refuse bag roll having the features according to claim 1, by a method for disposing of refuse having the features according to claim 13, and by a method for providing a refuse bag roll according to claim 14.

The refuse bag roll according to the invention thus comprises a plurality of refuse bags rolled up one after the other, which are separable from one another by material weakenings running in the transverse direction of the refuse bag roll. Here, each of the refuse bags has at least one filling opening for refuse and at least two refuse bag areas, which are fillable via the at least one filling opening. The refuse bag areas are each separable from the refuse bag non-destructively, so that the refuse bag areas form separate refuse bags after separation from the refuse bag.

The invention thus introduces a refuse bag as part of a refuse bag roll which, with several refuse bag areas, enables the separation of the refuse/waste already when filling the refuse bag. This means that the user does not need to have several individual bins with respective refuse bags, but may instead transfer one refuse bag from the refuse bag roll to a bin and sort different types of waste within the refuse bag. The option of separating the refuse bag areas to form individual, separate refuse bags means that the sorted waste collected may be disposed of separately according to sorting group. The fact that the refuse bag has at least two refuse bag areas may include that it has exactly two refuse bag areas or at least three refuse bag areas, the latter may include exactly three refuse bag areas or at least four refuse bag areas, the latter may include exactly four refuse bag areas or at least five refuse bag areas, the latter may include exactly five refuse bag areas or at least six refuse bag areas, of which again the latter may comprise exactly six refuse bag areas or at least seven refuse bag areas, of which again the latter may comprise exactly seven refuse bag areas or at least eight refuse bag areas, of which again the latter may comprise exactly eight refuse bag areas or at least nine refuse bag areas, of which again the latter may comprise exactly nine refuse bag areas or at least ten refuse bag areas, and so on.

According to advantageous embodiments of the invention, each refuse bag has a main bag wall and, provided on the main bag wall, at least one connecting wall, by means of which refuse bag areas are formed. The connecting walls run at least in sections in the longitudinal direction, thus enabling the insertion of refuse at a filling depth corresponding to the longitudinal direction, and a material weakening for non-destructive separation is formed at the connecting areas.

Advantages of this embodiment may be that a normal film may be provided as the main bag wall during manufacture, in particular also in the form of an individual bag, and the connecting walls may be attached subsequently (welded on, by means of welding with the application of heat and/or with the application of pressure).

According to one aspect, it may be provided that the main bag wall is an outer wall and the connecting wall has two layers (“double bag wall”), one of which, after separation, belongs to a first separate refuse bag and another of which belongs to a second separate refuse bag.

The advantages of these embodiments are that the refuse bag may be easily separable into several smaller refuse bag areas.

According to an alternative aspect, it is provided that all connecting walls are provided next to each other on one side of the main bag wall. This embodiment may be advantageous in terms of production, in particular it may be produced easily and therefore inexpensively.

According to other embodiments of the invention, each refuse bag may comprise a plurality of individual bags providing the refuse bag areas, wherein the individual bags are attached on one side to a common strip (preferably in the manner of a fold).

In this case, the individual bags are arranged like a booklet and are particularly preferably open on a side opposite the strip so that the individual bags may fan out. If necessary, a suitable bin may be provided for this purpose, in which only the strip needs to be attached and the individual bags may then be fanned out.

According to embodiments, the material weakenings are formed on the strip. The individual bags may be manufactured separately and welded together on the strip (application of heat and/or pressure), and at the same time the material weakening may be provided (e.g. by punching).

According to embodiments of the invention, the refuse bag areas of the refuse bags are configured differently.

On the one hand, at least two refuse bag areas may be designed in different sizes, in particular to take account of the fact that different types of refuse to be filled in, which are to be separated from each other, do not occur in equal quantities per type.

Alternatively or additionally, it is provided that at least two refuse bag areas of each refuse bag have different colours. Marking the individual refuse bag areas in different colours makes it easier for the user to separate the refuse. For example, the colour blue may stand for paper refuse, the colour brown for organic refuse, the colour yellow for plastic refuse, etc. If necessary, labelling may also be provided as an alternative or in addition.

According to another preferred embodiment with differently formed refuse bag areas, at least two refuse bag areas of each refuse bag are made of different materials. This may depend on the refuse to be disposed of. The materials may include at least two of plastic film, recycled plastic, compostable plastic, aluminium, paper, cellulose and hemp. The compostable plastic and/or hemp may be favourable for organic refuse, whereas it is not critical if plastic refuse, for its part, is provided in plastic film or recycled plastic. For paper refuse, the refuse bag area may be made of paper. An individual refuse bag area may also be made of different materials. For example, the refuse bag area for organic refuse may consist of or include compostable plastic in combination with a paper reinforcement. The optional drawstring may be made of a different material for refuse bag areas than the rest of the refuse bag area in question.

According to preferred embodiments of the invention, more types of refuse bags are provided in the refuse bag roll. There is thus at least one refuse bag that differs from other refuse bags. This aspect may also be regarded as an invention in itself, independently of the provision of the refuse bag areas, i.e. the invention described so far. In this aspect, first one type of refuse bag may be separated from the refuse bag roll and then another type of refuse bag. For example, one type of refuse bag may have several refuse bag areas, one of which is suitable for paper refuse and one for organic refuse; this may be accommodated in an organic refuse bin. Another refuse bag may be provided for plastic refuse, in which a special compartment (separate refuse bag area) is provided for glass.

According to other embodiments of the invention, the refuse bag areas are provided by individual bags which are connected to a material protrusion at least in one region on a side adjacent to the filling opening. In this case, the individual bags are arranged concentrically around the material protrusion and, particularly preferably, each individual bag has a filling opening, all of which are located on a side that is adjacent to the side that is connected to the material protrusion. Depending on the number, the individual bags could be fanned out in the shape of a multi-pronged star, i.e. a three-pronged star, a four-pronged star or a cross, a five-pronged star, etc. In this way, the individual bags could utilize the space around the material protrusion particularly efficiently. Once the individual bags have been fanned out, they are particularly easy to fill individually and then separate from the excess material non-destructively.

The connection to the material protrusion could have a material weakening, e.g. a perforation, with the help of which the individual bags may be easily separated. To further facilitate separation, it is also conceivable that the connection to the material protrusion only exists over a small region of the longitudinal axis. For example, the individual bags might be connected to the material protrusion only in one third, e.g. the centre third, of the longitudinal axis. If the individual bags are equipped with a drawstring, it would be possible, for example, to separate them by simply actuating the drawstring.

According to embodiments, it is provided that at least one of the individual bags has a folded bottom or a cross bottom on the side opposite the filling opening. This could increase the integral stability of the fanned-out refuse bag and allow it to stand upright on its own without additional fastening.

According to further embodiments in this regard, it is provided that, in the rolled-up form of the refuse bag roll, the outer and/or the inner individual bag has a connecting element which is configured to be able to detachably connect the outer and the inner individual bag to one another. In particular, one of the two individual bags has an adhesive surface, especially one with a removable protective layer. Instead of the adhesive surface, co-operating connecting elements such as hooks and eyelets made of refuse bag material on the two individual bags or loops or protrusions that may be knotted together are also conceivable. This could increase the stability of the refuse bag when fanned out by connecting the two individual bags that are directly next to each other after fanning out, thus preventing the fanned-out star from collapsing.

According to further embodiments, it is provided that at least one of the individual bags has a hole or a fastening element, in particular an adhesive surface or a loop, on the side opposite the connection to the material protrusion. In this way, the individual bags could be attached to the walls or corners of a container, for example, to further stabilize the star shape.

According to further embodiments, it is provided that the material protrusion on the side of the filling openings has a gripping element, in particular a loop. This makes it particularly easy to move all the individual bags at the same time, e.g. to remove them from a container.

According to other embodiments of the invention, at least one refuse bag and/or at least one refuse bag area has a device-readable information carrier, wherein the information carrier is in particular a QR code. Alternatively, the information carrier could also be a barcode or an NFC tag, for example. This would allow information regarding the use of refuse bags or individual bin areas to be stored individually.

According to embodiments, it is provided that the information carrier is configured to be able to cause a device reading the information carrier to output text information and/or to install or execute a software and/or to call up a website, or combinations thereof. In this case, the information carrier would have machine-readable instructions that may be executed on the device reading the information carrier, wherein information on refuse disposal could be received by the reading device and displayed by it. For example, such an information carrier could be in the form of a QR code and, by executing the machine-readable instructions, could cause the device reading the QR code to display a text stored in the QR code that contains information on the use of the refuse bags or, for example, on refuse disposal. In this way, the refuse bag/refuse bag area could facilitate access to information on its use for a large number of users.

Instead of a text stored in the QR code, it would also be conceivable that the machine-readable instructions first cause the device to receive a corresponding text via an Internet connection and to then output it. It would also be conceivable for the machine-readable instructions to first prompt the device to install software or to execute it if it has already been installed correspondingly. The software could then provide the user with information on the use of refuse bags or, for example, refuse disposal. The same applies to calling up a website that the machine-readable instructions prompt the device to access. The website could be used to provide the user with the relevant information.

The refuse disposal system according to the invention comprises a refuse bag roll, in which at least one refuse bag and/or at least one refuse bag area has a device-readable information carrier, and a portable electronic communication device, in particular a smartphone. The electronic communication device has means for reading the information carrier and means for outputting information. The electronic communication device is configured to be prompted, by reading the information carrier, to output text information and/or to install or execute software and/or call up a website. In this way, information regarding the use of the refuse bags could be made available to the user in a particularly simple and detailed manner, as smartphones with means for reading information carriers, e.g. NFC readers or cameras for capturing QR codes, are particularly widespread and typically have an Internet connection and a display, which makes it easier overall to provide the user with particularly up-to-date and detailed information regarding the use of the refuse bags.

According to embodiments, it is provided that by outputting the text information and/or executing the software and/or calling up the website, information on regulations on refuse disposal and/or information on refuse collection is output. This would make it easier to dispose of refuse in accordance with the applicable regulations and to collect refuse, as the relevant information could be made available to users reliably and repeatedly. For example, text information could be displayed to inform the user about the type of refuse areas or refuse bags for which individual refuse areas or refuse bags are intended and how or at what times the corresponding bags are collected or what costs are associated with disposal.

As the information available to the user could be stored individually, country- or region-specific information would also be possible, for example, as different countries/regions have different regulations regarding refuse disposal or different colour codes are used for the refuse bags of different types of waste. It is also conceivable that individual information could be provided for areas that are more restricted in terms of space, such as campsites or event sites, so that the information issued could be specific to this area. For example, a separate colour coding scheme could be defined for a campsite, e.g. blue for refuse paper, black for residual waste and green for organic waste. The collection times for the individual types of waste could be stored as information, along with a description of the items with which the respective bags may be filled. This text information could thus be retrieved particularly easily and repeatedly by people using the campsite.

If reading the information carrier causes the smartphone to install software, execute installed software or call up a website, the stored information could be individualized and kept up to date particularly easily, as the software or website itself could be adapted and the adapted information could be called up by reading the same information carrier.

According to further embodiments, it is provided that the portable electronic communication device has means for determining a device location and is configured to determine the device location before outputting the regulations for refuse disposal and/or the instructions for refuse collection and to be able to output the instructions for regulations for refuse disposal and/or the instructions for refuse collection depending on the determined device location. In this way, the user could be provided with country- or region-specific information on refuse disposal regulations and/or information on refuse collection based on the device location.

According to further embodiments, it is provided that the calling up of the website and/or the execution of the software initiated by reading the information carrier also comprises the entry of a value in a database. The value to be entered is linked here to the refuse bag/refuse bag area, for example. The database could be a central database outside the smartphone that the smartphone may access. A database within the software installed on the user's smartphone would also be conceivable. It is conceivable that values in the database could be used to generate statistics for the party that issues, produces or collects the refuse bags, e.g. how many bags of a certain type have already been used or disposed of. Based on such statistics, the design of the refuse bags could be optimized, for example by increasing the number of frequently used bags or enlarging these bags.

It is also conceivable that such a value could be used to enable payment transactions, e.g. for the purchase of individual refuse bags or a refuse bag roll or the disposal of individual refuse bags. A user account could be provided for this purpose, which the software or website could make available. This user account could be linked to the database. It would also be conceivable that the payment process for future refuse bags could be realized with the help of such a user account.

In this context, it is conceivable to provide the user with a refuse bag roll of which the bags and refuse bag areas are labelled with QR codes that are linked to the user's account from the outset. In this case, for example, the user could scan the QR codes of the individual refuse bag areas, e.g. before they are disposed of and thus create an entry in the database. The database could be a central database that is linked to the user account. A database within software installed on the user's smartphone and linked to the user account would also be conceivable. The values in the database could, for example, be used for individualized billing if, for example, the disposal of different refuse bags costs different amounts. This would allow billing to be based on the actual use of the individual refuse bag areas. For example, discounts for the use of certain refuse bags, e.g. for organic waste, could be offset against the costs for the use of other refuse bags, e.g. for residual waste. Instead of the bags and refuse bag areas with QR codes, which are linked to the user account of the user from the outset, it would also be conceivable that each individual refuse bag roll or each individual refuse bag has an individual QR code and by scanning such an individual QR code with the smartphone, the corresponding refuse bag roll/refuse bag is linked to a user account, usually to the user account of the smartphone that captures the QR code.

For example, the information carrier could be read by the user themself or by persons who come into contact with the bag to be disposed of, e.g. when receiving refuse bags at a campsite or event site. Instead of manual reading by such persons, the information carrier could also be read (semi-)automatically, for example by refuse transporters or refuse collection containers, each of which is equipped with a corresponding reader. In principle, such refuse collection containers could be imagined as being similar to an oversized deposit machine or even a self-service checkout with an attached refuse disposal container.

The entries in the database could be used to generate statistics, e.g. how many bags of a certain type the user has already used or disposed of and how their waste quantities or compliance with refuse disposal regulations compare to other users or the total number of users, which in turn could change the payment transactions or the amounts on which the payment transactions are based, e.g. through discounts or bonus points. It is conceivable that the user could receive discounts for future payment transactions or bonus points if they fulfil certain criteria, such as using or disposing of several refuse bags of one type. The individual use or disposal processes could be recorded, for example, by reading the information carrier or by manual entry by the user or a person receiving the refuse bag.

According to further embodiments, it is provided that calling up the website and/or executing the software also comprises executing a refuse disposal analysis application, wherein the refuse disposal analysis application is configured to be able to analyze the disposal of the refuse, in particular on the basis of user information or the entries in the database, depending on the regulations for refuse disposal. In this way, the analysis of waste quantities and disposal behaviour could be carried out particularly efficiently, as the disposal analysis could be triggered by the user and the resources of the smartphone could be used for the calculation. It is also conceivable that the disposal analysis takes into account device location data that was recorded by reading the information carrier when user details or values were entered in the database. This in turn would allow the refuse disposal analysis to be carried out with particular precision, i.e. in relation to the applicable regulations, as different refuse disposal regulations in different regions could be taken into account.

According to further embodiments, it is provided that calling up the website and/or executing the software also comprises executing a visual identification application, wherein the visual identification application is configured to be able to identify refuse items located on visual images. Identification could be carried out using image recognition algorithms or machine learning, for example. In this way, the user who visually captures waste objects, for example by photographing them with a smartphone, could be provided with targeted information on regulations for the disposal of the object. For example, a user who takes a photo of an aluminium drinks can could be provided with information on which refuse bag is intended for the can, when and where the bag may be collected, and the associated costs. Discounts or bonus points could also be awarded depending on the results of the identification processes. Instead of image recognition algorithms or machine learning, it would also be conceivable for the visual identification application to recognize the item using a barcode attached to it and determine the packaging material by comparing it with another database accessed by the software or the website, so that the packaging material may be used to determine which bag is intended for the item.

According to further embodiments, it is envisaged that the disposal of the refuse is alternatively or additionally analyzed on the basis of the identified refuse items. For example, the results of the identification processes could be used by the disposal analysis application. This could increase the quality of the data obtained using the disposal analysis application, as visual identification could compensate for incorrect user information.

The method for disposing of refuse according to the invention comprises:
providing a refuse bag having at least two compartments,
filling at least one of the compartments,
separating the filled compartment from the rest of the refuse bag,
transferring the filled compartment to a refuse bin/refuse container.

The separation of the filled compartment may be accompanied by the fact that a single additional compartment remains, which in turn has been filled and is moved to another type of refuse bin. However, separating the filled compartment may also mean that the remaining refuse bag remains for further filling. Preferably, differently filled compartments are filled with different types of refuse for the purpose of waste separation.

According to one embodiment, the following additional steps are provided:
providing a refuse disposal system according to the invention and
reading the information carrier.

In addition, the filled compartment is fed to a refuse disposal system depending on the regulations for refuse disposal and/or the instructions for refuse collection.

On the one hand, this could ensure that the user receives the relevant information on the regulations for refuse disposal or refuse collection in order to be able to fill the compartment in accordance with the regulations. On the other hand, by making the supply of refuse for disposal dependent on these regulations, it could be ensured that the disposal itself also complies with the regulations and thus the efficiency of refuse disposal could be increased.

The advantages of the methods result from the aforementioned advantages of the respective refuse bag rolls according to the invention.

The method according to the invention for providing a refuse bag roll of the type according to the invention comprises the fact that a user group and/or a usage period is (or are) determined, wherein for the user group and/or the usage period it is estimated on the basis of measurements which types of refuse occur in which quantities and a manufacturing instruction for a refuse bag roll is specified from at least two manufacturing instructions for different refuse bag rolls, each according to the type according to the invention, in such a way that the refuse bag areas of the refuse bags have colours and/or dimensions matching the estimated quantities. The method ends with the production of the refuse bag roll according to the specified manufacturing instructions. For example, a different refuse bag roll may be provided for a “private household with adults” user group than for a “private household with small children” user group, where the refuse bag roll must have a larger refuse bag area for residual waste (nappies). A distinction may also be made between a private household and a hotel as a user group, wherein a hotel is not typically expected to have a large amount of organic refuse, but more paper refuse. For example, in a refuse bag for hotels, a refuse bag area for organic refuse may be dispensed with completely and this refuse may be allocated to residual waste if necessary; refuse bag areas for plastic and glass may be combined into one refuse bag area, and the like. The utilization period may also determine which types of refuse occur and in which quantities. For example, more organic refuse may be expected in summer because more and/or better fruit is available, fresh vegetables are cooked more often, and the like.

According to another aspect of the present disclosure, which may be combined with one or more of the previously described embodiments, a refuse bag is disclosed which has at least one filling opening for refuse and at least two refuse bag areas, which are fillable via the at least one filling opening for the at least two refuse bag areas, wherein the refuse bag areas are each separable from the refuse bag non-destructively, so that the refuse bag areas each form separate individual refuse bags after separation from the refuse bag, wherein a plurality of the at least two refuse bag areas each have a device-readable information carrier, wherein at least one of the device-readable information carriers is readable only after at least partial separation of one of the refuse bag areas.

The invention thus introduces a refuse bag which, with a plurality of refuse bag areas, enables separation of the refuse/waste already when filling the refuse bag and could enable the user, by means of the information carriers attached to a plurality of the individual refuse bag areas, for example, to obtain information on the type of refuse for which the respective refuse bag area is intended and, in addition, to retrieve further information such as collection times or disposal costs. For example, the user could read out the respective information carrier with a smartphone and thereby call up text information or a linked website that could provide specific information on collection or fees for disposal of the refuse collected in the respective refuse bag area.

The information carrier could additionally be read out, for example, by a stationary reading device, in particular by a reading device attached to a container, or by a person receiving the refuse bag. In this case, it could for example be provided that insertion of an individual refuse bag into the container is possible only after the information carrier has been successfully read out, so that the information carrier could produce a type of access control. For example, the reading device could actuate a mechanism that releases an insertion opening only once a valid information carrier has been recognized. For example, instead of being read by a container or a person receiving the refuse bag, the information carrier could likewise be read by a refuse transporter, a refuse sorting facility, a recycling plant, or a refuse incineration plant. It could likewise be read by stationary or mobile automatic refuse acceptance stations, recyclable-material collection points, sorting installations, or interim storage installations for waste. The individual information carriers could for example be assigned to a specific user, in particular to a specific household. Reading the information carrier could enable identification of the user who inserts the individual refuse bag into the corresponding container. This identification could be used for various purposes, in particular for billing purposes. By virtue of the design of the refuse bag, which causes at least one of the device-readable information carriers to be readable only after at least partial separation of one of the refuse bag areas, effective protection against undesired reading-out of the information carrier could be realized.

Such a refuse bag could have the advantage that, by protecting the information carrier against undesired reading-out, it could be prevented that an unauthorized third person reads out the information carrier in order to gain unauthorized access to a container having access control. For example, a person could be prevented from introducing a separate individual refuse bag into a protected container without being authorized to do so.

Furthermore, by the protection against undesired reading-out it could be achieved that user-related information that would be displayed when the information carrier is read out, such as identification of the user by name or user identifier, could be protected against unauthorized disclosure to third parties. In this way, unauthorized capture and potential alteration of user information could be prevented.

Furthermore, the protection against undesired reading-out could provide the further advantage that manipulations of the refuse bag by feigning a valid information carrier would be made more difficult. For example, it could be prevented that a copied or reproduced information carrier is used to enable unauthorized insertion of refuse into protected disposal systems.

Furthermore, by the design in which separation of a refuse bag area is made a prerequisite for reading the associated information carrier, it could be brought about that the individual refuse bag areas intended for disposal are in fact separated from one another before they can, for example, be supplied as individual refuse bags to a container having corresponding access control. This could simplify subsequent disposal, in particular when using automated disposal installations, since manual or machine separation of the individual refuse bags could thereby be dispensed with there.

According to one example, it is provided that the one of the device-readable information carriers is non-volatilely writable only after at least partial separation of one of the refuse bag areas. This could have the advantage that storage of information, for example assignment of the refuse bag area to a user, for example for billing purposes, is enabled only once the refuse bag area has actually been separated, whereby manipulation or undesired pre-writing of the information carrier could be prevented. In this way, it could for example be ensured, from the user's perspective, that the refuse bag purchased by said user originates directly from manufacture and was not previously altered or manipulated by a third party. For example, this could prevent a harmful or defective code from being present on the information carrier which, when later read out by a user device such as a smartphone, causes malfunctions, damages the device, or initiates undesired functions.

According to one example, it is provided that the one of the device-readable information carriers is arranged on an outer wall of one of the refuse bag areas, which outer wall faces another of the refuse bag areas. This could have the advantage that the information carrier lies particularly protected between the corresponding refuse bag areas inside the refuse bag and is thus less easily accessible mechanically and optically, whereby the risk of unauthorized reading-out, writing, or damage could be further reduced.

According to one example, it is provided that the one of the device-readable information carriers is arranged in a cavity that is formed by a wall of the one refuse bag area and/or a wall of the other refuse bag area, wherein in particular it is provided that the cavity has an opening on a side facing away from the filling opening or is closed on all sides. This could have the advantage that manufacture of the refuse bag could be simplified, since already existing elements of the refuse bag, namely the walls of the refuse bag areas, could be used and no additional components would be required in order to implement corresponding protection against reading-out or writing of the information carrier before one of the refuse bag areas has been at least partially separated.

According to one example, it is provided that the refuse bag has a read and/or write protection element, wherein the read and/or write protection element shields the one of the information carriers against optical and/or magnetic and/or electromagnetic read-out. For example, the read and/or write protection element could be attached exclusively in the region in which an information carrier is located. It is likewise conceivable that such a read and/or write protection element is present, for example, on both sides or only on one side of the information carrier. For example, the read and/or write protection element could likewise be realized by the material of one of the refuse bag areas or by the material of the entire refuse bag. For example, an optically radiation-impermeable paper layer could be used as the read and/or write protection element, which prevents optical access to the information carrier by absorption and scattering of light waves. For example, the read and/or write protection element could be realized by means of a metal foil which, due to its conductive properties, reflects electromagnetic fields and thereby produces a Faraday shielding effect and additionally prevents optical access to the information carrier. For example, an electrically conductive plastics layer could likewise be provided, which absorbs or attenuates electromagnetic waves and thus prevents wireless communication. For example, the read and/or write protection element could be formed by a coating of metallized polymers which shields both electromagnetic and optical signals. Likewise, it could for example be provided that a multilayer composite material is used which has at least one metallic layer and one polymer-based layer and, through the combination of different materials, achieves broadband shielding against various attempts at reading and writing. This could have the advantage that protection against unauthorized reading-out or writing of the information carrier could be further improved.

In a further aspect, a further refuse bag is disclosed which has a device-readable information carrier, in particular a contactlessly writable information carrier, wherein the information carrier is configured to receive and non-volatilely store data regarding the contents of the refuse bag from a user device, wherein in particular it is provided that the information carrier is an RFID transponder, in particular an NFC chip. For example, the RFID transponder could be a separately manufactured chip that has been attached to the refuse bag. It would likewise be conceivable that the RFID transponder, in particular in the form of an NFC chip, is realized directly on the refuse bag as a stable polymer circuit by means of special printing methods. Such a refuse bag could have the advantage that refuse-type-specific data, such as composition, degree of homogeneity, or weight, could be stored reliably in a manner uniquely assigned to the refuse bag, whereby later automated identification and assignment of the refuse contents during disposal could be facilitated. In this case, the information carrier could for example be read out by a refuse container, a refuse transporter, a person receiving the refuse bag, or a refuse sorting facility, a recycling plant, a refuse incineration plant, a stationary or mobile capture system, an automatic refuse acceptance station, a recyclable-material collection point, a sorting installation, or an interim storage installation for waste, in order to retrieve the information assigned to the refuse bag regarding its contents and to control further treatment of the refuse bag depending on these data.

For example, refuse bags to which the user has assigned a certain content, such as batteries or accumulators, could, by means of the information stored in the information carrier and read out by an automated disposal installation, be guided directly into a corresponding section or subjected to treatment specific to the type of refuse. As a result, complicated identification of the contents of the respective refuse bag by the disposal installation could be dispensed with. In particular for refuse bags made of a light-impermeable material, the otherwise necessary opening of the refuse bag in order to identify the contents could be dispensed with or become necessary only at a later point in time within the disposal installation, which could further facilitate automated disposal. For example, the refuse bag would need to be opened only in a region of the disposal installation intended for the respective type of refuse and could there be examined by analysis devices specifically designed for this type of refuse. This could avoid the need for the refuse bag to be opened and examined already at the beginning of the disposal installation by a general analysis device, as is usually the case. A further advantage could be that, by the retrievable information regarding the contents of the refuse bag by means of the information carrier, refuse bags that are filled with hazardous refuse or dangerous substances, in particular substances hazardous to health or the environment, could be recognized quickly and reliably among other refuse bags having less dangerous contents but otherwise being identical. These refuse bags could thereby be specifically supplied to corresponding recycling paths or special disposal routes or guided into intended regions of containers or refuse sorting installations, so that safe and regulation-compliant treatment could be ensured.

A further advantage could likewise lie in that a plurality of refuse bags are manufactured identically and nevertheless may be used for different types of refuse, in that, by the assignment of the respective contents to the refuse bag enabled for the user via the information carrier, subsequent differentiation of the types of refuse is made possible. As a result, production costs of the refuse bag could be reduced, while at the same time flexibility in waste separation and disposal could be increased.

In one example in this regard, it is provided that the refuse bag has at least one filling opening for refuse and at least two refuse bag areas, which are fillable via the at least one filling opening for the at least two refuse bag areas, wherein the refuse bag areas are each separable from the refuse bag non-destructively, so that the refuse bag areas each form separate individual refuse bags after separation from the refuse bag, wherein the device-readable information carrier is arranged on a first of the at least two refuse bag areas and wherein additionally at least one further of the at least two refuse bag areas has a device-readable information carrier. This could have the advantage that separate capture and identification of the different refuse bag areas are enabled, whereby different types of refuse within a single original bag may be efficiently separated, assigned, and processed. For example, different types of refuse such as residual refuse, batteries, or recyclable plastics could already be captured separately upon filling, in that the respective contents of the individual refuse bag areas are stored by the user in the associated information carrier and thus assigned uniquely to the individual refuse bag areas. After separation of the refuse bag areas, the separate refuse bags formed therefrom could be supplied, by automated reading-out of the respective information carriers and without additional sorting effort, to specific disposal or recovery paths.

In a further aspect, a further refuse bag is disclosed having a device-readable information carrier, in particular an optically readable information carrier, wherein the information carrier is configured to cause a user device, as a result of reading the information carrier, to store data regarding the contents of the refuse bag in a database, wherein in particular the device-readable information carrier is a barcode, in particular a QR code. The user device could for example be a smartphone that has means for capturing an optical code, in particular a QR code. For example, the database could be a central database outside the smartphone, which the smartphone is able to access. A database within software installed on the user's smartphone would likewise be conceivable. It is furthermore conceivable that values stored in the database enable the creation of statistics for the party that issues, manufactures, or receives the refuse bags, for example regarding the type of refuse for which the refuse bags have been used. On the basis of such statistics, the design of the refuse bags could be optimized, in that, for example, the capacity, the material thickness, or the barrier properties of the refuse bags are adapted, since, for example, organic refuse, compared with paper refuse, places higher requirements on material thickness and barrier properties against water due to its generally higher density and higher moisture.

This could have the advantage that refuse-type-specific data, such as composition, degree of homogeneity, or weight, could be stored reliably in a manner uniquely assigned to the refuse bag, whereby later automated identification and assignment of the refuse contents during disposal could be facilitated. In this case, the information carrier could for example be read out by a refuse container, a refuse transporter, a person receiving the refuse bag, or a refuse disposal or recycling plant in order to retrieve the information assigned to the refuse bag regarding its contents and to make further treatment of the refuse bag dependent on these data. For example, refuse bags to which the user has assigned a certain content, such as batteries or accumulators, could, by means of the information stored in the information carrier and read out by an automated disposal installation, be guided directly into a corresponding section or subjected to treatment specific to the type of refuse. As a result, complicated identification of the contents of the respective refuse bag by the disposal installation could be dispensed with. In particular for refuse bags made of a light-impermeable material, the otherwise necessary opening of the refuse bag in order to identify the contents could be dispensed with or become necessary only at a later point in time within the disposal installation, which could further facilitate automated disposal. For example, the refuse bag would need to be opened only in a region of the disposal installation intended for the respective type of refuse and could there be examined by analysis devices specifically designed for this type of refuse. This could avoid the need for the refuse bag to be opened and examined already at the beginning of the disposal installation by a general analysis device, as is usually the case. A further advantage could be that, by the information regarding the contents of the refuse bag retrievable from the database, refuse bags that are filled with hazardous refuse or dangerous substances, in particular substances hazardous to health or the environment, could be recognized quickly and reliably among other refuse bags having less dangerous contents but otherwise being identical. These refuse bags could thereby be specifically supplied to corresponding recycling paths or special disposal routes or guided into intended regions of containers or refuse sorting installations, so that safe and regulation-compliant treatment could be ensured.

A further advantage could lie in that optically readable information carriers, such as QR codes, can be produced and/or attached to the refuse bag at low cost, for example by direct application by means of laser marking onto the refuse bag, by attaching a printed label, or by printing during the manufacturing process of the refuse bag itself, whereby the system as a whole could have lower production costs. Furthermore, optically readable information carriers could still be read out reliably even when they are partially damaged, which could increase robustness and reliability of capture. Furthermore, storage of the read-out data in a central database could allow linkage to a user account, whereby targeted traceability of refuse disposal could be enabled and, for example, user-based billing on the basis of the disposed types of refuse could be realized. A further advantage could likewise lie in that a plurality of refuse bags are manufactured identically and nevertheless may be used for different types of refuse, in that, by the assignment of the respective contents to the refuse bag enabled for the user via the information carrier, subsequent differentiation of the types of refuse is made possible. As a result, production costs of the refuse bag could be reduced, while at the same time flexibility in waste separation and disposal could be increased.

In one example in this regard, it is provided that the refuse bag has at least one filling opening for refuse and at least two refuse bag areas, which are fillable via the at least one filling opening for the at least two refuse bag areas, wherein the refuse bag areas are each separable from the refuse bag non-destructively, so that the refuse bag areas each form separate individual refuse bags after separation from the refuse bag, wherein the device-readable information carrier is arranged on a first of the at least two refuse bag areas and wherein additionally at least one further of the at least two refuse bag areas has a device-readable information carrier.

This could have the advantage that separate capture and identification of the different refuse bag areas are enabled, whereby different types of refuse within a single refuse bag may be efficiently separated, assigned, and processed. For example, different types of refuse such as residual refuse, batteries, or recyclable plastics could already be captured separately upon filling, in that the respective contents of the individual refuse bag areas are captured by reading-out of the associated information carrier by means of a user device and the associated data are stored in a database, so that contents could be uniquely assigned to the individual refuse bag areas. After separation of the refuse bag areas, the separate refuse bags formed therefrom could for example be read out, by automated reading-out of the respective information carriers, for example by a refuse container, a refuse transporter, a person receiving the refuse bag, or a refuse disposal or recycling plant, in order to retrieve the information assigned to the respective separate refuse bag regarding its contents and to control further treatment of the separate refuse bag depending on these data. For example, on the basis of the data retrieved from the database, the separate refuse bags could be supplied to specific disposal or recovery paths without additional sorting effort.

In a further aspect, a method for disposing of refuse is disclosed. The method comprises providing a refuse disposal installation with a reading device, providing a refuse bag with a device-readable information carrier, in particular a contactlessly writable information carrier, wherein the information carrier is configured to receive and non-volatilely store data regarding the contents of the refuse bag from a user device, wherein in particular the information carrier is an RFID transponder or an NFC chip. The method furthermore comprises providing a user device, wherein the user device has means for sending data regarding the contents of the refuse bag to the information carrier, filling the refuse bag by a user with refuse, sending data regarding the contents of the refuse bag by the user device to the information carrier, receiving the data regarding the contents of the refuse bag by the information carrier, non-volatilely storing the received data on the information carrier, supplying the filled refuse bag to the refuse disposal installation, reading the information carrier of the supplied refuse bag by the refuse disposal installation with the aid of the reading device in order to determine the data stored in the information carrier regarding the contents of the refuse bag, and processing the supplied refuse bag by the refuse disposal installation, wherein the processing takes place depending on the data regarding the contents of the refuse bag determined by reading the information carrier. For example, the user device could be a smartphone and the information carrier could be an RFID transponder, wherein the smartphone has a hardware and software combination for communication with the RFID transponder. For example, this hardware and software combination could comprise an integrated NFC reading device having writing functionality and also control software in order in particular to write data onto NFC-compatible RFID transponders, such as NFC chips.

For example, the refuse disposal installation could be a stationary system, such as a refuse container, or a mobile system, such as a refuse transporter, which has a reading device configured to read out RFID transponders, in particular NFC-compatible RFID transponders such as NFC chips, contactlessly. For example, the reading device could comprise an NFC reading device suitable for reading, in particular contactlessly, NFC-compatible RFID transponders such as NFC chips.

This could have the advantage that capture and further processing of the refuse bags can be designed particularly efficiently, since the necessary information regarding the contents of the refuse bag is available immediately when the refuse bag is supplied and can be used for further processing of the refuse, whereby manual capture or sorting could be dispensed with to a large extent or at least their frequency could be significantly reduced.

In one example in this regard, a refuse bag is provided in the step of providing the refuse bag, the refuse bag having at least one filling opening for refuse and at least two refuse bag areas, wherein the refuse bag areas are fillable via the at least one filling opening for the at least two refuse bag areas, wherein the refuse bag areas are each separable from the refuse bag non-destructively, so that the refuse bag areas each form separate individual refuse bags after separation from the refuse bag, wherein the device-readable information carrier is arranged on a first of the at least two refuse bag areas, and wherein additionally at least one further of the at least two refuse bag areas has a device-readable information carrier. Furthermore, in the step of filling the provided refuse bag, the first of the at least two refuse bag areas is filled, wherein the first refuse bag area is separated in order to form a separate individual refuse bag, and wherein the data regarding the contents of the refuse bag are data regarding the contents of the separate individual refuse bag formed by the separation. Furthermore, the refuse bag that is supplied to the refuse disposal installation, the information carrier of which is read out by the refuse disposal installation, the associated data regarding the contents of which are retrieved from a database, and which is subsequently processed by the refuse disposal installation, is the previously separated separate individual refuse bag.

The advantages of the method described above can likewise be transferred to this example, wherein the additional advantage could be achieved that different types of refuse may already be separated upon filling and each treated separately, without the user having to keep, for example, a plurality of individual waste bins with respective refuse bags, whereby the efficiency of waste separation and later disposal could be further improved.

In a further aspect, a method for disposing of refuse is disclosed. The method comprises providing a refuse disposal installation with a reading device, providing a refuse bag with a device-readable information carrier, in particular an optically readable information carrier, wherein the information carrier is configured to cause a user device, as a result of reading the information carrier, to store data regarding the contents of the refuse bag in a database, wherein in particular the device-readable information carrier is a barcode, in particular a QR code, wherein additionally a unique identifier is stored in the information carrier. The method furthermore comprises providing a user device, wherein the user device has means for reading the information carrier and means for storing data regarding the contents of the refuse bag in a database. The method moreover comprises filling the refuse bag with refuse by a user, reading the information carrier by the user device in order to determine the unique identifier stored in the information carrier, and storing data regarding the contents of the refuse bag in a database by the user device with the determined unique identifier as a database access key, wherein in particular the database is a distributed ledger, in particular a blockchain. Furthermore, the method comprises supplying the filled refuse bag to the refuse disposal installation, reading the information carrier by the refuse disposal installation with the aid of the reading device in order to determine the unique identifier stored in the information carrier, retrieving the data stored in the database regarding the contents of the refuse bag by the refuse disposal installation on the basis of the determined unique identifier, and processing the refuse bag by the refuse disposal installation, wherein the processing takes place depending on the data retrieved from the database.

This could have the advantage that implementation of reading-out of the optically readable information carrier can be realized particularly simply, since refuse disposal installations, such as refuse sorting or refuse incineration plants, usually already have camera-based capture systems for the refuse itself, so that capture of the information carrier could be realized particularly easily and inexpensively, for example by using analysis software that evaluates the image data that is available anyway and can thereby read the information carrier. Furthermore, a further advantage could lie in that storage of the information regarding the contents of the refuse bag in a database creates the basis for systematic evaluation and optimization of refuse disposal, since the collected data records could enable analysis of usage patterns, refuse compositions, and disposal behavior.

In one example in this regard, in the step of providing the refuse bag, a refuse bag is provided having at least one filling opening for refuse and at least two refuse bag areas, wherein the refuse bag areas are fillable via the at least one filling opening for the at least two refuse bag areas, wherein the refuse bag areas are each separable from the refuse bag non-destructively, so that the refuse bag areas each form separate individual refuse bags after separation from the refuse bag, wherein the device-readable information carrier is arranged on a first of the at least two refuse bag areas, and wherein additionally at least one further of the at least two refuse bag areas has a device-readable information carrier. Furthermore, in the step of filling the provided refuse bag, the first of the at least two refuse bag areas is filled, wherein the first refuse bag area is separated in order to form a separate individual refuse bag, and wherein the data regarding the contents of the refuse bag are data regarding the contents of the separate individual refuse bag formed by the separation. The advantages of the method described above can likewise be transferred to this example, wherein the additional advantage could be achieved that different types of refuse may already be separated upon filling and each treated separately, without the user having to keep, for example, a plurality of individual waste bins with respective refuse bags, whereby the efficiency of waste separation and later disposal could be further improved.

In a further example, a method is disclosed that additionally comprises providing an electronic account system, wherein in the electronic account system a user account is uniquely assigned to a user and wherein the electronic account system is connected to the refuse disposal installation. Furthermore, the method comprises identifying the user by the refuse disposal installation in order to determine the user account uniquely assigned to the user in the account system. The method moreover comprises assigning the refuse bag supplied to the refuse disposal installation and the data regarding its contents to the determined user account by the refuse disposal installation by means of an entry in the electronic account system. In particular, the method comprises outputting a message to the user by the user device or the refuse disposal installation indicating that the supplied refuse bag has been assigned to the user account, wherein the message in particular contains information as to which contents have been assigned to the refuse bag.

Due to the unique assignment of the refuse bag supplied to the refuse disposal installation to a user on the basis of the unique identifier stored in the refuse bag and determined by the refuse disposal installation, as well as the information regarding the contents of the refuse bag assigned to the user account in the electronic account system, payment transactions could for example be realized in that fees for disposal of the respective types of refuse bag would be assigned to the respective user account. Likewise, user-specific billing could be enabled on the basis of the information stored in the electronic account system, in which, for example, actual use of certain types and quantities of refuse bags would be taken into account.

Furthermore, statistics could for example be created on the basis of the assignment of refuse bag contents and user in the electronic account system, which statistics could for example make statements regarding the frequency of use of certain types of refuse bags or compliance with disposal regulations by the respective user. For example, these statistics could be made available to the user in order to provide said user, for example, with a graphical overview of said user's refuse-generation and refuse-disposal activities, thereby creating increased awareness that as little refuse as possible should arise and that, if it does arise, it should be disposed of in accordance with the applicable regulations. For example, these statistics could be used in order to offer individual incentives such as discounts or bonus programs for a certain disposal practice.

By outputting a message to the user by the user device or the refuse disposal installation, which message could in particular contain information on the type of refuse contents assigned to the user account, the reliability of the disposal process could be increased, since the user receives direct feedback on the successful assignment and any errors could thus be recognized and corrected more quickly.

For example, the electronic account system could furthermore be used in that the user carries out payment transactions, in that digital or real goods or services could be paid for via the user account, whereby linkage of the refuse disposal services with further billing processes would be enabled.

Furthermore, the unique assignment in the electronic account system could for example be used in order to support optimization of disposal and recovery processes, in that, for example, refuse-type-specific quantity capture and distribution patterns are determined on the user level and used to improve logistics or disposal infrastructure.

Such a method could have the advantage that a particularly reliable and traceable linkage of disposal processes with individual user accounts is enabled, whereby transparency, traceability, and reliability in refuse disposal could be improved. For example, this could enable targeted evaluation and analysis of waste separation and waste recovery on an individual user basis, which could support development of more efficient disposal systems. Likewise, the method could contribute to fairer cost allocation in refuse disposal, since individual billing could be enabled on the basis of actual use. Furthermore, the method could increase users' motivation to separate refuse properly, in that direct feedback and, if appropriate, reward for regulation-compliant behavior could be provided by the account system.

In one example in this regard, it is provided that the electronic account system comprises a distributed ledger, in particular a blockchain, wherein the entry in the electronic account system is generated or secured using a cryptographically secured token. This could have the advantage that user data and disposal data could be stored in a particularly tamper-resistant manner through use of a distributed ledger, in particular a blockchain, since subsequent changes to the stored entries would be technically considerably hindered or excluded. For example, the stored data could moreover be substantially anonymized, in that the assignment between user identity and refuse bag contents is effected exclusively via cryptographically secured tokens, without direct clear data having to be stored in the blockchain. For example, payment transactions for disposal services could likewise be carried out particularly efficiently and reliably, in that the transactions could be uniquely proven and automatically processed by means of cryptographically secured tokens. Furthermore, the decentralized structure of a distributed ledger could increase system availability and failure safety, since no central instance would be required for managing the disposal data. Finally, the immutable and chronologically traceable storage of all entries in a distributed ledger could enable efficient subsequent analysis and evaluation of the disposal and billing processes. For example, by the use of cryptographically secured tokens, payment transactions or allocations of value between different parties or systems could be realized particularly simply, securely, and across systems, since a standardized and verifiable transactional basis would be created.

In a further aspect, a refuse bag roll is disclosed having a plurality of refuse bags rolled up one after the other according to the examples described above, wherein the refuse bags are separable from one another by material weakenings extending in the transverse direction of the refuse bag roll and wherein the refuse bags lie in the refuse bag roll transversely to the longitudinal extension thereof, so that the opening side of the refuse bags points to one side. This could have the advantage that a particularly close and efficient coupling between refuse capture, data storage, and disposal control could be achieved, whereby complete digital traceability of the waste streams could be enabled. For example, the user device could be realized by a smartphone or a tablet, whereby, due to the widespread use of these mobile devices, many users might already be in possession of a suitable device and the refuse disposal system could thereby in many cases be implemented already by providing a corresponding refuse bag without further complicated infrastructure measures.

Furthermore, the features and advantages relating to the refuse bags may likewise be transferred accordingly to the methods for disposing of refuse, so that further repetition is dispensed with at this point.

Furthermore, the features and advantages relating to the refuse bags may likewise be transferred accordingly to the refuse bag roll, so that further repetition is dispensed with at this point.

Furthermore, the features and advantages relating to the refuse bags may likewise be transferred accordingly to the refuse disposal system, so that further repetition is dispensed with at this point.

According to another aspect of the present disclosure, which may be combined with one or more of the previously described embodiments, a refuse bag is disclosed having at least one filling opening for refuse and at least two refuse bag areas, wherein the refuse bag areas are fillable via the at least one filling opening for the at least two refuse bag areas, wherein the refuse bag areas are each separable from the refuse bag non-destructively, so that the refuse bag areas each form separate individual refuse bags after separation from the refuse bag, wherein the refuse bag areas are connected to one another by a releasable adhesive bond comprising an adhesive, wherein the releasable adhesive bond is releasable by contactless energy input, in particular by action of electromagnetic radiation, in particular UV, IR, or microwave radiation, wherein the contactless energy input causes a chemical reaction with at least partial degradation of the adhesive and/or a phase transition and/or a reduction in viscosity and/or a change in crystallinity and/or a change in surface tension of the adhesive. It may for example be provided that the temperature above which the adhesive effect of the adhesive is reduced lies below the melting or softening temperature of the material of which the refuse bag consists and/or below the melting or softening temperature of that waste for the reception of which the respective area of the refuse bag is intended. The separated individual refuse bags in turn each have their own filling opening.

The individual refuse bag areas of such refuse bags could be separated from one another substantially contactlessly and automatically by means of a suitable apparatus, in that this apparatus irradiates the adhesive bonds, for example with UV, IR, or microwave radiation, or supplies heat in some other manner, for example by means of hot air, whereby the adhesive effect of the adhesive of the adhesive bond is eliminated or at least reduced, for example in that a chemical reaction is triggered in the adhesive which at least partially degrades at least one component of the adhesive or reduces the viscosity of the adhesive. In this way, the individual refuse bags could be separated from one another without significant mechanical action. Such an apparatus suitable for releasing the adhesive bond could for example be integrated into a stationary or mobile refuse disposal installation, for example a refuse sorting installation, a refuse transporter, or also a refuse container. In this way, the user could supply the refuse bag having the refuse bag areas still connected to one another, for example to a corresponding refuse container, in which an automated separation of the refuse bag areas would then take place.

Even if, after the contactless energy input by the apparatus in the container or another of the refuse disposal installations mentioned, mechanical assistance of the separation were still required, for example by pulling the refuse bag areas apart, the force required for this could be significantly reduced owing to the reduced adhesive effect of the adhesive. This could facilitate machine separation and increase separation reliability. In this way, damage to the refuse bags during the separation process could for example be avoided, whereby unintended escape of the refuse contents could be prevented. This could lead, for example in automated refuse sorting or recycling installations, to increased process reliability and separation quality. Moreover, owing to the specifically deactivatable adhesive bond, the refuse bag areas could remain mechanically stably connected to one another during storage, transport, and use and, in contrast for example to refuse bags connected by reversible pressure-sensitive adhesive, could not unintentionally detach from one another, but instead could be reliably separated from one another only at the desired moment by targeted energy input.

The individual refuse bags separated in this way could be supplied automatically to different treatment paths, for example within the scope of refuse recovery or recycling. As a result, the reliability of refuse separation could be increased, since this would no longer have to be carried out manually by the user, but could instead be performed in a traceable, controlled, and reliable manner by a corresponding machine apparatus. In addition, handling of the refuse bag could be simplified for the user, since manual separation of the individual refuse bags would no longer be necessary. Furthermore, the safety for the user during handling could also be increased, since unintended escape of the refuse contents when separating the refuse bag areas would be avoided.

According to one example, it is provided that the releasable adhesive bond is arranged in a section of that side of the refuse bag areas on which their filling opening is located and/or that the releasable adhesive bond is arranged in a section of one of those sides of the refuse bag areas which adjoin the side on which the filling opening is located.

By means of a releasable adhesive bond on that side of the refuse bag areas on which their filling opening is located, handling of the refuse bag could be simplified for the user, in that the filling openings are jointly opened and pulled apart when introducing the refuse bag into a waste bin, so that both refuse bag areas are immediately fillable. In addition, the filling openings could remain fixed in a wide-open state, so that the various filling openings do not move relative to one another when the entire refuse bag is moved. Thus, for example, it could be prevented that the filling openings twist or fold over when being inserted or filled. This could facilitate targeted and convenient filling. By means of a releasable adhesive bond on those sides of the refuse bag areas which adjoin the side having the filling opening, the structural integrity of the refuse bag could be increased. This could be advantageous in particular when the refuse bag is not introduced into a waste bin or refuse container, but is instead fastened, for example, to a ring or a loop or is carried by the user during manual collection of refuse. In such applications, the individual refuse bags connected by the adhesive bond could stabilize the shape of the entire refuse bag and thus fix the geometry of the bag, which could improve handling and facilitate control during use. A combination of releasable adhesive bonds in the regions described above—i.e. at least in sections on all sides except the side opposite the filling opening—which in principle corresponds to a U-shaped adhesive bond, could combine these advantages accordingly.

According to one example, it is provided that the adhesive comprises a thermolabile component and/or a photolabile component, in particular a UV-labile component.

As a result, manufacturing costs could be reduced, since the adhesive need not consist entirely of a thermolabile or photolabile material. Already a corresponding component within the adhesive composition could be sufficient to reduce the adhesive effect of the entire adhesive to a sufficient extent by the contactless energy input and thus release the adhesive bond. By implementing a thermolabile component, the energy input could take place with little technical effort, since usable heat sources for this purpose—such as infrared radiation, hot air, or microwave radiation—are widespread, available at low cost, and easily integrable into existing refuse treatment or refuse collection processes. By implementing a photolabile component, it could in particular be made possible that the energy input need only be concentrated selectively on certain sections of the refuse bag, in particular when selective or partial separation of the adhesive bonds in certain areas is desired.

According to one example in this regard, it is provided that the thermolabile component comprises a polymer selected from the group consisting of polyvinyl acetate, polycaprolactone, polyethylene, ethylene-vinyl acetate, polypropylene, polystyrene, polylactide, polybutylene adipate-co-terephthalate, and polyurethane, and/or that the photolabile component comprises a polymer having a functional group selected from the group consisting of o-nitrobenzyl, o-nitroveratryl, p-hydroxyphenacyl, cinnamate, coumarin, benzoin ester, and/or azo groups. By selecting a polymer from the mentioned group of thermolabile materials, the manufacturing costs of the refuse bag could be kept low, since these polymers are available on a large scale, inexpensive, and technically well proven. In addition, they could be processed by established methods and integrated into existing manufacturing processes without extensive modifications, wherein polylactide is moreover a biodegradable polymer, which could increase the sustainability and recyclability of the refuse bag. By using a polymer having the mentioned photolabile functional groups, reliable reduction of the adhesive effect by irradiation with electromagnetic radiation could be achieved, since these groups can be activated selectively and reproducibly by electromagnetic radiation in defined wavelength ranges. In particular when using UV radiation, controlled cleavage of chemical bonds and/or rearrangements within the functional group could occur, whereby the molecular structure of the adhesive changes locally and its adhesive properties could be weakened or eliminated in a targeted manner.

According to one example, it is provided that the adhesive comprises a polymeric adhesive component based on polyurethanes and/or polyureas and/or epoxy resins and an additive component, wherein the additive component comprises a functional group which is activatable by energy input such that a chemical reaction with the polymeric adhesive component takes place with at least partial degradation of the polymeric adhesive component. By means of such an adhesive composition, targeted control of the separation properties could be enabled, in that the adhesive is selectively deactivated under defined conditions without the adhesive bond of the refuse bag unintentionally losing adhesive effect during storage or use. The use of a polymeric main component on a polyurethane or epoxy resin basis in combination with an additionally selectively addressable additive component could combine high adhesive stability with a defined releasable separability.

In a further aspect, a refuse bag is disclosed having at least one filling opening for refuse and at least two refuse bag areas, wherein the refuse bag areas are fillable via the at least one filling opening for the at least two refuse bag areas, wherein the refuse bag areas are each separable from the refuse bag non-destructively, so that the refuse bag areas each form separate individual refuse bags after separation from the refuse bag, wherein the refuse bag areas are connected to one another by means of magnetically acting elements. The separated individual refuse bags in turn each have their own filling opening.

Such refuse bags could, by the use of magnetically acting elements for connecting the refuse bag areas, create the possibility of newly arranging the refuse bag areas and coupling them to one another in a reversible manner. As a result, handling for the user could be simplified, for example in that the arrangement of the refuse bag areas can be flexibly adapted to the respective application or installation situation. In particular, adaptability to existing infrastructures—such as refuse containers having predetermined geometries, divided waste bins, or special receiving systems—could be improved. In addition, the reversible character of the connection could permit reusability of individual components or temporary reconfiguration of the refuse bag, for example for targeted sorting, separation, or portioning of different types of waste in the context of use.

According to one example, it is provided that the magnetically acting elements are each arranged in a section of that side of the refuse bag areas on which their filling opening is located and/or that the magnetically acting elements are arranged in a section of one of those sides of the refuse bag areas which adjoin the side on which the filling opening is located. By means of magnetically acting elements on that side of the refuse bag areas on which their filling opening is located, handling of the refuse bag for the user could be simplified, in that the filling openings are jointly opened and pulled apart when introducing the refuse bag into a waste bin, so that both refuse bag areas are immediately fillable. In addition, the filling openings could remain fixed in a wide-open state, so that the various filling openings do not move relative to one another when the entire refuse bag is moved. Thus, it could for example be prevented that the filling openings twist or fold over when being inserted or filled. This could facilitate targeted and convenient filling. By means of magnetically acting elements on those sides of the refuse bag areas which adjoin the side having the filling opening, the structural integrity of the refuse bag could additionally be increased. This could be important in particular when the refuse bag is not introduced into a waste bin or refuse container, but is instead fastened, for example, to a ring or a loop or is carried by the user during manual collection of refuse. In such applications, the individual refuse bags connected by the magnetically acting elements could stabilize the shape of the entire refuse bag and thus fix the geometry of the bag, which could improve handling and facilitate control during use. A combination of magnetically acting elements in the regions described above—i.e. at least in sections on all sides except the side opposite the filling opening—which in principle corresponds to a U-shaped arrangement, could combine these effects accordingly.

According to one example, it is provided that the magnetically acting elements are formed by a layer which comprises magnetic particles and which is applied at least in sections to the refuse bag areas, or that the magnetically acting elements are formed by magnetic particles which are contained at least in sections in the material of which the refuse bag areas consist. By an embodiment as an applied layer having magnetic particles, targeted and defined placement of the magnetically acting elements could be enabled, for example in the form of structured patterns or functional zones which could be matched exactly to certain application requirements. Such a solution could also be realized subsequently in the manufacturing process or during converting, which could facilitate integration into existing production lines. Integration of the magnetic particles directly into the material of the refuse bag areas could generate a particularly robust magnetic connection, since the functional units would be inseparably connected to the material. As a result, for example the number of necessary manufacturing steps could be reduced while at the same time a durable, purely material-based functionality could be achieved. In addition, a uniform magnetic effect could be realized over larger area regions without additional layers or adhesions being required.

In a further aspect, a method for disposing of refuse is disclosed, the method comprising the following steps:
providing a refuse bag having at least one filling opening for refuse and at least two refuse bag areas, wherein the refuse bag areas are fillable via the at least one filling opening for the at least two refuse bag areas, wherein the refuse bag areas are each separable from the refuse bag non-destructively, so that the refuse bag areas each form separate individual refuse bags after separation from the refuse bag, wherein the refuse bag areas are connected to one another by a releasable adhesive bond comprising an adhesive, wherein the releasable adhesive bond is releasable by contactless energy input, in particular by action of electromagnetic radiation, in particular UV, IR, or microwave radiation, wherein the contactless energy input causes a chemical reaction with at least partial degradation of a component of the adhesive and/or a phase transition and/or a reduction in viscosity and/or a change in crystallinity and/or a change in surface tension of the adhesive,
filling the refuse bag with refuse by a user, wherein the at least two refuse bag areas are each filled with refuse of a different type,
supplying the filled refuse bag to a refuse disposal installation,
releasing the adhesive bond by contactless energy input, in particular by action of UV radiation, IR radiation, or microwave radiation,
separating the at least two refuse bag areas to obtain separate individual refuse bags,
processing the separate individual refuse bags by the refuse disposal installation, wherein the processing is performed depending on the type of refuse with which the respective individual refuse bag is filled.

By the combination of predefined separability and machine separation of the different refuse bag areas, which are filled with different types of refuse, the resulting individual refuse bags could be reliably supplied to the respectively appropriate disposal and/or treatment paths. As a result, automated and type-pure further processing of the waste could be facilitated and the efficiency of refuse separation overall could be increased. Apart from this, the features and advantages relating to the refuse bags can be transferred accordingly to the method for disposing of refuse, so that further repetitions are dispensed with at this point.

In a further aspect, a method for disposing of refuse is disclosed, the method comprising the following steps:
providing a refuse bag having at least one filling opening for refuse and at least two refuse bag areas, wherein the refuse bag areas are fillable via the at least one filling opening for the at least two refuse bag areas, wherein the refuse bag areas are each separable from the refuse bag non-destructively, so that the refuse bag areas each form separate individual refuse bags after separation from the refuse bag, wherein the refuse bag areas are connected to one another by means of magnetically acting elements, or wherein the refuse bag areas are connected to one another by a releasable adhesive bond comprising an adhesive, wherein the releasable adhesive bond is releasable by contactless energy input, in particular by action of electromagnetic radiation, in particular UV, IR, or microwave radiation, wherein the contactless energy input causes a chemical reaction with at least partial degradation of a component of the adhesive and/or a phase transition and/or a reduction in viscosity and/or a change in crystallinity and/or a change in surface tension of the adhesive,
   wherein at least one of the at least two refuse bag areas has a device-readable information carrier, wherein a unique identifier is stored in the information carrier,
filling the refuse bag with refuse by a user,
supplying the filled refuse bag to a refuse disposal installation having a reading device and separating the at least two refuse bag areas by the refuse disposal installation in order to obtain that separate individual refuse bag which has the device-readable information carrier,
   or
separating the at least two refuse bag areas by the user in order to obtain that separate individual refuse bag which has the device-readable information carrier and supplying this separate individual refuse bag to a refuse disposal installation having a reading device,
reading the information carrier by the reading device of the refuse disposal installation in order to determine the unique identifier stored in the information carrier,
determining the amount of refuse contained in the individual refuse bag, in particular by weighing, volume measurement, or image-based analysis,
storing data regarding the determined amount of refuse in a database using the determined unique identifier as a database access key,
   processing the individual refuse bag by the refuse disposal installation, wherein the processing is performed depending on the stored data regarding the amount of refuse.

By the use of a device-readable information carrier having a unique identifier in at least one of the refuse bag areas in the method, assignment of the respective individual refuse bag on the basis of the waste type intended for this individual refuse bag or also to a certain user or usage context could be enabled. As a result, on the one hand the reliability of assignment of the individual refuse bag to the corresponding disposal path and on the other hand individual traceability of the filled refuse bags could be created, which in turn could facilitate targeted, user-dependent processing or billing. Reading the identifier stored in the information carrier and linking it with determined data regarding the amount of refuse—such as by weighing or volume measurement—could enable precise documentation of the waste quantities incurred.

On the basis of this information stored in a database, CO2 certification could for example be enabled, in which a corresponding CO2 value is assigned to a user for the amount of refuse associated with the individual refuse bag—for example because that individual refuse bag contained waste which, owing to targeted filling by the user, could be supplied to recycling instead of having to be disposed of in a landfill. The data captured in this way could serve as a basis for issuing digital proofs or certificates, for example for representing savings potential in the context of reuse or for proving sustainable behaviour to third parties. In addition, separation of the refuse bag areas—in particular in the case of automated detection and separation by a refuse disposal installation—could take place more reliably, since targeted access can be made to that individual refuse bag which contains the readable information carrier. This could support selective further processing or separate treatment of specially identified types of waste.

According to one example, it is provided that the method additionally comprises the following steps:

providing a user device, wherein the user device has means for reading the information carrier and means for storing data regarding the type of contents of the individual refuse bag in a database, and
reading the information carrier by the user device in order to determine the unique identifier stored in the information carrier, and
storing data regarding the type of contents of the individual refuse bag by the user in a database by means of the user device using the determined unique identifier as a database access key,
   and/or
determining the type of contents of the individual refuse bag by the refuse disposal installation, in particular by image-based analysis or sensor-based material recognition, in particular by spectroanalytic methods,
   and
storing data regarding the determined type of contents of the individual refuse bag by the refuse disposal installation in a database using the determined unique identifier as a database access key,
wherein the individual refuse bag is processed by the refuse disposal installation, wherein the processing is performed depending on the stored data regarding the amount of refuse and the type of contents.

If, already before supplying the refuse bag to the refuse disposal installation, an explicit link between the type of contents of an individual refuse bag and its unique identifier is established in the database by storage of corresponding data by the user by means of a user device, the reliability of refuse separation could be increased. Such an early and traceable assignment could enable fine-granular traceability of the waste treatment process and facilitate precise allocation of the respective individual refuse bag to a suitable treatment or recycling path, since dedicated determination of the type of contents of the refuse bag by complex methods in the refuse disposal installation would no longer be necessary. This could promote targeted further processing and improve both efficiency and quality of corresponding recycling processes. In addition, the system could be configured so that it detects incorrect or incomplete entries—for example when a certain type of waste has been filled into an individual refuse bag which is unsuitable for this type of waste, for example because it is not moisture-tight and has been filled with moist organic waste—and correspondingly adapts downstream processes and optionally informs the user.

If the refuse disposal installation determines the type of contents of the individual refuse bag, for example by image-based analysis or sensor-based material recognition, in particular by spectroanalytic methods, and stores data regarding the determined type of contents of the individual refuse bag in a database using the determined unique identifier as a database access key, fully automated, user-independent capture and classification of the waste could be enabled. This could contribute, in particular in large-volume disposal processes, to increased efficiency, since manual documentation is dispensed with and at the same time an objective, reproducible data basis is created which can be used for downstream treatment, sorting, or accounting of the waste.

If the type of bag contents is additionally captured automatically by the refuse disposal installation, in addition to documentation by the user, and corresponding data assigned to the individual refuse bags are stored in a database, a closed feedback system could arise in which both the information specified by the user and the information regarding type and extent of the contents of the refuse objectively determined by the refuse disposal installation are available. This could enable validation or plausibility checking of the refuse separation performed by the user and thereby increase the reliability of sorting overall and protect the system against fraudulent activities by the user, for example when the user deliberately makes incorrect statements about the bag contents in order to obtain advantages such as CO2 certificates or discounts to which the user is not actually entitled. In addition, on the basis of this data, targeted optimization of recycling processes or avoidance strategies with regard to certain types of waste could be supported. Not least, this systematics could also contribute to raising user awareness, since the system could transparently provide feedback on correctly or incorrectly performed separation processes, whereby in the long term a change in behaviour in the sense of more sustainable refuse separation could be promoted.

In a further aspect, a method for manufacturing refuse bags is disclosed, which have a first and a second individual refuse bag, wherein the first and the second individual refuse bag are separable from one another non-destructively and each have a filling opening, the method comprising the following steps:
feeding a first bag web and a second bag web in a production direction, wherein the first bag web comprises first individual refuse bags connected to one another in a separable manner and the second bag web comprises second individual refuse bags connected to one another in a separable manner, wherein the two bag webs are guided one above the other in the same direction and the longitudinal axes of the bag webs are aligned with one another,
connecting the bag webs section by section by a releasable connecting seam, wherein a first part of the releasable connecting seam extends in a section of that side of the individual refuse bags on which their filling opening is located, wherein the first part of the releasable connecting seam is generated by applying pressure by means of a stamp, wherein the stamp is inserted into the filling opening of one of the individual refuse bags,
   and/or
   wherein a second part of the releasable connecting seam extends in a section of one of those sides of the individual refuse bags which adjoin the side on which the filling opening is located, wherein the second part of the connecting seam is generated by applying pressure by means of a roller,
   wherein the application of pressure in each case
causes interlocking deformation of material sections of the superposed bag webs, thereby producing a positive-fit connection, in particular in conjunction with generating recesses in the bag webs, and/or
is performed under the action of heat, and/or
is performed using an adhesive which is applied before connecting to the outer wall of one of the individual refuse bags that faces the other individual refuse bag,
   wherein the method optionally comprises the following step:
separating a defined number of refuse bags from the connected bag web, in particular in conjunction with winding up the defined number of refuse bags.

The described method for manufacturing refuse bags could enable precise and reproducible manufacture of refuse bags having separable individual refuse bags. The alignment of the bag webs along aligned longitudinal axes could ensure high dimensional accuracy and fitting accuracy of the resulting connections. This could lead, in particular in automated manufacturing environments, to consistently high product quality. Moreover, the method could be integrated into already existing, conventional manufacturing processes for film bags based on so-called roll-to-roll processes. For example, two continuous bag webs previously produced by such established processes could, inline in a continuous process, pass through the described method steps for manufacturing the refuse bags. This could facilitate process integration and reduce manufacturing costs, since implementation of series production would be simplified owing to low conversion effort.

Section-by-section production of the releasable connecting seam—by targeted application of pressure by means of a stamp and/or a roller—could permit flexible adaptation to different geometries of the refuse bag areas. If a connecting seam is introduced in the region of the filling opening by a stamp inserted into the filling opening, it could be prevented that the inner walls of the respective individual refuse bags are connected to one another. The stamp could on the one hand generate the releasable connecting seam—for example by heat sealing—and at the same time function as a spacer element which keeps the inner walls of that individual refuse bag into which the stamp is inserted at a distance from one another.

Generation of the second part of the connection by means of a roller at the side regions adjoining the filling opening could permit an extensive and stabilizing connection which in particular could fix the overall shape of the combined refuse bag and improve its handling.

By the selectable connection techniques—positive-fit deformation, such as with recesses, heat sealing under the action of heat, or cold sealing by means of adhesive—the method could be adapted to different material properties and process requirements. This could, for example, facilitate integration into existing manufacturing lines and tailor production to different usage profiles or recycling requirements.

For example, a releasable connecting seam produced by interlocking deformation of material sections between the individual refuse bags could dispense with additional material such as adhesive, which could improve material efficiency and reduce possible interactions with the refuse contents. Owing to the flexibility in the selection of corresponding forming tools, the force required for releasing the connecting seam could additionally be set in a targeted manner, so that the separability of the individual refuse bags can be adapted to specific requirements of the application or further processing. By generating recesses in the bag webs, the interlocking of the material sections could additionally be simplified, since defined engagement regions are created which permit precise and repeatable positive fitting. This could improve the reproducibility of the connection as well as control over its mechanical properties.

In the case of a releasable connecting seam produced by cold sealing by means of adhesive between the individual refuse bags, a particularly uniform and continuous connection could be achieved which is nevertheless specifically releasable. By the use of suitable adhesive formulations, the adhesive effect of the connection could be matched in a targeted manner to certain environmental conditions or separation mechanisms. For example, adhesives could be used whose adhesion can be specifically reduced by external influences such as UV radiation, IR radiation, or heat, so that separability could take place without significant mechanical action. This could not only improve the selectivity of separation but also increase safety and cleanliness during the separation process. In addition, adaptation of the adhesive properties to certain recycling specifications or material combinations could permit high flexibility in use.

A releasable connecting seam produced by heat sealing under the action of heat could be distinguished in particular by high tightness, which could increase suitability for applications involving moist or liquid refuse. The connection could thereby be configured not only to be liquid-tight but also gas-tight, which could, for example, prevent odour formation or the escape of liquids. Since heat sealing requires no additional material such as adhesive, the method could furthermore improve material efficiency and reduce potential interactions with the refuse contents. Moreover, the heat sealing process could be integrated particularly easily into existing roll-to-roll manufacturing processes, since it is widespread, proven, and technically mature. The combination of high process reliability and functional tightness could facilitate manufacture of reliable refuse bag systems having clearly defined separation points and expand their field of application. For example, the roller could be equipped with a heatable pressure-applying element which permits the action of heat on the bag webs in a defined region.

In addition, the optional separation of a defined number of refuse bags and subsequent winding thereof could create a packaging unit adapted to demand which can be stored, transported, and further processed well in automated systems.

According to one example, it is provided that, during the application of pressure, material of a bag web is removed or pierced, in particular by punching, in order to weaken the releasable connecting seam.

If, during the application of pressure, material of a bag web is removed or pierced, in particular by punching, in order to weaken the releasable connecting seam, the force required for later separation could thereby be set in a targeted manner. This could create a defined predetermined breaking point which facilitates separability under reproducible conditions without impairing the structural integrity of the bags during transport or storage. In particular in combination with a connecting seam produced by cold sealing, the targeted weakening of the connection by material removal could further optimize the separation characteristics, for example in that the connection can be reliably released under certain temperature effects or mechanical forces. In this way, separability could be adapted exactly to application-specific requirements or automated separation processes.

In a further aspect, an apparatus for manufacturing refuse bags is disclosed, which have a first and a second individual refuse bag, wherein the first and the second individual refuse bag are separable from one another non-destructively and each have a filling opening, the apparatus comprising:
a feed module, wherein the feed module is configured to be able to transport first and second bag webs in a production direction such that the bag webs are guided one above the other in the same direction and the longitudinal axes of the bag webs are aligned with one another, wherein each bag web comprises individual refuse bags connected to one another in a separable manner,
a roller, wherein the roller is configured to be able to exert pressure on the superposed bag webs transported by the feed module in order to generate a releasable connecting seam section by section between the bag webs,
a stamp module, wherein the stamp module is configured to be able to insert a stamp into the filling opening of one of the individual refuse bags and to be able to exert pressure via the stamp on the superposed bag webs transported by the feed module, in particular wherein the stamp is heatable.

According to one example, it is provided that the roller additionally has a punching element, wherein the punching element is configured to remove or pierce material from a bag web in order to weaken the releasable connecting seam, and/or that the roller additionally has a forming element which is configured to produce a positive-fit connection by interlocking deformation of material sections of the superposed bag webs, in particular in conjunction with generating recesses in the bag webs and/or partially forming a material section into a corresponding forming region of the respectively other bag web. In this way, the type of connecting seam produced and particular the separation force required for later releasing the connection could be varied in a targeted manner and flexibly adapted to the respective application—for example depending on the requirements for stability during filling, transport, or the desired separability in the refuse disposal installation.

The features and advantages relating to the methods for manufacturing corresponding refuse bags can be transferred in an analogous manner to the corresponding apparatus for manufacturing refuse bags, so that repetitive description is dispensed with at this point.

It is understood that one or more of the above-mentioned examples may be combined with one another as long as the examples do not exclude one another.

The invention is described in greater detail below with reference to the drawing, in which

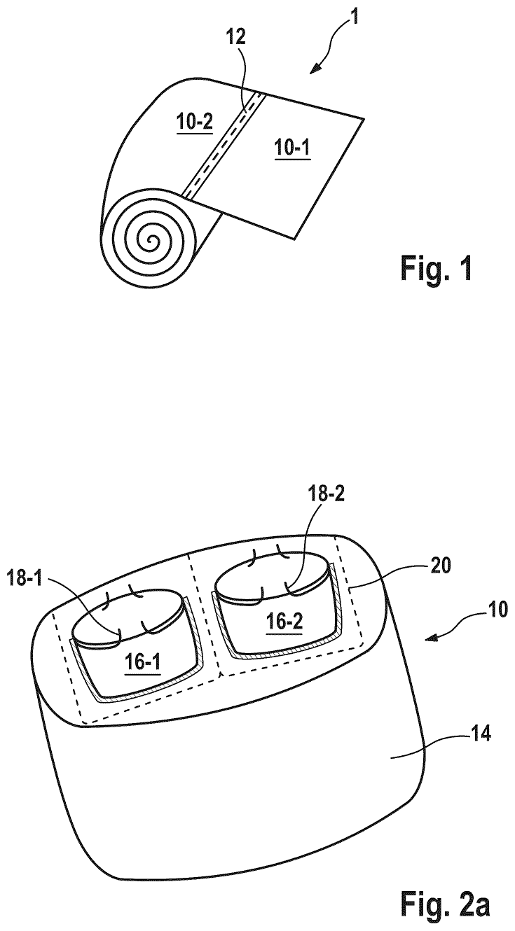

FIG. 1 schematically shows a refuse bag roll as a whole;

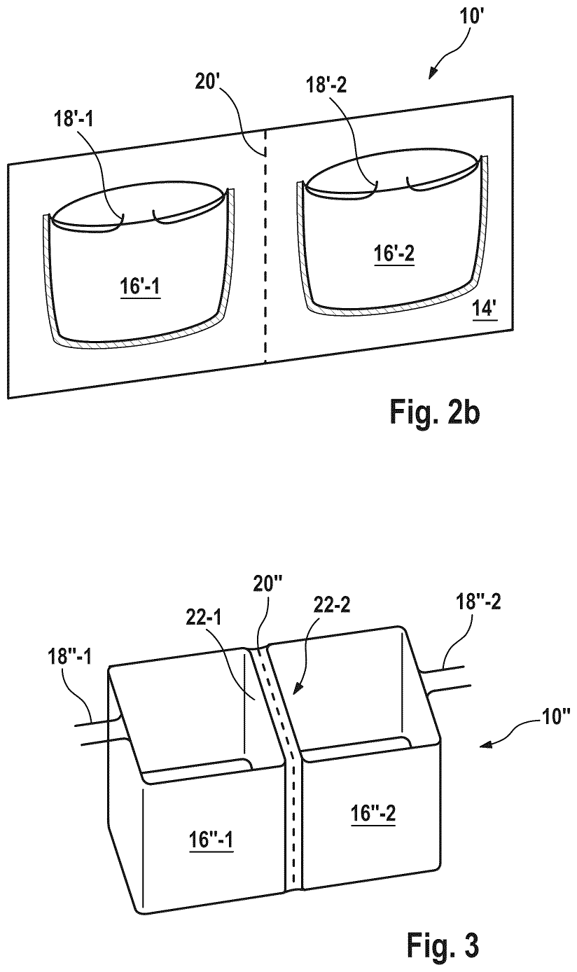

FIG. 2a shows a first variant of a first embodiment of a refuse bag, which may be provided by the refuse bag roll;

FIG. 2b shows a second variant of the first embodiment of a refuse bag, which may be provided by the refuse bag roll;

FIG. 3 illustrates a second embodiment of a refuse bag;

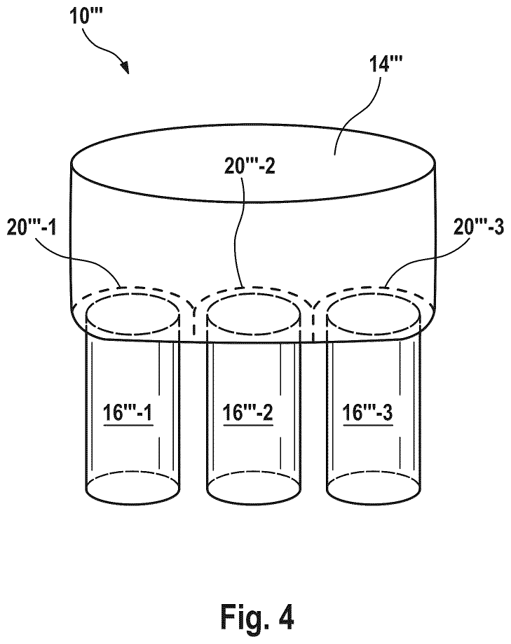

FIG. 4 illustrates a third embodiment of a refuse bag;

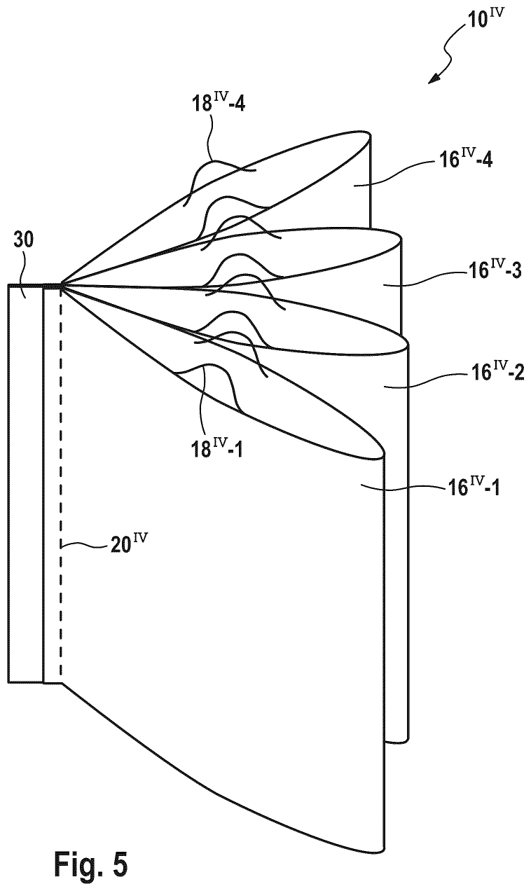

FIG. 5 illustrates a fourth embodiment of a refuse bag;

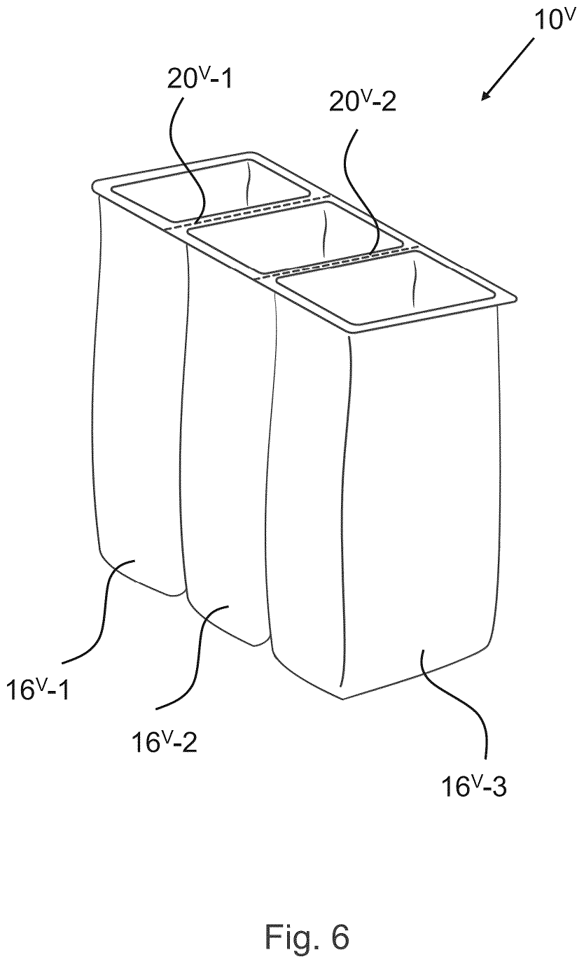

FIG. 6 illustrates a fifth embodiment of a refuse bag;

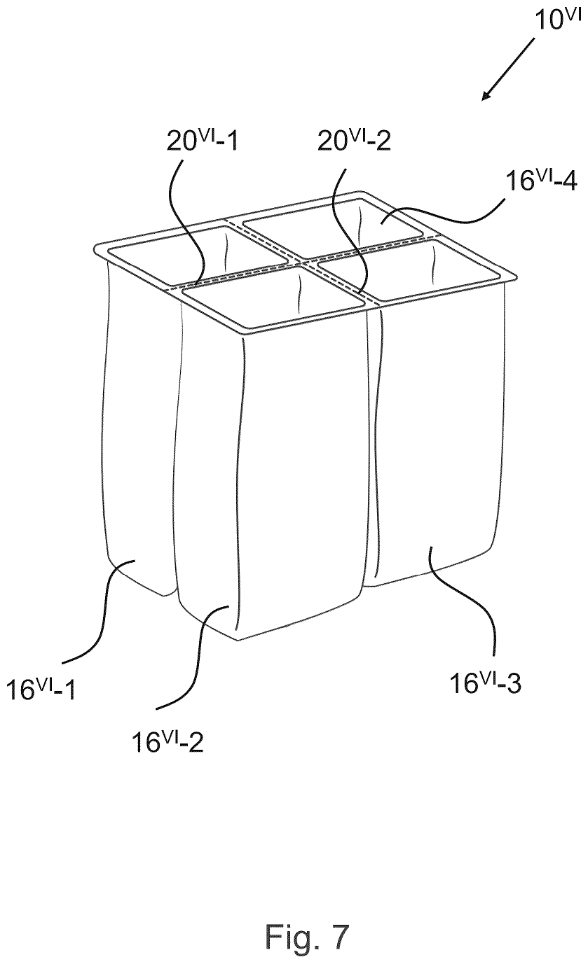

FIG. 7 illustrates a second variant of the fifth embodiment of the refuse bag;

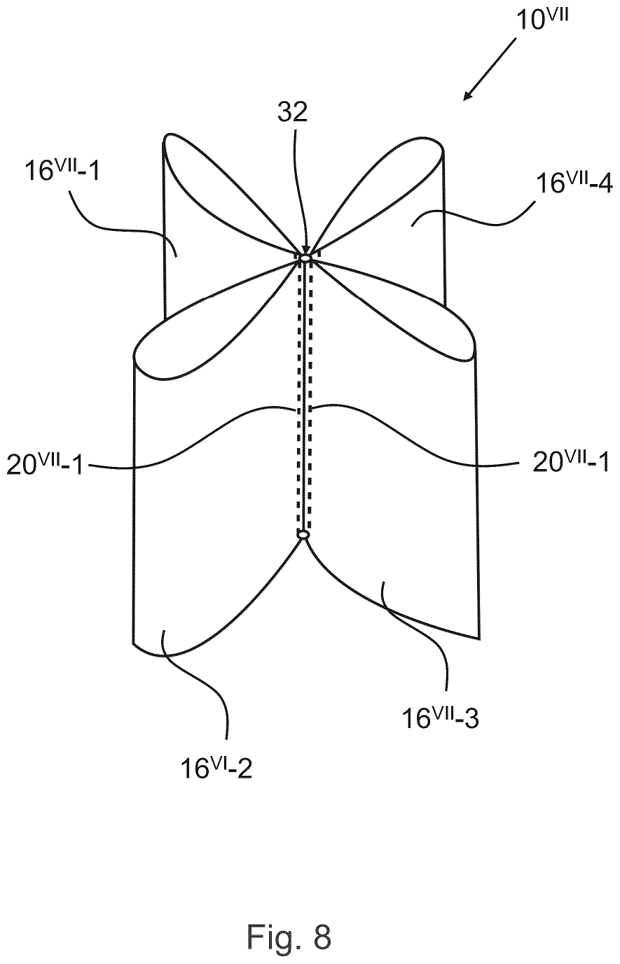

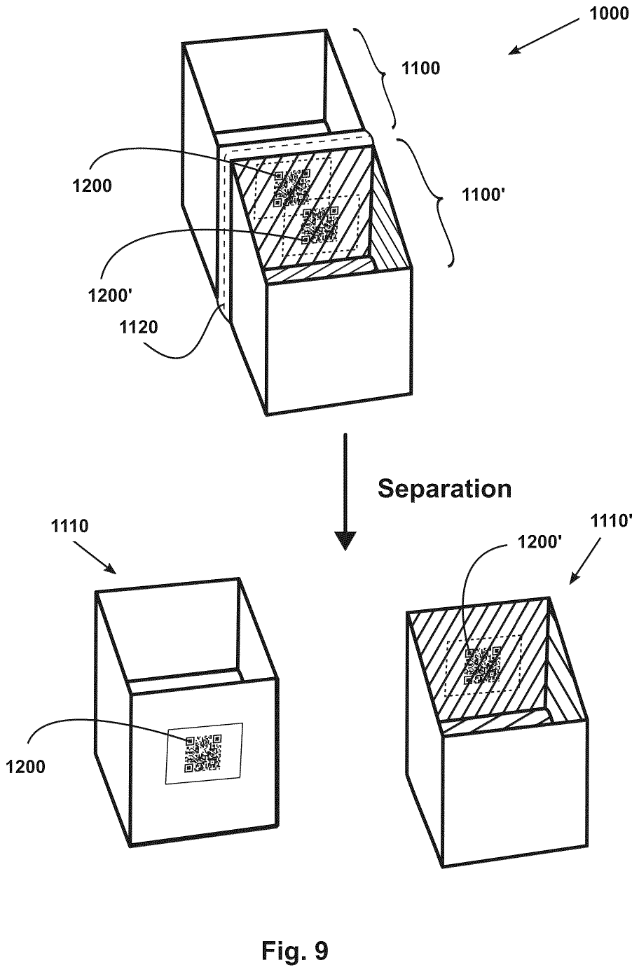

FIG. 8 illustrates a sixth embodiment of a refuse bag;

FIG. 9 shows a schematic perspective view of an exemplary refuse bag and of the corresponding exemplary separate individual refuse bags obtained by separating the refuse bag areas;

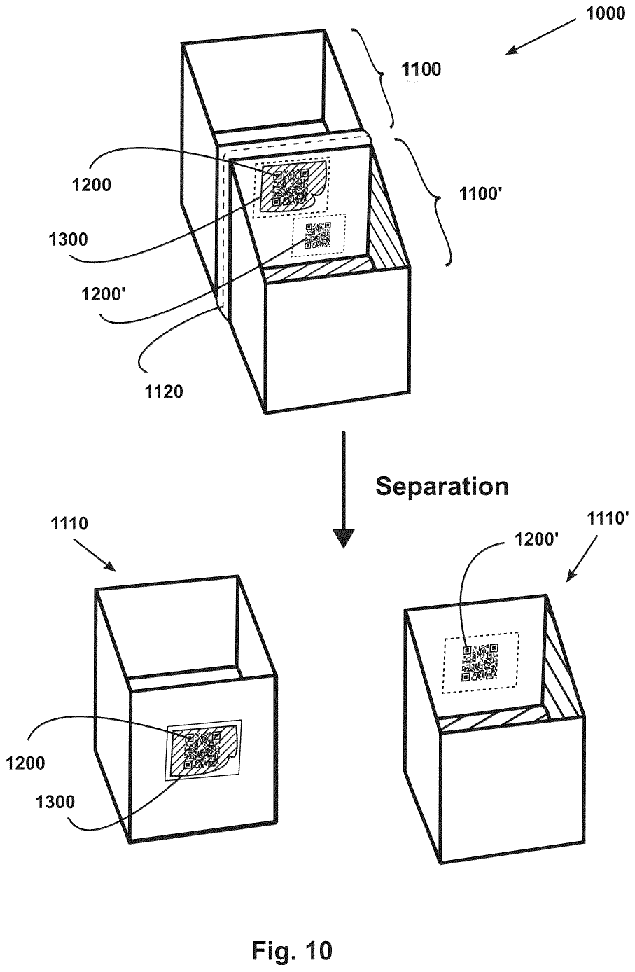

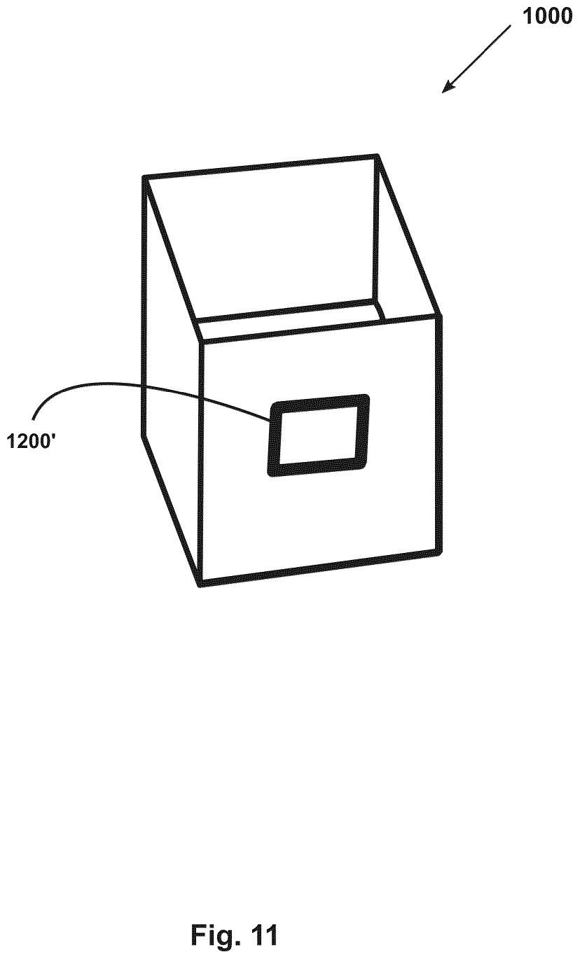

FIG. 10 shows a schematic perspective view of a further exemplary refuse bag and of the corresponding exemplary separate individual refuse bags obtained by separating the refuse bag areas;

FIG. 11 shows a schematic perspective view of a further exemplary refuse bag;

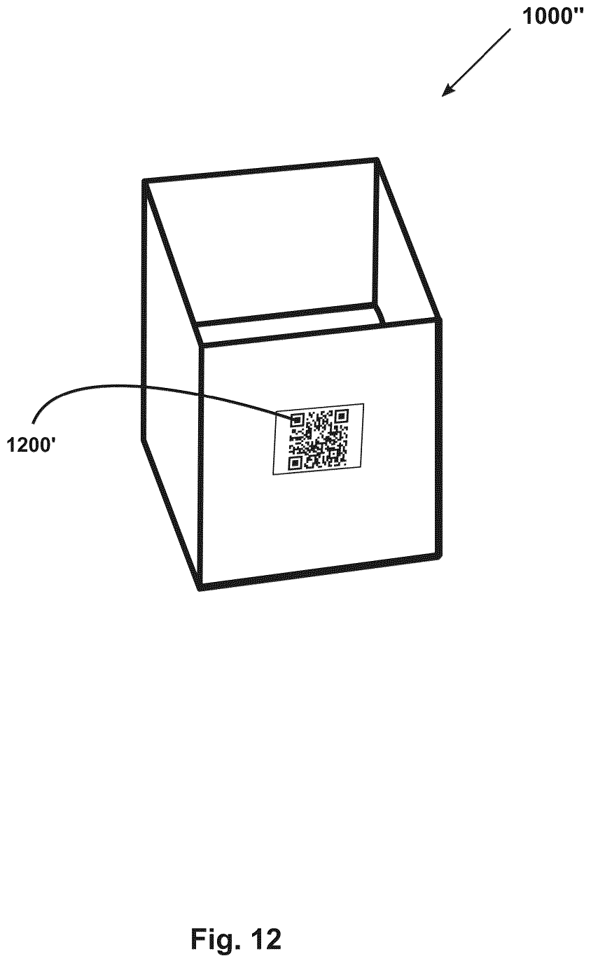

FIG. 12 shows a schematic perspective view of a further exemplary refuse bag;

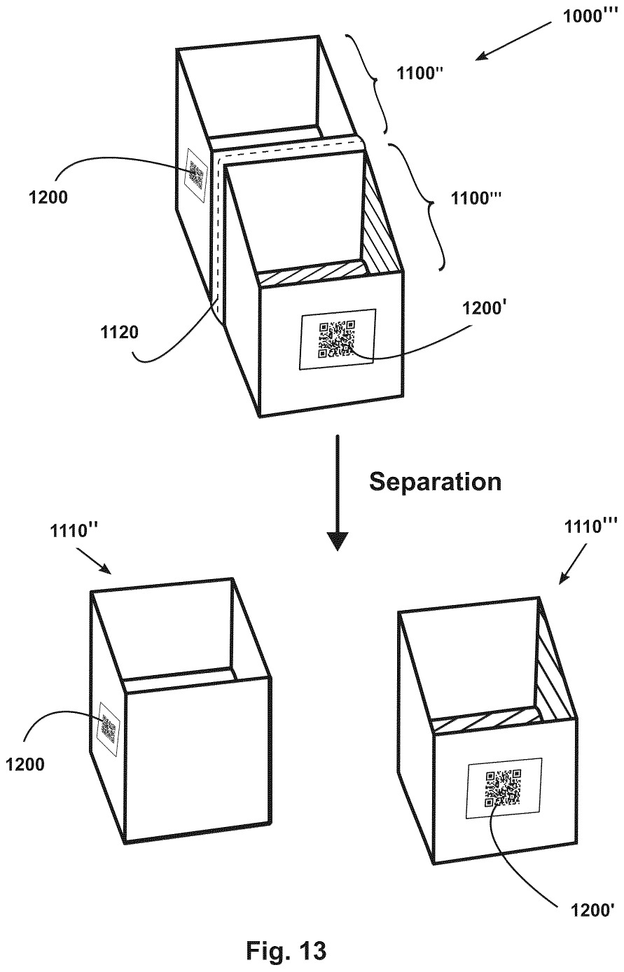

FIG. 13 shows a schematic perspective view of a further exemplary refuse bag and of the corresponding exemplary separate individual refuse bags obtained by separating the refuse bag areas;

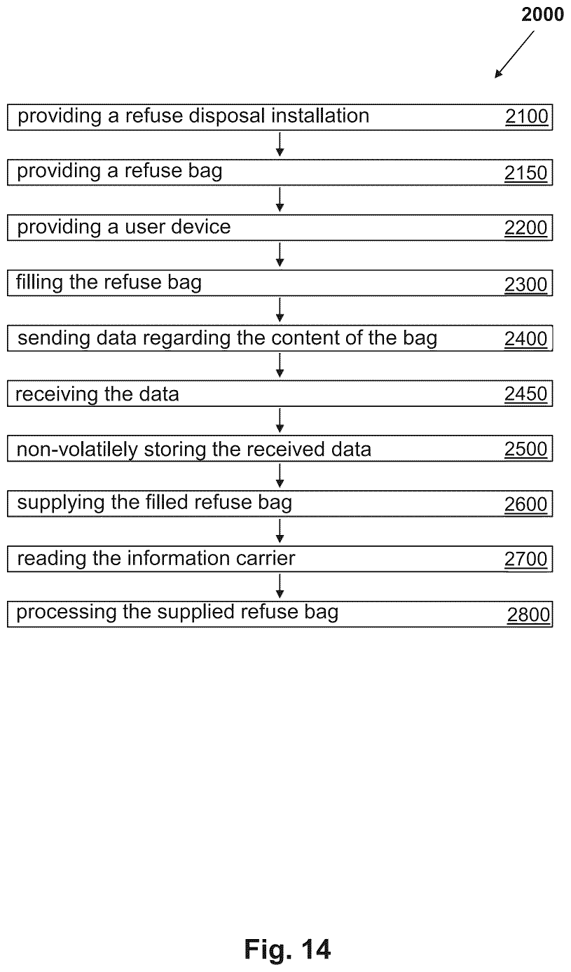

FIG. 14 shows a flow chart of an exemplary method for disposing of refuse;

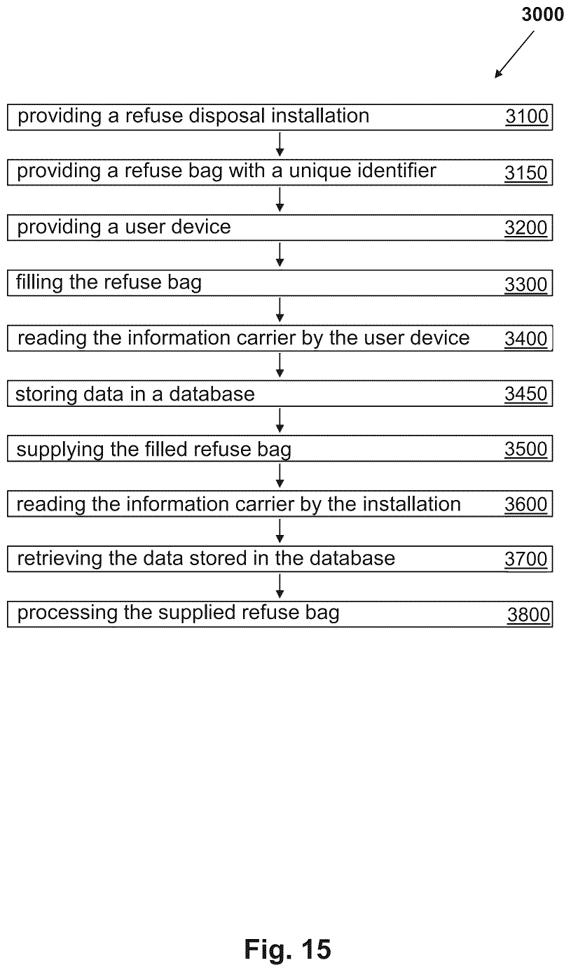

FIG. 15 shows a flow chart of a further exemplary method for disposing of refuse;

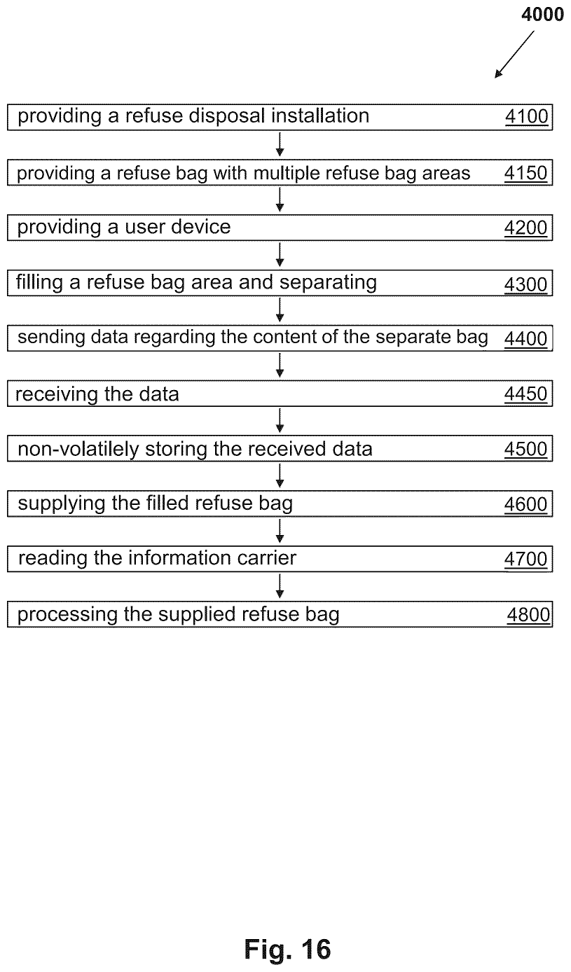

FIG. 16 shows a flow chart of a further exemplary method for disposing of refuse;

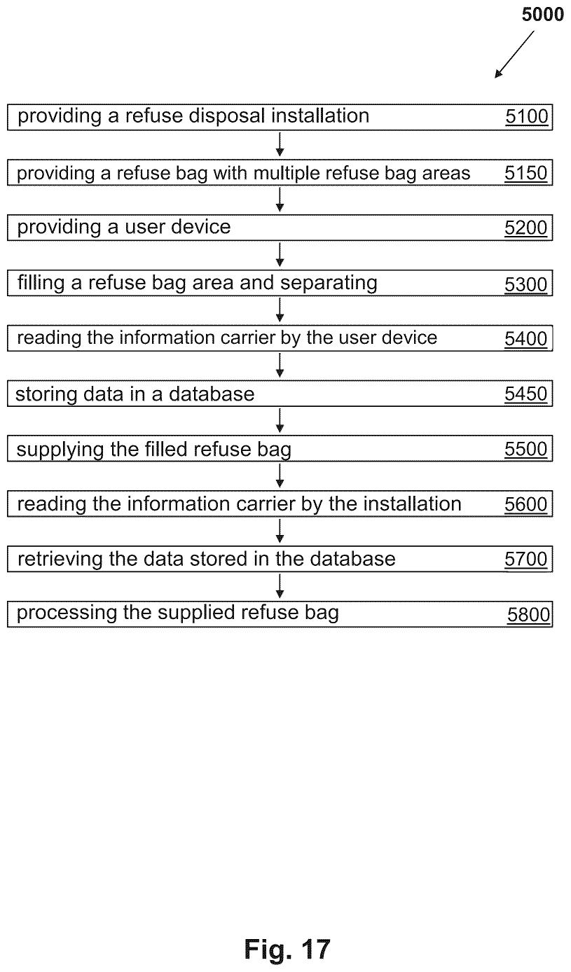

FIG. 17 shows a flow chart of a further exemplary method for disposing of refuse;

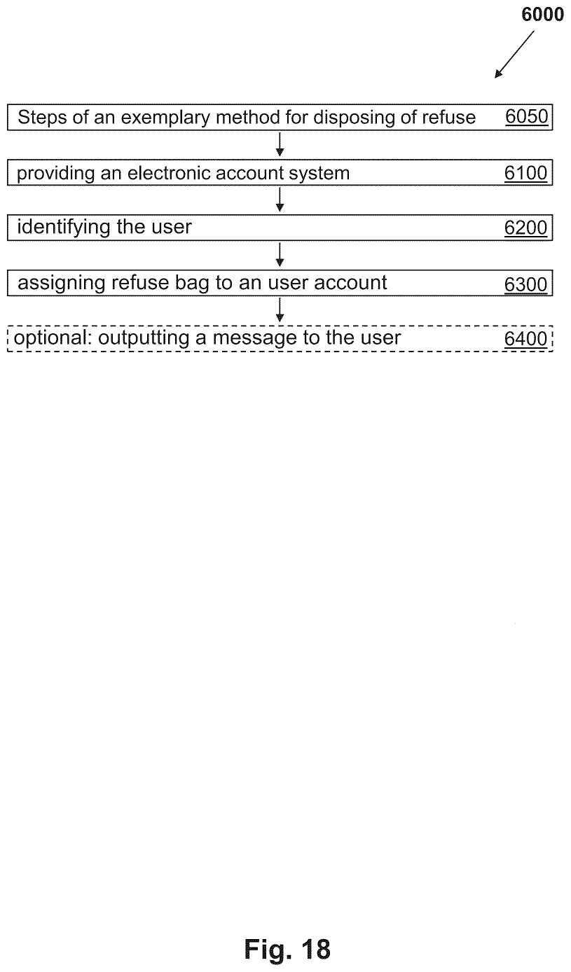

FIG. 18 shows a flow chart of a further exemplary method for disposing of refuse;

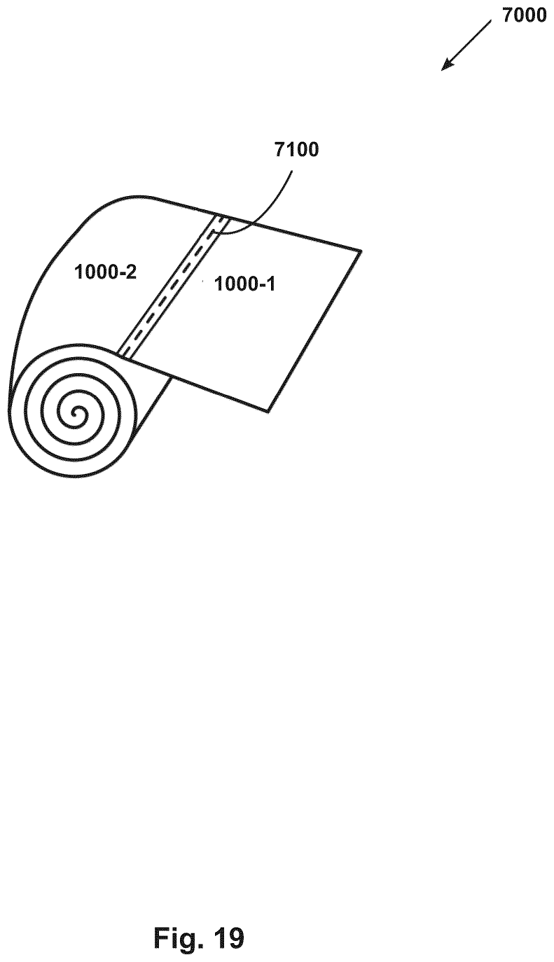

FIG. 19 shows a schematic view of an exemplary refuse bag roll;

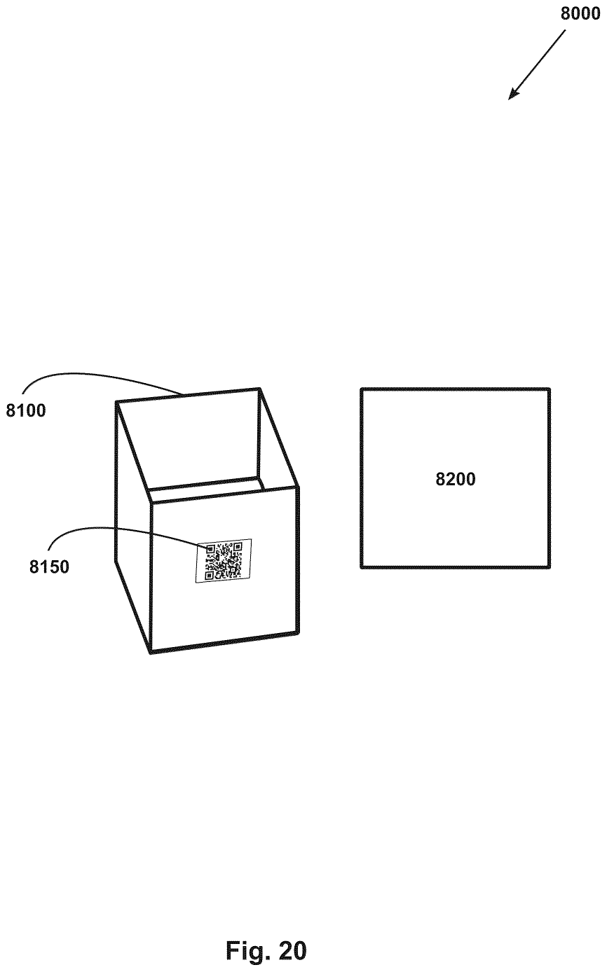

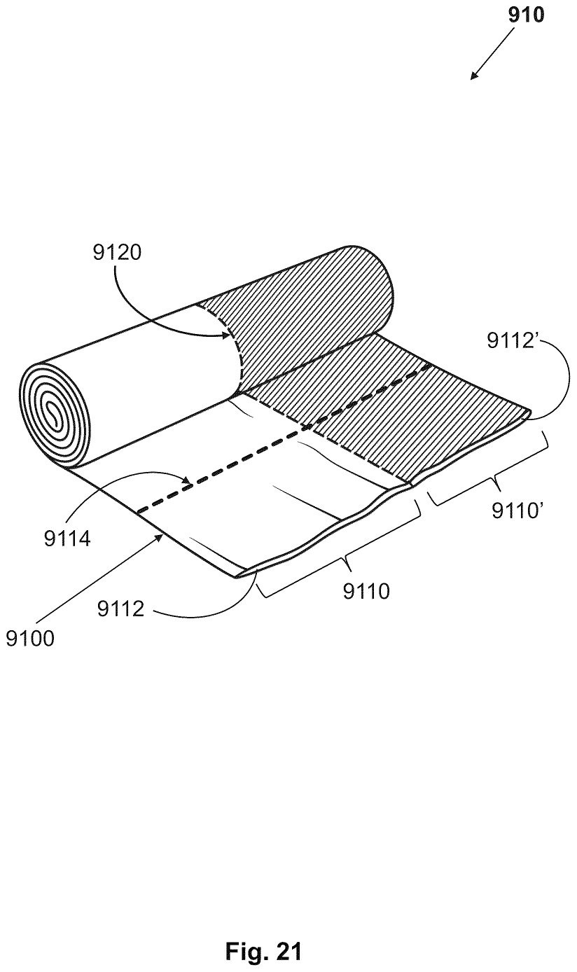

FIG. 20 shows a schematic view of an exemplary refuse disposal system;

FIG. 21 shows a schematic illustration of an exemplary refuse bag roll having refuse bags rolled up one after the other;

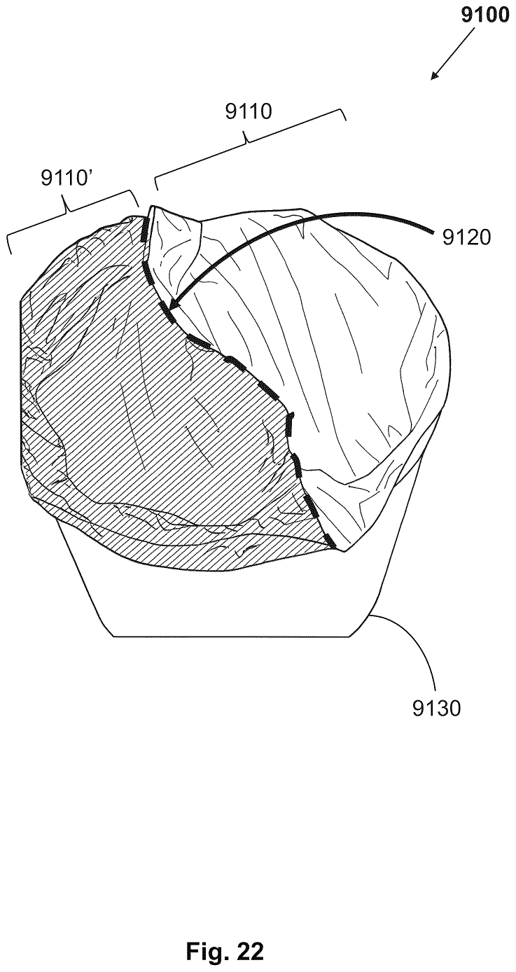

FIG. 22 shows a schematic illustration of an exemplary refuse bag inserted into a waste bin;

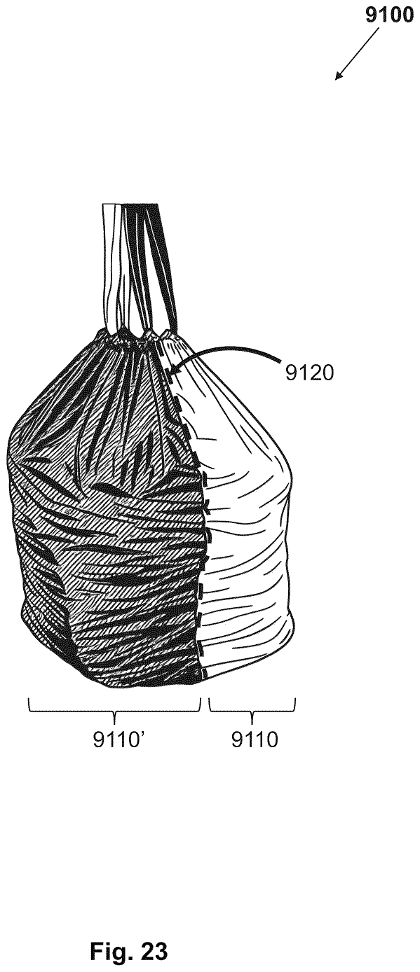

FIG. 23 shows a schematic illustration of an exemplary refuse bag in the filled state;

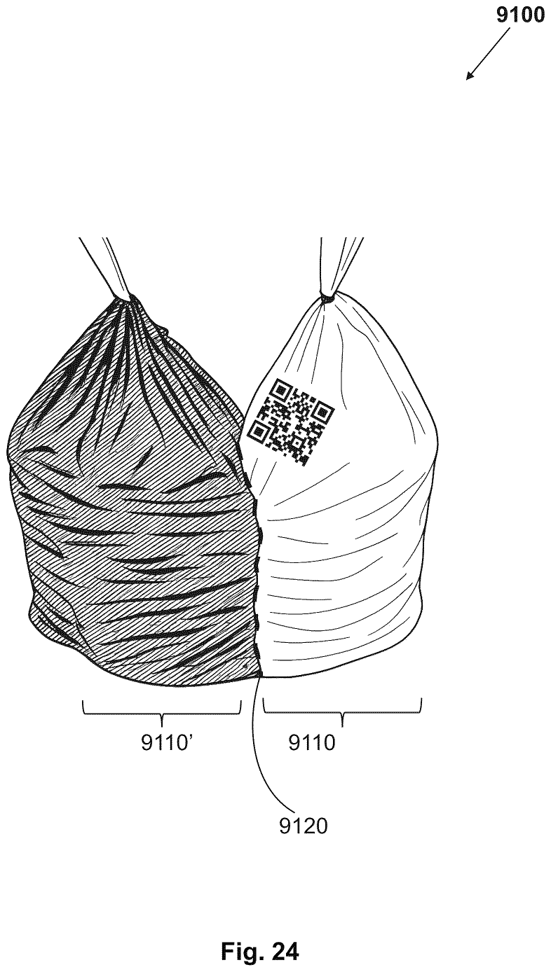

FIG. 24 shows a schematic illustration of an exemplary refuse bag in the filled state, in which the refuse bag areas are partially separated from one another;

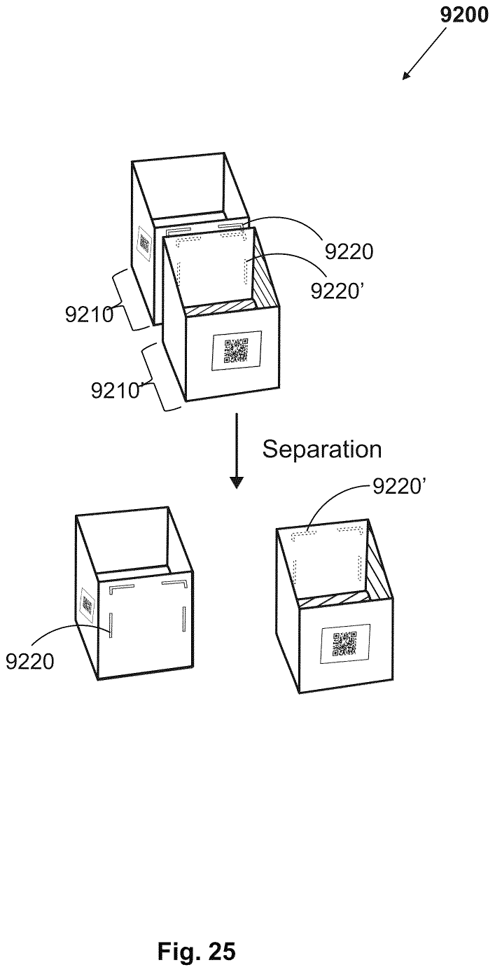

FIG. 25 shows a schematic illustration of an exemplary refuse bag and corresponding exemplary individual refuse bags obtained by separating the refuse bag areas,

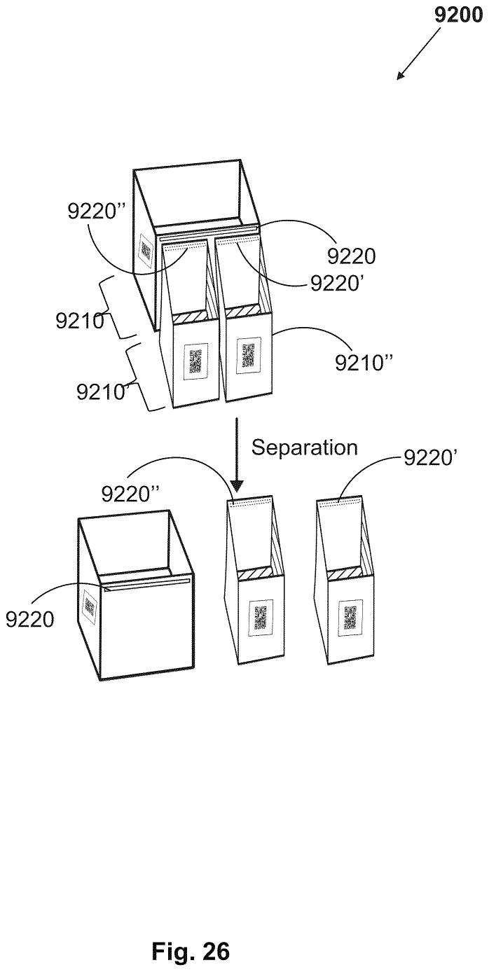

FIG. 26 shows a schematic illustration of a further exemplary refuse bag and corresponding exemplary individual refuse bags obtained by separating the refuse bag areas;

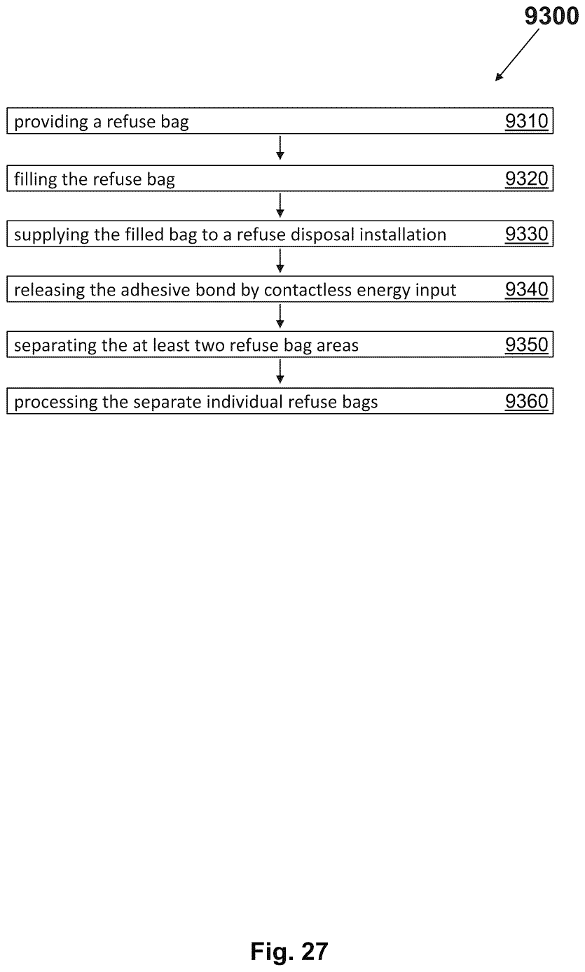

FIG. 27 shows a flow chart of an exemplary method for disposing of refuse;

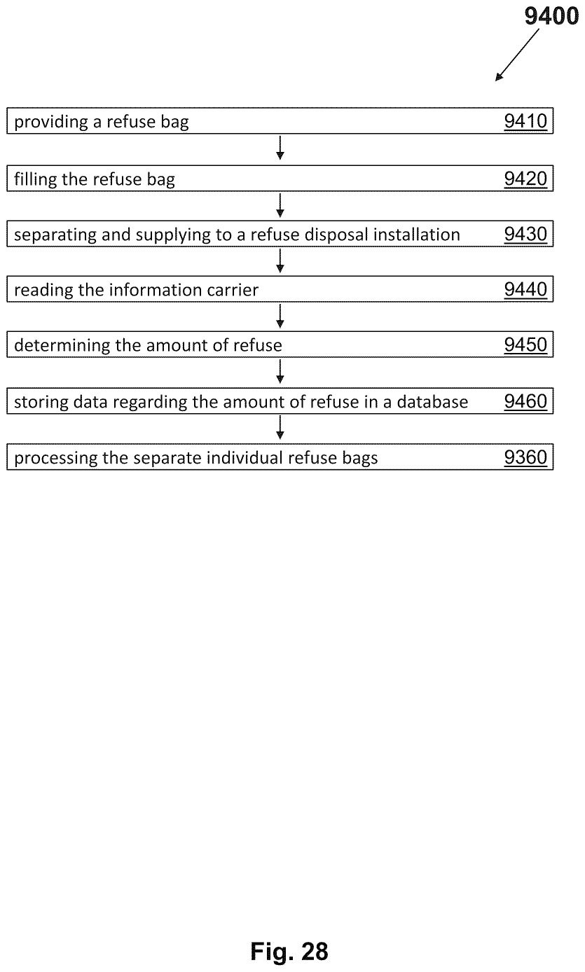

FIG. 28 shows a flow chart of a further exemplary method for disposing of refuse;

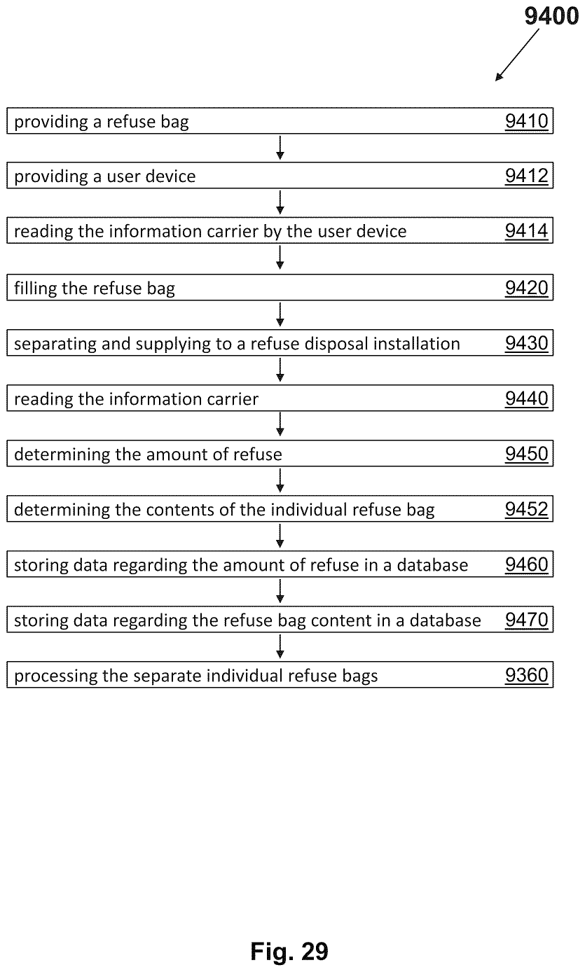

FIG. 29 shows a flow chart of a further exemplary method for disposing of refuse;

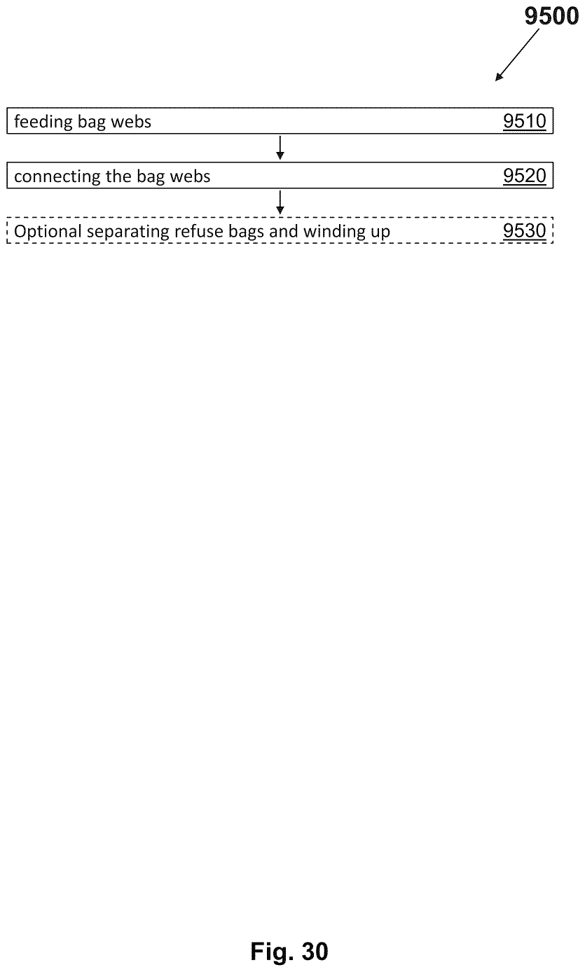

FIG. 30 shows a flow chart of an exemplary method for manufacturing refuse bags;

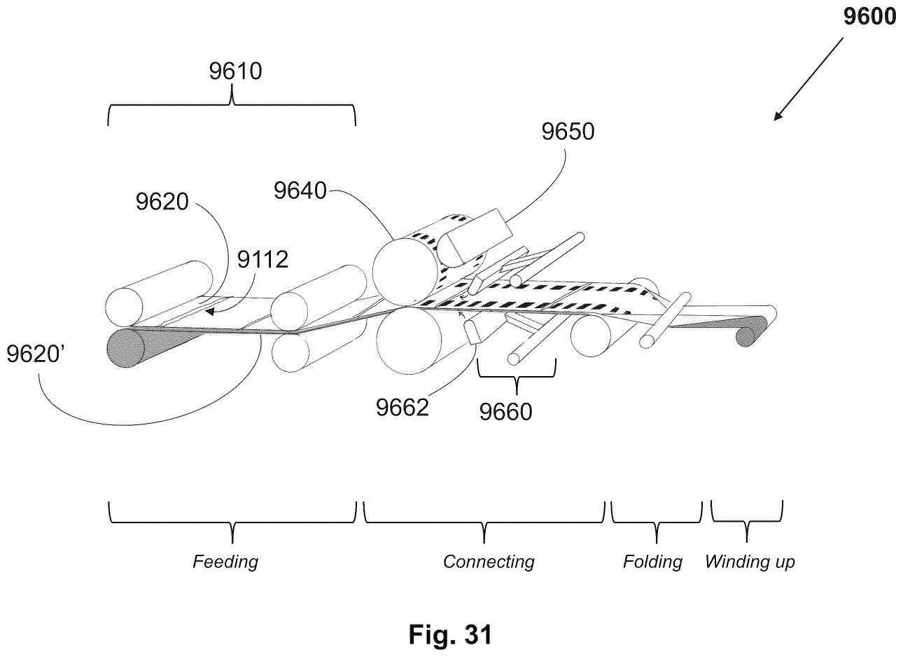

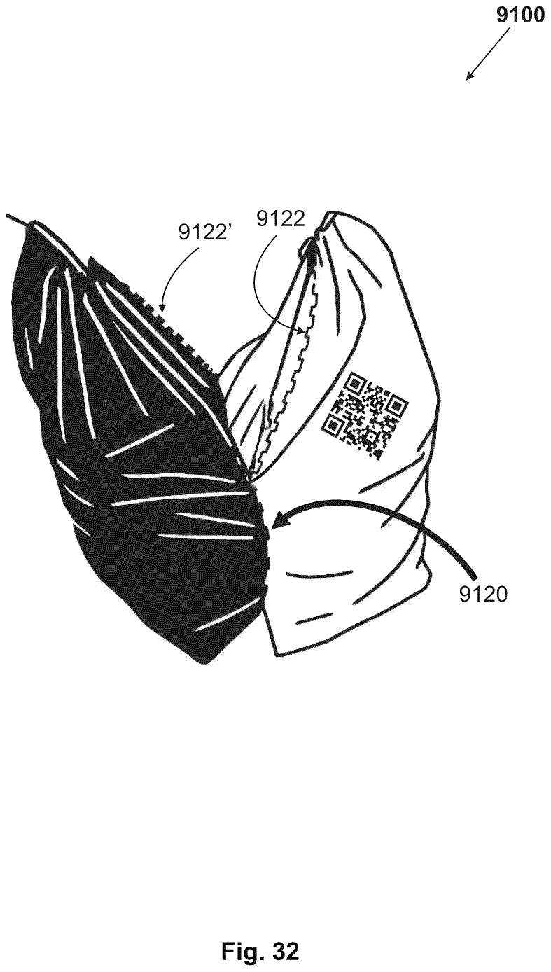

FIG. 31 shows an exemplary apparatus for manufacturing refuse bags;

FIG. 32 shows a schematic illustration of a further exemplary refuse bag in the filled state, in which the refuse bag areas are partially separated from one another.

A refuse bag roll 1 as a whole consists of a plurality of refuse bags 10-1, 10-2 etc. rolled up one after the other, which are separable from one another by material weakenings 12 running in the transverse direction of the refuse bag roll, for example in the form of perforations. Typically, the first refuse bag 10-1 is separated from the second refuse bag 10-2 and used, while the remaining refuse bag roll is kept as stock. The embodiments of refuse bags 10, 10′, 10″, 10′″, 10^{IV} shown below may in principle be provided individually, but are preferably provided by a refuse bag roll of the type of refuse bag roll 1 shown in FIG. 1.

FIG. 2a shows a first variant of a first embodiment of the invention as refuse bag 10; FIG. 2b shows a second variant of this embodiment as refuse bag 10′.

In the refuse bag 10, an outer wall 14 is closed and forms a refuse bag in itself, wherein refuse bag areas 16-1, 16-2 are preferably formed on the inner side of the outer wall, preferably by welding on a connecting wall, wherein the rear side of the respective refuse bags is provided by the outer wall 14, and wherein the individual refuse bag areas are separable from the rest of the refuse bag due to perforations 20. Optionally provided drawstrings 18-1 on the first refuse bag area 16-1 and 18-2 on the second refuse bag area 16-2 are guided by loops, wherein the loops extend on the connecting wall and also on the inner side of the outer wall 14.

In the refuse bag 10′ shown in FIG. 2b according to the second variant of the first embodiment, an open wall is provided as the main bag wall 14′, on which the connecting walls for forming the refuse bag areas 16′-1 and 16′-2 are arranged. Due to the perforation 20′, the main bag wall 10′ may be divided into two parts, each with a refuse bag area, and each part may then be used as a separate refuse bag, in particular disposed of after filling. Optional drawstrings 18′-1 and 18′-2 are also provided here.

In the refuse bag 10″ shown in FIG. 3 according to a second embodiment of the invention, two refuse bag areas 16″-1 and 16″-2 are formed next to each other and each region is provided by a common bag, wherein as connecting walls 22-1 and 22-2 two neighbouring (double) layers are provided which may be separated from one another by a perforation 20″, so as to form separate refuse bags which each have a drawstring 18″-1 and 18″-2 respectively. In this case, the main bag wall is the outer wall of the entire refuse bag 10″, which is not provided with a reference sign in FIG. 3.

In the refuse bag 10′″ shown in FIG. 4 according to a third embodiment, the main bag wall 14′″ is a bag which is open at the top in FIG. 4 and to which the further refuse bag areas 16′″-1, 16′″-2 and 16′″-3 are attached, wherein they are separable at the perforations 20′″-1, 20′″-2 and 20″-3. In principle, this is designed like a glove with detachable fingers. Drawstrings may also be provided here, but these are not shown in FIG. 4.

In the refuse bag 10^{IV} shown in FIG. 5 according to the fourth embodiment of the invention, a plurality of refuse bag areas 16^{IV}-1, 16^{IV}-2, 16^{IV}-3 and 16^{IV}-4 are provided, which are welded together on a strip 30 in the manner of a fold, wherein a preferably single perforation 20^{IV} is formed on the strip. If the strip 30 is torn off, the refuse bag 10^{IV} is divided into the plurality of refuse bag areas 16^{IV}-1, 16^{IV}-2, 16^{IV}-3 and 16^{IV}-4 Each refuse bag area 16^{IV}-1, 16^{IV}-2, 16^{IV}-3 and 16^{IV}-4 has a drawstring; the drawstrings 18^{IV}-1 and 18^{IV}-4 are labelled here as examples. In this embodiment, the individual refuse bag areas 16^{IV}-1 to 16^{IV}-4 may be made particularly well from different materials, for example for paper refuse from paper, for organic refuse from compostable material, in particular compostable plastic, for plastic from plastic film, and for glass from recycled plastic or also aluminium with somewhat thicker and more stable walls.

In the refuse bag 10^{V} shown in FIG. 6 according to a fifth embodiment of the invention, a plurality of refuse bag areas 16^{V}-1, 16^{V}-2, 16^{V}-3 is provided, in which at least one side of the filling opening of a refuse bag area 16^{V}-1, 16^{V}-2, 16^{V}-3 is connected to one side of the filling opening of another refuse bag area 16^{V}-1, 16^{V}-2, 16^{V}-3, wherein the refuse bag areas 16^{V}-1, 16^{V}-2, 16^{V}-3 are separable at the perforations 20^{V}-1 and 20^{V}-2.

In the variant shown in FIG. 7 according to a fifth embodiment of the invention, a refuse bag 10VI is provided with a plurality of refuse bag areas 16^{VI}-1, 16^{VI}-2, 16^{VI}-3 and 16^{VI}-4 are provided, in which two sides of the filling opening of a refuse bag area 16^{VI}-1, 16^{VI}-2, 16^{VI}-3 and 16^{VI}-4 are each connected to one side of the filling opening of another refuse bag area 16^{VI}-1, 16^{VI}-2, 16^{VI}-3 and 16^{VI}-4. The refuse bag areas 16^{VI}-1, 16^{VI}-2, 16^{VI}-3 and 16^{VI}-4 are separable at the perforations 20^{VI}-1 and 20^{VI}-2.

In the refuse bag 10^{VII} shown in FIG. 8 according to a sixth embodiment of the invention, a plurality of individual bags 16^{VII}-1, 16^{VII}-2, 16^{VII}-3 and 16^{VII}-4 are provided, which are connected over their full length to a material projection 32 on a side adjacent to the filling opening, wherein the individual bags 16^{VII}-1 and 16^{VII}-2 are separable from the material protrusion 32 at the perforations 20^{VII}-1, 20^{VII}-2. A connection with the material protrusion 32 over a smaller area, e.g. only in the centre third, is also conceivable. The individual bags 16^{VII}-3 and 16^{VII}-4 are separable from the material protrusion 32 at perforations not provided with reference signs in FIG. 8. The individual bags 16^{VII}-1 to 16^{VII}-4 may be fanned out in this embodiment in the shape of a four-pronged star or a cross. Preferably, the individual bags 16^{VII}-1 to 16^{VII}-4 each have a folded bottom or a cross bottom on the side opposite the filling opening. In this way, the integral stability of the fanned-out refuse bag 10^{VII} could be increased and the refuse bag 10^{VII} could stand upright on its own.

In all of the above embodiments, it may be provided that the size and/or purpose of the refuse bag areas is varied, the latter possibly by colouring and/or labelling. In this way, it is possible to determine which types of refuse occur in a particular user group and in what proportions, and the size ratios for the refuse bag areas may be planned accordingly and some refuse bag areas may be omitted altogether.

The embodiments according to FIGS. 2a, 4 and 5 may be realized with fewer refuse bag areas than shown, and the embodiments according to FIGS. 2a, 2b, 3, 4 and 5 may also be realized with more refuse bag areas than shown.

Without limiting generality, in the following non-limiting examples—with the exception of FIG. 9—the device-readable information carrier is illustrated in each case as an optically readable information carrier in the form of a QR code. Alternatively, the information carrier could for example be implemented as another form of optically readable information carrier, for example as a barcode. Likewise, the information carrier could for example be implemented as a device-readable, in particular contactlessly writable, information carrier, for example as an RFID transponder or NFC chip.

FIG. 9 shows a schematic perspective view of an exemplary refuse bag and of the corresponding exemplary separate individual refuse bags obtained by separating the refuse bag areas. The exemplary refuse bag 1000 is shown in the upper half of FIG. 9, while the exemplary separate individual refuse bags 1110, 1110′, which may be obtained by separation, are shown in the lower half of FIG. 9.

In the non-limiting example of FIG. 9, the refuse bag 1000 has two refuse bag areas 1100, 1100′ arranged next to one another, wherein, as connecting wall between the refuse bag areas 1100, 1100′, two adjacent double layers are provided, which can be separated from one another by a perforation 1120 in order to form the separate individual refuse bags 1110, 1110′ shown in the lower half of FIG. 9. It is likewise conceivable that the refuse bag 1000 has three, four, or an even larger number of refuse bag areas 1100, 1100′ and that a corresponding number of separate individual refuse bags 1110, 1110′ can be obtained by separation of these refuse bag areas. The refuse bag 1000 additionally has a main bag wall, which is formed by the outer wall of the entire refuse bag 1000 not provided with a reference sign in FIG. 9. For example, it is conceivable that, instead of the double layers which realize the connecting wall between the refuse bag areas 1100, 1100′, the two refuse bag areas 1100, 1100′ are directly adhesively bonded or welded to one another in such a way that a material protrusion is present between the refuse bag areas, which can be provided with a corresponding material weakening, for example a perforation 1120.

The front refuse bag area 1100′ facing the viewer in the perspective view and the rear refuse bag area 1100 facing away from the viewer consist for example of an optically radiation-impermeable material, whereby the device-readable information carrier 1200′ positioned on the outer wall of the refuse bag area 1100′ facing away from the viewer is not readable without at least partially separating one of the refuse bag areas 1100, 1100′. The same applies to the device-readable information carrier 1200 on the outer wall of the refuse bag area 1100 facing the viewer. The border of the information carriers 1200, 1200′ by a dashed line is intended to illustrate that the two information carriers are located, from the viewer's perspective, behind the outer wall of the refuse bag area 1100′ facing away from the viewer.

The two information carriers 1200, 1200′ are thus located between the two refuse bag areas 1100, 1100′, wherein the exemplary QR codes face one another. For example, the QR codes could be printed on labels attached to the outer wall of the respective refuse bag areas 1100, 1100′. It is likewise conceivable that the QR codes or other optically device-readable information carriers are applied directly to the outer wall of the refuse bag areas 1100, 1100′, for example by laser marking of the optically radiation-impermeable material.

The connecting wall between the refuse bag areas 1100, 1100′, which is provided with the perforation 1120, runs for example all around the left, upper, right, and lower side of the corresponding outer walls of the refuse bag areas 1100, 1100′, whereby the QR codes are not readable from the outside without at least partial separation taking place. For example, only the left vertical perforation section could be used for opening, so that the refuse bag areas 1100, 1100′ could be moved apart in order to make the QR codes accessible. It is likewise conceivable that the connecting wall runs only on the left, upper, and right side, so that the two refuse bag areas 1100, 1100′ are not connected to one another on the lower side.

In the non-limiting example of FIG. 9, the separation of the refuse bag areas 1100, 1100′ from one another described by an arrow and the word “Separating” has been carried out completely in order to be able to illustrate clearly the arrangement of the QR codes. As explained, it is however likewise conceivable that the refuse bag areas 1100, 1100′ are only partially separated from one another in order to be able to capture the QR codes optically. In FIG. 9, the separate individual refuse bags 1110, 1110′ are in the same orientation relative to one another as is the case for the corresponding refuse bag areas 1100, 1100′ in the upper part of FIG. 9. Thus, corresponding to the information carrier 1200, the separate individual refuse bag 1110 is on the front side facing the viewer and the information carrier 1200′ of the separate individual refuse bag 1110′ is on the rear side facing away from the viewer.

FIG. 10 shows a schematic perspective view of a further exemplary refuse bag 1000 and of the corresponding exemplary separate individual refuse bags 1110, 1110′ obtained by separating the refuse bag areas 1100, 1100′. The refuse bag 1000 and the individual refuse bags 1110, 1110′ substantially correspond to those of FIG. 9. Reference is therefore made to the explanations relating to FIG. 9 for the elements not explicitly described below. In addition to FIG. 9, in the non-limiting example of FIG. 10, a read and/or write protection element 1300 is positioned on the information carrier 1200, which is assigned to the refuse bag area 1100 or the separate individual refuse bag 1110.

The read and/or write protection element 1300 could for example be removed by the user after separation of the individual refuse bag 1110 has taken place, which is indicated in FIG. 10 by the raised lower-right corner of the element. In the exemplary embodiment of FIG. 10, the read and/or write protection element 1300 is for example realized by a paper strip, on the rear side of which a releasable pressure-sensitive adhesive is applied all around. The pressure-sensitive adhesive used has properties such as are customary, for example, in so-called sticky notes, i.e., the adhesive is designed such that the element adheres securely after being applied, but can be removed again without residue and without damage to the information carrier or the carrier material. Further configurations of the read and/or write protection element are likewise conceivable, in which targeted shielding against optical and electromagnetic access is realized. Thus, the read and/or write protection element could for example comprise a metal-containing layer that prevents both radio signals and optical reading methods by reflection of electromagnetic radiation. Alternatively, the protection element could have an electrically conductive structure designed to absorb incident electromagnetic waves in a targeted manner and thereby prevent unauthorized communication or manipulations. A further possibility would consist in configuring the protection element as a multilayer composite structure, in which, through the combination of metallic and polymer-based layers, a comprehensive barrier both against optical and against electromagnetic reading attempts is achieved. It is likewise conceivable that the information carrier 1200′ is also equipped with a corresponding read and/or write protection element, which corresponds for example to the read and/or write protection element 1300 or is alternatively realized in a different manner.

FIG. 11 shows a schematic perspective view of a further exemplary refuse bag 1000′. In the non-limiting example of FIG. 11, the refuse bag 1000′ has on its front side an information carrier 1200″, which could likewise be attached to an inner wall of the refuse bag 1000′ or another outer wall than the front outer wall. In the non-limiting example of FIG. 11, the information carrier 1200″ is an NFC tag having writing functionality. It would likewise be conceivable that it is another device-readable and writable information carrier, in particular a contactlessly writable RFID transponder, such as a UHF tag or a passive RFID chip having reading and writing functionality. The information carrier 1200″, in the form of the exemplary NFC tag having writing functionality, is configured to receive and non-volatilely store data regarding the contents of the refuse bag 1000′ from a user device (not shown in FIG. 11). The user device could for example be realized by a smartphone or a tablet, each of which has means for wireless communication with the exemplary NFC tag, for example via an integrated NFC interface including a corresponding antenna structure. By means of this NFC interface, the user device 1400 could first read out the NFC tag contactlessly and thus establish a communication channel therewith. Via this communication channel, information regarding the contents of the refuse bag 1000′ could then, for example, be transmitted from the user device 1400 to the information carrier 1200″, which stores this information non-volatilely—for example in an integrated EEPROM or in flash memory cells.

The information regarding the contents of the refuse bag 1000′ could for example comprise indications regarding the type of contents (e.g., plastics, organic refuse, paper, batteries/accumulators, metal) or the quantity of the contents. A refuse disposal installation 1500 (not shown in FIG. 11), such as for example a refuse container or a refuse sorting installation, could subsequently read out this information from the information carrier 1200″ and use it in order to guide the refuse bag 1000′ into a specific section within the container or the sorting installation, whereby automated sorting and disposal dependent on contents could be enabled.

FIG. 12 shows a schematic perspective view of a further exemplary refuse bag 1000″. The refuse bag 1000″ shown in the non-limiting example of FIG. 12 substantially corresponds to the refuse bag 1000′ from FIG. 11, wherein it realizes an analogous technical function by slightly different means, for which reason not all advantages and configurations relating to identical or similar features are explicitly repeated, but are hereby made part of the description of FIG. 12. The technical function referred to relates substantially to storage of information regarding the contents of the respective refuse bag, wherein this information is uniquely assigned to the respective refuse bag and retrievable for refuse disposal installations. In contrast to the refuse bag 1000′ from FIG. 11, the refuse bag 1000″ from FIG. 12 has a device-readable, in particular optically readable, information carrier 1200, which could for example be attached to an outer wall or an inner wall of the refuse bag. In the non-limiting example of FIG. 12, this information carrier 1200 is configured as a QR code.

Other device-readable, in particular optically readable, information carriers would likewise be conceivable, for example a barcode in the form of a 1D code, a Data Matrix code, or a ColorCode/High Capacity Color Barcode. The information carrier 1200 is configured such that it causes a user device 1400 (not shown in FIG. 12), as a result of reading the information carrier 1200, to store data regarding the contents of the refuse bag in a database, for example in that corresponding machine-readable instructions are encoded in the information carrier. The user device 1400 could for example be realized by a smartphone or a tablet, each of which has means for reading information carriers, in particular for optical reading, for example an integrated camera unit with corresponding evaluation software for decoding QR codes, barcodes, Data Matrix codes, or comparable optically readable codes.

Storage of the information regarding the contents of the refuse bag could for example be realized by a website connected to a corresponding database and the URL of which is encoded in the QR code. The user device could thereby be caused, by reading the information carrier, for example to call up this website in order to make corresponding inputs there that are stored in a database. It would likewise be conceivable that machine-readable instructions are contained in the QR code which first cause the user device to install software or, if already installed, to execute it. In the software, the data regarding the contents of the refuse bag could then be captured, for example by manual text input, voice input, or by visual recognition of the contents on the basis of video or photo recordings. The data thus captured could be stored by the software in a database. The database could for example be a central database outside the user device, which the user device accesses via an internet connection. It would likewise be conceivable that the data are stored in a local database within the software installed on the user's smartphone, wherein this local database is also reachable from the outside via an internet connection. In the information carrier 1200, for example, a unique identifier is stored which enables unique assignment of the entry in the database to the corresponding refuse bag 1000″.

Analogously to the example from FIG. 11, the information regarding the contents of the refuse bag 1000″ comprises, for example, indications regarding the type of contents (e.g., plastics, organic refuse, paper, batteries/accumulators, metal) or the quantity of the contents. For example, a refuse disposal installation, such as a refuse container or a refuse sorting installation, reads the information carrier 1200 and retrieves, for example on the basis of the identifier stored in the information carrier 1200, the corresponding entry or the stored data regarding the contents of the refuse bag from the database, in order to use this information analogously to the example from FIG. 11 and thereby, for example, guide the refuse bag 1000″ into a specific section within the container or the sorting installation.

FIG. 13 shows a schematic perspective view of a further exemplary refuse bag 1000′″ and of the corresponding exemplary individual refuse bags 1110″, 1110′″ obtained by separating the refuse bag areas 1100″, 1100′″. The exemplary refuse bag 1000″′ is shown in the upper half of FIG. 13, while the exemplary separate individual refuse bags 1110″, 1110′″, which may be obtained by separation, are shown in the lower half of FIG. 13.

In the non-limiting example of FIG. 13, the refuse bag 1000′″ has two refuse bag areas 1100″, 1100′″ arranged next to one another, wherein, as connecting wall between the refuse bag areas 1100″, 1100′″, two adjacent double layers are provided, which can be separated from one another by a perforation 1120′ in order to form the separate individual refuse bags 1110″, 1110′″ shown in the lower half of FIG. 13. It is likewise conceivable that the refuse bag 1000′″ has three, four, or an even larger number of refuse bag areas 1100″, 1100″′ and that a corresponding number of separate individual refuse bags 1110″, 1110′″ can be obtained by separation of these refuse bag areas. The refuse bag 1000′″ additionally has a main bag wall, which is formed by the outer wall of the entire refuse bag 1000′″ not provided with a reference sign in FIG. 13. For example, it is conceivable that, instead of the double layers which realize the connecting wall between the refuse bag areas 1100, 1100′, the two refuse bag areas 1100, 1100′ are directly adhesively bonded or welded to one another in such a way that a material protrusion is present between the refuse bag areas, which can be provided with a corresponding material weakening, for example a perforation 1120. The information carriers 1200 could, as shown by way of example in FIG. 13, be attached on the left side of the refuse bag area 1100′″.

It is likewise conceivable that the information carriers 1200, 1200′—analogously to the example from FIG. 1—are located between the two refuse bag areas 1100″, 1100′″, wherein the exemplary QR codes face one another. For example, the QR codes could be printed on labels attached to the outer wall of the respective refuse bag areas 1100, 1100′. It is likewise conceivable that the QR codes or other optically device-readable information carriers are applied directly to the outer wall of the refuse bag areas 1100″, 1100′″, for example by laser marking of the optically radiation-impermeable material. In this way, the information carriers 1200, 1200′ could for example—analogously to FIG. 1—be readable only after at least partial separation of one of the refuse bag areas 1100″, 1100′″, in this example thus only optically capturable.

For example, the individual refuse bags 1110″, 1110′″ could be such as correspond to the refuse bag 1000′ from FIG. 11 and accordingly, instead of the QR codes, device-readable and writable information carriers are provided, for example NFC tags having writing functionality or contactlessly writable RFID transponders, such as UHF tags or passive RFID chips having reading and writing functionality. In such an example, the refuse bag areas 1100″, 1100′″ would substantially correspond to the refuse bag 1000′, wherein these would be releasably connected to one another. These device-readable and writable information carriers could likewise be positioned—for example analogously to FIG. 1—between the refuse bag areas 1100″, 1100′″ in such a way that they are readable only after at least partial separation of one of the refuse bag areas 1100″, 1100′″. For example, the information carriers 1200, 1200′ of the refuse bag 1000′″ could also be different types of information carriers from one another, for example in one case a QR code and in the other case an NFC tag having writing functionality.

For example, the examples from FIGS. 9 to 13 could be combined with one another. Thus, for example, the refuse bags from FIGS. 11, 12, or 13 could likewise have a read and/or write protection element such as the refuse bag in FIG. 10, wherein for example only one, a plurality, or all information carriers could have such a read and/or write protection element.

FIG. 14 shows a flow chart of an exemplary method 2000 for disposing of refuse. In block 2100, a refuse disposal installation is provided, for example in the form of a refuse container, an automated refuse sorting installation, or a stationary collection system. In block 2150, a refuse bag is provided, for example in the form of an exemplary refuse bag as disclosed in FIG. 11 and the associated figure description. In block 2200, a user device is provided, for example a smartphone or another portable communication device that has means for sending data regarding the contents of the refuse bag to the information carrier, for example an integrated RFID or NFC interface.

In block 2300, the refuse bag is filled by the user with refuse, for example with sorted refuse, such as batteries or accumulators, paper waste, or organic waste. In block 2400, the user device sends data regarding the contents of the filled refuse bag to the associated information carrier, for example by wireless communication by means of RFID or NFC technology. The information regarding the contents of the refuse bag could for example comprise indications regarding the type of contents (e.g., plastics, organic refuse, paper, batteries/accumulators, metal) and/or the quantity of the contents. Capture or generation of the data regarding the contents of the refuse bag can for example be carried out manually by the user, such as by text input. Alternatively or additionally, the data capture could also be carried out automatically, in particular by visual recognition of the contents on the basis of image and/or video data recorded with the user device, wherein the automatic visual recognition could be realized by suitable software modules on the user device. For example, the data regarding the contents of the refuse bag thus determined by visual recognition could subsequently be sent to the information carrier.

In block 2450, the information carrier receives the transmitted data regarding the refuse contents, for example via wireless communication by means of RFID or NFC technology. In block 2500, the information carrier stores the received data non-volatilely, for example in an EEPROM or flash memory, so that they are later retrievable by reading the information carrier. In block 2600, the filled refuse bag is supplied to the refuse disposal installation. For example, the refuse bag is thrown into a refuse container that is, for example, equipped with access control, so that an insertion opening is released only once a valid information carrier has been recognized.

In block 2700, the refuse disposal installation reads out the information carrier with a reading device in order to determine the information stored therein regarding the contents of this specific refuse bag. For example, the refuse disposal installation thus obtains information regarding the type and quantity of the refuse contained in the specific refuse bag.

In block 2800, the refuse disposal installation processes the refuse bag depending on the read-out data, in that the refuse bag is for example supplied to a suitable sorting, recycling, or disposal line. If the refuse disposal installation is configured, for example, as a refuse container, it could have a plurality of sections for different types of waste or refuse, such as for batteries or accumulators, paper, or metal.

Processing of the refuse bag on the basis of the read-out data could for example comprise that the refuse container automatically assigns the supplied refuse bag to a corresponding section on the basis of the data regarding its contents and transports it thereto, so that pre-sorting of the refuse already takes place within the container. A refuse transporter could later, when emptying the container, selectively remove only one or individual types of refuse. Alternatively, the entire container could be picked up by the refuse transporter and supplied, for example, to a recycling plant. There, the individual refuse bags previously pre-sorted on the basis of their contents could be removed from the respective sections and specifically supplied to the corresponding refuse-type-specific recycling paths.

FIG. 15 shows a flow chart of an exemplary method 3000 for disposing of refuse. The exemplary method substantially corresponds to that of FIG. 14. Instead of a writable information carrier in which the data regarding the contents of the refuse bag are stored, the exemplary method shown in FIG. 15 provides that the refuse bag has a device-readable information carrier in which a unique identifier is stored, such as a unique QR code. The information carrier could be read by the user device and cause the latter to store data regarding the contents of the refuse bag in a database. Instead of directly reading the content-related information stored in the information carrier, as provided in the method according to FIG. 14, the method according to FIG. 15 provides that the refuse disposal installation reads the information carrier and, on the basis of the unique identifier stored therein, retrieves the associated information regarding the contents of the refuse bag from a database. Except for the mechanism of storing and retrieving the data regarding the contents of the refuse bag and with regard to the place where these data are stored, the method according to FIG. 15 may otherwise correspond to that according to FIG. 14.

In block 3100, a refuse disposal installation is provided, for example in the form of a refuse container, an automated refuse sorting installation, or a stationary collection system. In block 3150, a refuse bag is provided with a device-readable, in particular optically readable, information carrier, wherein a unique identifier is stored in the information carrier. The refuse bag is for example one such as disclosed in FIG. 12 and the associated figure description.

In block 3200, a user device is provided, for example a smartphone or another portable communication device, which has means for reading the information carrier and for storing data regarding the contents of the refuse bag in a database, for example an integrated camera unit with corresponding decoding software as well as a communication interface, for example a mobile-radio, WLAN, or Bluetooth interface, for transmitting the data to a database. The database may for example be present locally within the software installed on the user device and synchronized with an external, in particular central, database, for example via the internet.

Alternatively, the data could also be stored directly in a database present on an external server, wherein transmission may take place via the aforementioned communication interface, in particular via the internet.

In block 3300, the refuse bag is filled by the user with refuse, for example with sorted refuse, such as batteries or accumulators, paper waste, or organic waste. In block 3400, the user device reads the information carrier in order to determine the unique identifier stored therein. In block 3450, the user device stores the data regarding the contents of the refuse bag in a database using the unique identifier previously read out from the information carrier as a database access key, wherein in particular the database may be a distributed ledger, for example a blockchain. The information regarding the contents of the refuse bag could for example comprise indications regarding the type of contents (e.g., plastics, organic refuse, paper, batteries/accumulators, metal) and/or the quantity of the contents. Capture or generation of the data regarding the contents of the refuse bag can for example be carried out manually by the user, such as by text input or by uploading image or video files. Alternatively or additionally, the data capture could also be carried out automatically, in particular by visual recognition of the contents on the basis of image and/or video data recorded with the user device, wherein the automatic visual recognition could be realized by suitable software modules on the user device.

In block 3500, the filled refuse bag is supplied to the refuse disposal installation. For example, the refuse bag is thrown into a refuse container that is, for example, equipped with access control, so that an insertion opening is released only once a valid information carrier has been recognized. In block 3600, the refuse disposal installation reads out the information carrier with a reading device in order to determine the unique identifier stored therein and thereby obtain access to the data record in the database assigned to the corresponding refuse bag via the unique identifier.

In block 3700, the refuse disposal installation retrieves the information stored in the database regarding the contents of the refuse bag on the basis of the identifier previously determined.

In block 3800, the refuse disposal installation processes the refuse bag depending on the data retrieved from the database, in that the refuse bag is for example supplied to a suitable sorting, recycling, or disposal line. If the refuse disposal installation is configured, for example, as a refuse container, it could have a plurality of sections for different types of waste or refuse, such as for batteries or accumulators, paper, or metal. Processing of the refuse bag on the basis of the information retrieved from the database could for example comprise that the refuse container automatically assigns the supplied refuse bag to a corresponding section and transports it thereto, so that pre-sorting of the refuse already takes place within the container. A refuse transporter could later, when emptying the container, selectively remove only one or individual types of refuse. Alternatively, the entire container could be picked up by the refuse transporter and supplied, for example, to a recycling plant. There, the individual refuse bags previously pre-sorted on the basis of their contents could be removed from the respective sections and specifically supplied to the corresponding refuse-type-specific recycling paths.

FIG. 16 shows a flow chart of an exemplary method 4000 for disposing of refuse. The method shown is similar in basic structure to the method from FIG. 14. The difference consists in that the provided refuse bag has a plurality of refuse bag areas each having an information carrier, which may be filled separately and separated non-destructively, either before or after filling of an individual refuse bag area. By this separation, separate individual refuse bags having information carriers are formed. These individual refuse bags are subsequently—in substantive correspondence to the refuse bag in the method from FIG. 14—each supplied to a refuse disposal installation and there likewise processed in an analogous manner depending on the data read out or retrieved from a database.

The separated individual refuse bags could in this case for example correspond to the refuse bag of the method from FIG. 14, i.e., they could have a contactlessly writable information carrier, such as an NFC tag having writing functionality, that is configured to receive and non-volatilely store data regarding the contents of the refuse bag from a user device.

In block 4100, a refuse disposal installation is provided, for example in the form of a refuse container, an automated refuse sorting installation, or a stationary collection system. In block 4150, a refuse bag is provided, for example in the form of an exemplary refuse bag as disclosed in FIG. 13 and the associated figure description. In block 4200, a user device is provided, for example a smartphone or another portable communication device that has means for sending data regarding the contents of the refuse bag to the information carrier, for example an integrated RFID or NFC interface.

In block 4300, a refuse bag area is filled and separated in order to form a separate individual refuse bag, for example with sorted refuse, such as batteries or accumulators, paper waste, or organic waste. In block 4400, the user device sends data regarding the contents of the filled individual refuse bag to the associated information carrier, for example by wireless communication by means of RFID or NFC technology. The information regarding the contents of the individual refuse bag could for example comprise indications regarding the type of contents (e.g., plastics, organic refuse, paper, batteries/accumulators, metal) and/or the quantity of the contents. In block 4450, the information carrier receives the transmitted data regarding the refuse contents, for example via wireless communication by means of RFID or NFC technology.

In block 4500, the information carrier stores the received data non-volatilely, for example in an EEPROM or flash memory, so that they are later retrievable by reading the information carrier. In block 4600, the filled individual refuse bag is supplied to the refuse disposal installation. For example, the individual refuse bag is thrown into a container that is, for example, equipped with access control, so that an insertion opening is released only once a valid information carrier has been recognized.

In block 4700, the refuse disposal installation reads out the information carrier with a reading device in order to determine the information stored therein regarding the contents of this specific individual refuse bag. For example, the refuse disposal installation thus obtains information regarding the type and quantity of the refuse contained in the specific individual refuse bag.

In block 4800, the refuse disposal installation processes the individual refuse bag depending on the read-out data, in that the individual refuse bag is for example supplied to a suitable sorting, recycling, or disposal line. If the refuse disposal installation is configured, for example, as a refuse container, it could have a plurality of sections for different types of waste or refuse, such as for batteries or accumulators, paper, or metal. Processing of the individual refuse bag on the basis of the read-out data could for example comprise that the refuse container automatically assigns the supplied individual refuse bag to a corresponding section on the basis of the data regarding its contents and transports it thereto, so that pre-sorting of the refuse already takes place within the container. A refuse transporter could later, when emptying the container, selectively remove only one or individual types of refuse. Alternatively, the entire container could be picked up by the refuse transporter and supplied, for example, to a recycling plant. There, the individual refuse bags previously pre-sorted on the basis of their contents could be removed from the respective sections and specifically supplied to the corresponding refuse-type-specific recycling paths.

FIG. 17 shows a flow chart of an exemplary method 5000 for disposing of refuse. The method shown is similar to the method from FIG. 15, for which reason not all advantages and configurations relating to identical or similar steps are explicitly repeated, but are hereby made part of the description of FIG. 17. The difference from the method from FIG. 15 consists in that the provided refuse bag has a plurality of refuse bag areas each having an information carrier, which may be filled separately and separated non-destructively, either before or after filling of an individual refuse bag area. By this separation, separate individual refuse bags having information carriers are formed. These individual refuse bags are subsequently—in substantive correspondence to the refuse bag in the method from FIG. 15—each supplied to a refuse disposal installation and there likewise processed in an analogous manner depending on the data read out or retrieved from a database. The separated individual refuse bags could in this case for example correspond to the refuse bag of the method from FIG. 15, i.e., they could have a device-readable, in particular optically readable, information carrier having a unique identifier, such as a QR code, that is configured to cause the user device to store data regarding the contents of the refuse bag in a database.

In block 5100, a refuse disposal installation is provided, for example in the form of a refuse container, an automated refuse sorting installation, or a stationary collection system. In block 5150, a refuse bag is provided, for example in the form of an exemplary refuse bag having a plurality of refuse bag areas, such as disclosed in FIG. 13 and the associated figure description, wherein the refuse bag areas are each provided with a device-readable, in particular optically readable, information carrier in which a unique identifier is stored.

In block 5200, a user device is provided, for example a smartphone or another portable communication device, which has means for reading the information carrier and for storing data regarding the contents of the refuse bag in a database, for example an integrated camera unit with corresponding decoding software as well as a communication interface, for example a mobile-radio, WLAN, or Bluetooth interface, for transmitting the data to a database. The database may for example be present locally within the software installed on the user device and synchronized with an external, in particular central, database, for example via the internet.

Alternatively, the data could also be stored directly in a database present on an external server, wherein transmission may take place via the aforementioned communication interface, in particular via the internet.

In block 5300, a refuse bag area is filled and separated in order to form a separate individual refuse bag, for example with sorted refuse, such as batteries or accumulators, paper waste, or organic waste. In block 5400, the user device reads the information carrier in order to determine the unique identifier stored therein. In block 5450, the user device stores the data regarding the contents of the individual refuse bag in a database using the unique identifier previously read out from the information carrier as a database access key, wherein in particular the database may be a distributed ledger, for example a blockchain. The information regarding the contents of the individual refuse bag could for example comprise indications regarding the type of contents (e.g., plastics, organic refuse, paper, batteries/accumulators, metal) and/or the quantity of the contents. Capture or generation of the data regarding the contents of the individual refuse bag can for example be carried out manually by the user, such as by text input or by uploading image or video files. Alternatively or additionally, the data capture could also be carried out automatically, in particular by visual recognition of the contents on the basis of image and/or video data recorded with the user device, wherein the automatic visual recognition could be realized by suitable software modules on the user device.

In block 5500, the filled individual refuse bag is supplied to the refuse disposal installation. For example, the individual refuse bag is thrown into a refuse container that is, for example, equipped with access control, so that an insertion opening is released only once a valid information carrier has been recognized. In block 5600, the refuse disposal installation reads out the information carrier with a reading device in order to determine the unique identifier stored therein and thereby obtain access to the data record in the database assigned to the corresponding individual refuse bag via the unique identifier. In block 5700, the refuse disposal installation retrieves the information stored in the database regarding the contents of the individual refuse bag on the basis of the identifier previously determined.

In block 5800, the refuse disposal installation processes the individual refuse bag depending on the data retrieved from the database, in that the individual refuse bag is for example supplied to a suitable sorting, recycling, or disposal line. If the refuse disposal installation is configured, for example, as a refuse container, it could have a plurality of sections for different types of waste or refuse, such as for batteries or accumulators, paper, or metal. Processing of the individual refuse bag on the basis of the information retrieved from the database could for example comprise that the refuse container automatically assigns the supplied individual refuse bag to a corresponding section and transports it thereto, so that pre-sorting of the refuse already takes place within the container. A refuse transporter could later, when emptying the container, selectively remove only one or individual types of refuse.

Alternatively, the entire container could be picked up by the refuse transporter and supplied, for example, to a recycling plant. There, the individual refuse bags previously pre-sorted on the basis of their contents could be removed from the respective sections and specifically supplied to the corresponding refuse-type-specific recycling paths.

FIG. 18 shows a flow chart of a further exemplary method for disposing of refuse. The exemplary method is similar to those from FIGS. 14 to 17, for which reason not all advantages and configurations relating to identical or similar steps are explicitly repeated, but are hereby made part of the description of FIG. 18. Compared with the methods from FIGS. 14 to 17, the method from FIG. 18 comprises additional method steps that make it possible to uniquely assign the contents of the respective refuse bag to a user account. This makes it possible, for example, to carry out user-specific billing on the basis of information stored in an electronic account system.

In block 6050, execution of the steps of an exemplary refuse disposal method is provided, which for example corresponds to those of the methods according to FIGS. 14 to 17. In particular, the method, the steps of which are carried out in block 6050, comprises providing a refuse bag having an information carrier, storing data regarding its contents in the information carrier or in a database, supplying it to the refuse disposal installation, and reading or retrieving these data and processing the refuse bag by the refuse disposal installation on the basis of these data.

In block 6100, an electronic account system is provided in which a uniquely assigned user account is stored for a user. The electronic account system is functionally coupled to the refuse disposal installation so that information regarding the contents of the refuse bag can be linked to a user account and stored for further processing, for example for billing purposes. The electronic account system could for example be realized by means of a cloud service, a municipal billing system, or a central administrative database. In particular, the electronic account system could be implemented by means of a distributed ledger, in particular a blockchain, for example in order to ensure particularly tamper-resistant and transparent storage of the user and disposal data. By use of a distributed ledger, it could be ensured that subsequent changes to the stored entries are technically considerably hindered or excluded, whereby particularly trustworthy assignment of disposal processes to individual user accounts would be enabled.

In block 6200, the refuse disposal installation identifies the user in order to determine the user account uniquely assigned to said user in the account system.

The identification could for example take place on the basis of a unique identifier stored in the information carrier of the refuse bag and already linked to the user, which would be read out by a reading device and assigned to the corresponding user account in the account system. Authentication of the user via said user's user device, for example via the user's smartphone which communicates with the system upon insertion of the refuse bag, for example via Bluetooth, or via an ID card, a combination of username and password, or by manual entry of a username at a terminal of the refuse disposal installation, would likewise be conceivable.

In block 6300, the refuse bag supplied to the refuse disposal installation as well as the associated previously stored data regarding its contents are assigned to the user account identified in the account system. This assignment could be realized by a corresponding entry in the electronic account system. In this way, it would be ensured that each disposal action can be assigned to a specific user. This could form the basis for a plurality of follow-up functions, such as user-specific billing of disposal costs, creation of usage statistics, or checking compliance with certain disposal guidelines.

Optionally, the method additionally comprises block 6400. In this block, a message is output to the user that the refuse bag has been successfully assigned to the user account. This message could for example contain information on the type of assigned refuse contents. The output could for example take place in the form of text, a sound, or a melody. The output takes place via the user device, such as a smartphone, a tablet, or a smartwatch, for example via software installed on the user device or a website called up on the user device, which are each functionally coupled to the refuse disposal installation, for example the output is realized by a pop-up or a push notification. It is likewise conceivable that the output takes place via the refuse disposal installation itself, for example via an integrated display or an acoustic signal of a container. By this feedback, the user could immediately recognize whether the assignment was successful, which in turn would increase transparency and traceability of the disposal process.

For example, in the exemplary method from FIG. 18, the electronic account system could comprise a distributed ledger, in particular a blockchain, or be realized thereby, wherein the entry in the electronic account system could be generated or secured using a cryptographically secured token. The cryptographic token could serve as digital proof that an assignment of a refuse bag to a user account has taken place and could in particular represent a verifiable, tamper-proof, and system-internally uniquely identifiable value assigned to the respective user account. Realization or securing of the token could take place by digital signatures, public-key infrastructures, or similar cryptographic methods or be supported by such methods. For example, by use of these cryptographic mechanisms, it could be ensured that each entry in the electronic account system is uniquely authenticated and immutable, whereby integrity and traceability of the disposal and assignment processes could be improved. The cryptographic token could for example represent a billing unit or a verified identifier that could be used for further processing steps, for example for user-specific billing, for payment for goods or services, for allocations of value in bonus or discount programs, or for statistical evaluation.

FIG. 19 shows a schematic illustration of an exemplary refuse bag roll 7000. The refuse bags 1000-1, 1000-2 rolled up one after the other may for example be such refuse bags as are shown in one of FIGS. 9 to 14 or described in the corresponding figure description. The refuse bags 1000-1, 1000-2 rolled up one after the other are, for example, separable from one another by the material weakenings 7100 extending in the transverse direction of the refuse bag roll 7000. The material weakening 7100 is realized, for example, by a perforation or by regional material thinning. The refuse bags 1000-1, 1000-2 rolled up one after the other lie in the refuse bag roll 7000 transversely to the longitudinal extension thereof, so that the opening side of the refuse bags points to one side, for example to the side facing away from the viewer, which in the example of FIG. 19 lies on the side opposite the indicated spiral facing the viewer. The refuse bags may for example be rolled up one after the other on a cardboard or plastics roll or may also be rolled up one after the other without such a supporting structure, in that a web of a plurality of refuse bags connected to one another is wound up to form such a refuse bag roll 7000.

FIG. 20 shows a schematic illustration of an exemplary refuse disposal system 8000. The refuse disposal system 8000 comprises a refuse bag 8100, such as is shown for example in one of FIGS. 9 to 14 or described in the associated figure description or at another point in this description, as well as a user device 8200. The refuse bag 8100 has a device-readable information carrier 8150, which may for example be embodied as an optically readable information carrier, for example in the form of a QR code—as shown in FIG. 20—or for example as a contactlessly writable information carrier, for example as an RFID transponder or NFC tag.

The user device 8200 may correspond to the user device 1400 described in the description of the preceding figures and may for example be realized by a smartphone or another portable communication device which has means for reading information carriers, such as an integrated camera unit having corresponding decoding software or an NFC or RFID interface. The user device 8200 furthermore has means for sending data regarding the contents of the refuse bag 8100 to the information carrier, for example an integrated NFC interface having corresponding transmission and control software. Alternatively or additionally, the user device 8200 has means for storing data regarding the contents of the refuse bag 8100 in a database, for example a local database integrated into the software installed on the user device 8200 or a communication interface for transmitting the data to an external database, for example via a mobile-radio, WLAN, or Bluetooth connection. The database in which the data are stored may for example be present locally on the user device 8200 or may be located externally, for example within a cloud service or a central server. In particular, the database may be realized as a distributed ledger, in particular as a blockchain, in order to enable tamper-resistant, transparent, and long-term verifiable storage of the refuse bag and user data.

FIG. 21 shows an exemplary refuse bag roll 910. In the non-limiting example, a plurality of refuse bags 9100, 9200 are wound up on the refuse bag roll 910 in a manner arranged one behind the other and connected to one another, or form the refuse bag roll 910. In this example, each refuse bag 9100, 9200 consists of two refuse bag areas 9110, 9110′ arranged next to one another. In the example shown, the refuse bag areas 9110, 9110′ are connected to one another by a releasable adhesive bond in the form of a releasable connecting seam 9120, releasable by contactless energy input, and each have their own filling opening 9112 and 9112′, respectively. A corresponding releasable connection of the refuse bag areas 9110, 9110′ by means of magnetically acting elements is likewise conceivable. In FIG. 21, the connecting seam 9120 is illustrated by way of example by a dashed line and, in the example shown, extends in the region of the respective filling openings 9112, 9112′ of the refuse bag areas. For example, the connecting seam 9120 could be provided only in sections or punctiform in the region of the filling openings 9112 and 9112′, respectively. Alternatively or additionally, a connecting seam 9120 could be implemented which extends at least in sections on the sides of the refuse bag areas 9110, 9110′ which adjoin the filling openings 9112 and 9112′, respectively.

Between two adjacent refuse bags 9100, 9200 there is in each case a material weakening 9114, for example in the form of a perforation, which is indicated in FIG. 21 by a dotted line. This material weakening 9114 makes it possible to separate individual refuse bags 9100, 9200 segment by segment from the refuse bag roll 910.

After separation of a refuse bag 9100, 9200—which in this non-limiting example consists of two refuse bag areas 9110, 9110′ connected to one another via the connecting seam 9120—the individual refuse bag areas 9110, 9110′ can be filled by the user with different types of refuse, for example residual refuse or municipal refuse in one refuse bag area and recyclable plastics in the other refuse bag area, and can for example be supplied to a refuse disposal installation via a suitable collection container. There, in the case of a corresponding adhesive bond releasable by contactless energy input, the connecting seam 9120 can be selectively released by targeted energy input, for example by means of UV, IR, or microwave radiation.

For this purpose, the refuse disposal installation—for example a large-volume container, a refuse transporter, or a refuse sorting installation—could be equipped with a corresponding apparatus. Such an apparatus could for example comprise a high-performance UV lamp or a UV laser, by means of which targeted action is exerted on the adhesive bond. Alternatively, infrared sources, for example in the form of IR radiators or infrared lamps, could also be used in order to bring about thermal activation of the adhesive bond. Likewise, a microwave chamber could be provided into which the refuse bag 9100 is briefly introduced in order to initiate targeted degradation of the adhesive components by electromagnetic radiation.

In addition, combined systems are also conceivable in which, for example, UV and IR radiation are used simultaneously or in a coordinated sequence in order to achieve particularly effective separation. Such apparatuses could additionally be equipped with optical detection units which detect the section of the refuse bag 9100 to be irradiated, as well as with a positioning device for precise alignment of the refuse bag 9100 in the radiation field.

The energy introduced in this way causes a targeted change in the adhesive within the releasable adhesive bond, for example by chemical degradation of one or more components of the adhesive, or by physical effects such as a reduction in viscosity, a phase transition, a change in crystallinity, or a reduction in surface tension. Thus, for example, local softening or melting of amorphous adhesive constituents could occur through infrared irradiation, whereby the adhesive force is reduced. A targeted drop in viscosity could cause the adhesive surfaces to separate from one another under low tensile load. In the case of crystalline adhesive constituents, a targeted phase transition to the amorphous state could reduce their cohesion. Alternatively, UV-induced photochemical cleavage or rearrangement of functional groups in the adhesive could lead to structural weakening, so that the connecting seam largely loses its adhesive function. In this case, either the entire refuse bag 9100 can be exposed to the energy input or only the region of the connecting seam 9120—in the example shown according to FIG. 21, therefore, for example, the section in the region of the filling openings 9112, 9112′ of the refuse bag areas 9110, 9110′.

FIG. 22 shows a schematic illustration of an exemplary refuse bag 9100, 9200 inserted into a waste bin 9130. The exemplary refuse bags 9100, 9200 may for example be such as are wound up on the refuse bag roll 910 from FIG. 21. Owing to the releasable connecting seam 9120, which is indicated by a dashed line and is located between the refuse bag areas 9110, 9110′ and 9210, 9210′, respectively, and owing to the tensioning of the entire refuse bag 9100, 9200 produced by the waste bin 9130, the filling openings 9112, 9112′ of the individual refuse bag areas 9110, 9110′ are fixed in an open state and together form the filling opening 9111 of the refuse bag 9100. For example, releasable seam connections 9120 could additionally be provided on those sides of the refuse bag areas 9110, 9110′ which adjoin the filling openings 9112 and 9112′, respectively, which increase the structural stability of the refuse bag 9100, 9200. A connecting seam 9120 formed in such a substantially U-shaped manner around the refuse bag areas 9110, 9110′—except for the side opposite the filling opening 9112, 9112′—could substantially improve the structural integrity of the refuse bag 9100, 9200 in the inserted state within the waste bin 9130. In this way, a stable structure could be ensured in which separate alignment of the individual refuse bag areas 9110, 9110′ is unnecessary. In particular, undesirable adhesion of the inner walls of the refuse bag areas 9110, 9110′, for example as a result of electrostatic charging, could be prevented or at least reduced. This in turn facilitates filling of the refuse bag areas 9110, 9110′, in particular with refuse of low density, such as light film packaging, since the filling openings 9112, 9112′ are maintained in an open state and sticking or blocking of the inner surfaces is avoided.

FIG. 23 shows a schematic illustration of an exemplary refuse bag 9100, 9200 in the filled state. This may for example be the refuse bag 9100, 9200 from FIG. 22 which was previously filled within a waste bin 9130 and subsequently removed therefrom. The adhesion together of the two refuse bag areas 9110, 9110′ brought about by the releasable connecting seam 9120 is clearly visible. This connection could improve handling of the refuse bag 9100, 9200 in that, when removing it from the waste bin 9130 and during subsequent transport to a refuse container, only a single refuse bag and not two separate individual refuse bags need be handled. Since the refuse bag areas 9110, 9110′ are held in a defined spatial relationship to one another by the connecting seam 9120, twisting, folding over, or uncontrolled falling apart of the refuse bag areas 9110, 9110′, compared with individual refuse bags spatially separated from one another, could be prevented.

FIG. 24 shows a schematic illustration of an exemplary refuse bag 9100, 9200 in the filled state, in which the refuse bag areas 9110, 9110′ are partially separated from one another. In the example illustrated, the refuse bag areas 9110, 9110′ are released from one another in the upper third, while the releasable connecting seam 9120 continues to exist in the lower two thirds and connects the refuse bag areas 9110, 9110′ to one another. In this non-limiting example, the refuse bag area 9110 shown on the right in FIG. 24 additionally has a device-readable information carrier in the form of a QR code. By means of this QR code, a unique identifier stored in the QR code could be read out with the aid of a corresponding user device, for example a smartphone, which could enable unique identification of the individual refuse bag. After reading out the identifier stored in the QR code, this could be used as an access key to the database. The user could then capture and store information regarding the contents of the respective refuse bag area 9110 by means of the user device. This could, among other things, improve traceability of the waste, enable sorting or classification of the refuse on a digital basis, and support later automated further processing by a refuse disposal installation.

FIG. 25 shows a schematic illustration of an exemplary refuse bag 9200 and corresponding exemplary individual refuse bags obtained by separating the refuse bag areas 9210, 9210′. In the example shown, the refuse bag areas 9210, 9210′ are connected to one another by means of magnetically acting elements 9220, 9220′. In the illustration of FIG. 25, the two refuse bag areas 9210, 9210′ are shown spaced apart from one another purely for illustrative purposes in order to make the magnetically acting elements 9220, 9220′ visible. The exemplary refuse bag 9200 in reality consists of connected, non-spaced-apart refuse bag areas 9210, 9210′.

In this non-limiting example, the magnetically acting elements 9220, 9220′ are realized by application of a magnetic layer in corresponding segments of the outer walls at the upper side of the refuse bag areas 9210, 9210′. This can for example be effected by the use of an adhesive containing magnetic particles or by a corresponding magnetic paint which is applied within corresponding segments during manufacture of the refuse bags. Likewise conceivable as a magnetically acting element 9220 is a corresponding circumferential or, for example, a U-shaped magnetic layer in corresponding segments which, with the exception of the lower side in FIG. 25, runs around all sides of the two refuse bag areas 9210, 9220′.

Alternatively or additionally, it is conceivable that the material of which the refuse bag areas 9210, 9210′ consist itself contains magnetic particles. In this way, an extensive, reversibly releasable connection between the refuse bag areas 9210, 9210′ could be achieved by means of the magnetically acting elements 9220, 9220′. It is likewise possible that only certain specifically selected regions of the refuse bag areas 9210, 9210′ are equipped with magnetically acting particles, whereby segmented connecting points would be created.

The connection of the refuse bag areas 9210, 9210′ via magnetically acting elements 9220, 9220′ could permit repeated releasable or reversible separation of the refuse bag areas 9210, 9210′. In this way, it would be possible for the user to rearrange or reposition the refuse bag areas after separation. This would increase flexibility of handling, for example with regard to situation-dependent use or adaptation to different collection container configurations. Temporary separation for the purpose of separate filling and subsequent reconnection would also be conceivable.

FIG. 26 shows a further example of a refuse bag 9200 in which three refuse bag areas 9210, 9210′, 9210″ are connected to one another by magnetically acting elements 9220, 9220′, 9220″. In the illustration of FIG. 26, the three refuse bag areas 9210, 9210′, 9210″ are shown spaced apart from one another purely for illustrative purposes in order to make the magnetically acting elements 9220, 9220′, 9220″ visible. The exemplary refuse bag 9200 in reality consists of connected, non-spaced-apart refuse bag areas 9210, 9210′, 9210″. In this case, the refuse bag area 9210 arranged perspectively farther to the rear is of larger size than the two refuse bag areas 9210′ and 9210″ arranged farther to the front from the viewer's perspective. In the example shown, the magnetically acting elements 9220, 9220′, 9220″ are formed as continuous segments at the upper side of the respective refuse bag areas 9210, 9210′, 9210″. This arrangement permits a stable yet reversibly releasable connection along the upper edges of the refuse bag areas.

By this configuration, the user can, after separation of the refuse bag areas, reconnect them in different arrangements. For example, the two smaller refuse bag areas 9210′, 9210″ could be connected to one another, while the larger area 9210 is used separately or positioned elsewhere. Likewise, the larger area 9210 could optionally be coupled with only one of the two smaller areas 9210′ or 9210″.

This modular structure permits an application-related configuration of the refuse bag 9200, whereby different requirements with respect to volume distribution, waste separation, or fastening variants can be flexibly taken into account. The user thereby obtains an adaptable solution for different disposal scenarios, for example for separate collection of different types of waste within a uniform system. The reversibly releasable magnetically acting elements 9220, 9220′, 9220″ ensure simple and reversible handling without an additional fastening means.

It is likewise conceivable that the magnetically acting element is formed in the form of a circumferential segment extending along all four sides of a refuse bag area or, in the case of a round refuse bag, extending completely around it. In this way, the refuse bag areas could be connected to one another in almost any orientation, whereby the flexibility of configurability is further increased. An arrangement of the magnetically acting elements on a plurality of sides or additionally in large-area form is also conceivable in order to achieve an extensive, direction-independent holding effect. It can be provided here that the filling openings of the refuse bag areas are not held together by the magnetically acting elements. This could for example be realized by a protective layer applied at the inner side of the filling openings, which selectively shields or reduces the magnetic interaction in this region. Likewise conceivable is a targeted arrangement of the magnetically acting elements outside the filling opening regions in order to ensure free accessibility thereof. For certain applications, for example when handling types of waste associated with particularly strong odours, it may however be advantageous that the magnetically acting elements bring about automatic closing of the filling openings. In this way, odours or other gaseous or volatile substances could escape from the refuse bag only when the filling opening is manually opened or held open. The magnetic holding force thereby generated could bring about passive re-closing, which, in particular during brief setting down or transport of the refuse bag, permits a functional closure without additional mechanical closure means.

Instead of the examples shown in FIGS. 5 and 6, a plurality of refuse bag areas, not necessarily of equal size, could also be reversibly connected to one another. Thus, for example, three smaller bags for types of waste which usually occur only in small quantities or have a small volume—such as hazardous waste, for example batteries, or organic waste—could be combined with one larger bag for residual refuse or recyclable plastics, which generally occupy a larger volume. By such an arrangement, a volume- and waste-type-specific subdivision within a single, modularly constructed refuse bag system could be realized, which supports targeted and user-friendly waste separation.

For example, the examples from FIGS. 1 to 6 could be combined with one another. Thus, for example, a refuse bag could be provided in which two refuse bag areas are specifically reversibly connected to one another by a releasable adhesive bond. Additional magnetically acting elements could be provided on these two refuse bag areas adhesively bonded to one another, which permit one or more further refuse bag areas to be coupled on without a further adhesive application being required. This could combine the advantages of a stable, structurally coherent basic unit-ensured by the adhesive bond—with the flexibility of modular expandability by means of the magnetically acting elements. The user could thus adapt the refuse bag system to changing requirements with respect to volume or waste separation by temporarily attaching additional refuse bag areas when needed and removing them again when not in use.

FIG. 27 shows a flow chart of an exemplary method 9300 for disposing of refuse. In block 9310, a refuse bag is provided which has a plurality of refuse bag areas fillable via at least one common filling opening. The refuse bag areas are here connected to one another by a releasable adhesive bond, wherein the adhesive is configured so that it can be released by contactless energy input. The refuse bag can for example be embodied in the form of one of the examples shown in FIGS. 1 to 4 and described in the corresponding figure description.

In block 9320, the refuse bag is filled by the user. Here, each refuse bag area is filled via its filling opening with refuse of a different type, for example for pre-sorted collection of types of waste such as organic refuse, plastic, or non-recyclable residual refuse.

In block 9330, the filled refuse bag is supplied to a refuse disposal installation, for example by placing the refuse bag in a container or handing it over to a person who accepts filled refuse bags, for example in the outdoor/camping sector or at large events such as music or cultural festivals.

In block 9340, targeted release of the adhesive bond takes place by contactless energy input. For this purpose, for example UV, IR, or microwave radiation can be used, which acts on the adhesive bond and there causes a chemical or physical change in the adhesive, whereby its adhesive effect is reduced or completely eliminated. The energy input can take place at various points in the disposal process. Thus, it can take place within a stationary collection container equipped with integrated radiators which are automatically activated upon insertion or after closing of the lid. Alternatively, the energy input can take place within a refuse transporter or refuse collection vehicle which, when emptying refuse containers or compacting the collected material, contains corresponding activation units for targeted irradiation. Implementation in an upstream or central pre-sorting installation is also conceivable, for example in that radiation is applied selectively to predefined regions of the refuse bags during transport on a conveyor belt.

In block 9350, the refuse bag areas now released from one another are separated, so that separate individual refuse bags are present. This takes place automatically by the refuse disposal installation, for example by mechanical separation modules or pulling devices. Separation preferably takes place without damaging the individual refuse bags.

In block 9360, the individual refuse bags now separated are processed according to their contents. This can for example be effected by assignment to type-specific further processing lines such as fermentation, material recycling, or thermal recovery.

FIG. 28 shows a flow chart of a further exemplary method 9400 for disposing of refuse. In block 9410, a refuse bag is provided which comprises at least two separable refuse bag areas. These refuse bag areas are connected to one another either by magnetically acting elements or by a releasable adhesive bond. At least one of the refuse bag areas here has a device-readable information carrier in which a unique identifier is stored, such as a QR code or an RFID chip or NFC tag. The refuse bag areas are fillable via at least one common filling opening and can, after separation, be further processed as separate individual refuse bags.

In block 9420, the refuse bag, i.e. the refuse bag areas, is filled with refuse by the user. Here, the refuse bag areas can be filled selectively with different types of waste, for example residual refuse, organic refuse, batteries, or recyclable materials.

In block 9430, the filled refuse bag is either supplied as a whole to a refuse disposal installation, which subsequently separates the refuse bag areas in order to obtain and process the individual refuse bags having the information carrier, or the refuse bag areas are first separated by the user, whereupon that individual refuse bag which contains the information carrier is supplied separately to the disposal installation.

In block 9440, the refuse disposal installation reads out the information carrier by means of a reading device, for example an RFID or NFC reading module or an optical capture unit for reading QR codes, in order to determine the stored unique identifier. This can take place by a fixedly integrated reading module, for example when passing through a capture tunnel, when being drawn in by an automated gripping system, or by sensor-based detection units within the installation. The optical capture unit can for example be embodied as a stationary camera having image recognition software or as a scanner-based solution in combination with image processing hardware.

In block 9450, the refuse disposal installation determines the amount of refuse of the respective individual refuse bag. This can for example be effected by weighing, by volume measurement with optical sensors, or by capacitive detection.

In block 9460, the determined data regarding the amount of refuse are stored in a database. The unique identifier previously read out from the information carrier is thereby used as a database access key in order to enable unique assignment of the measurement data. Storage can take place either by the user device, which transmits the data directly to a central database after determination, or by the refuse disposal installation itself.

In block 9360, the individual refuse bag is processed by the refuse disposal installation, wherein the processing is performed depending on the stored data regarding the amount of refuse and the type of contents. The processing can for example comprise assignment to a specific recovery path, implementation of a material-dependent treatment, or targeted forwarding to a downstream treatment or disposal stage. In this way, a waste-type-appropriate and data-based treatment of the individual refuse bag is enabled.

FIG. 29 shows a flow chart of a further exemplary method 9400 for disposing of refuse. In block 9410, a refuse bag is provided which comprises at least two separable refuse bag areas. These refuse bag areas are connected to one another either by magnetically acting elements or by a releasable adhesive bond. At least one of the refuse bag areas here has a device-readable information carrier in which a unique identifier is stored, such as a QR code or an RFID chip or NFC tag. The refuse bag areas are fillable via at least one common filling opening and can, after separation, be further processed as separate individual refuse bags.

In block 9412, a user device is provided which has means for reading out the information carrier. This may for example be a smartphone having an integrated RFID or NFC interface or a portable reading device such as is used in professional collection or sorting systems. The user device can additionally comprise means for displaying or temporarily storing read-out data.

In block 9414, the user device reads out the information carrier in order to determine the unique identifier stored in the information carrier. This can take place before or after filling and serves for unique assignment of the respective refuse bag area. The data are stored locally or transmitted directly to an external database.

In block 9420, the refuse bag, i.e. the refuse bag areas, is filled with refuse by the user. Here, the refuse bag areas can be filled selectively with different types of waste, for example residual refuse, organic refuse, batteries, or recyclable materials.

In block 9430, the filled refuse bag is either supplied as a whole to a refuse disposal installation, which subsequently separates the refuse bag areas in order to obtain and process the individual refuse bags having the information carrier, or the refuse bag areas are first separated by the user, whereupon that individual refuse bag which contains the information carrier is supplied separately to the refuse disposal installation.

In block 9440, the refuse disposal installation reads out the information carrier by means of a reading device, for example an RFID or NFC reading module or an optical capture unit for reading QR codes, in order to determine the stored unique identifier. This can take place by a fixedly integrated reading module, for example when passing through a capture tunnel, when being drawn in by an automated gripping system, or by sensor-based detection units within the installation. The optical capture unit can for example be embodied as a stationary camera having image recognition software or as a scanner-based solution in combination with image processing hardware.

In block 9450, the refuse disposal installation determines the amount of refuse of the respective individual refuse bag. This can for example be effected by weighing, by volume measurement with optical sensors, or by capacitive detection.

In block 9452, additionally or alternatively, the contents of the individual refuse bag are determined by the refuse disposal installation. For this purpose, for example an image-based analysis can take place, such as camera-based material classification, multispectral detection, or AI-supported object recognition in passage.

In block 9460, the determined data regarding the amount of refuse are stored in a database. The unique identifier previously read out from the information carrier is thereby used as a database access key in order to enable unique assignment of the measurement data. Storage can take place either by the user device, which transmits the data directly to a central database after determination, or by the refuse disposal installation itself.

In block 9470, additional data regarding the type of contents of the individual refuse bag are stored in the same or a linked database. This information can be based on the detection in block 9452 or can be supplemented manually by user-side pre-classification, wherein the corresponding data are stored in the database by the user device.

In block 9360, the individual refuse bag is processed by the refuse disposal installation, wherein the processing is performed depending on the stored data regarding the amount of refuse and the type of contents. The processing can for example comprise assignment to a specific recovery path, implementation of a material-dependent treatment, or targeted forwarding to a downstream treatment or disposal stage. In this way, a waste-type-appropriate and data-based treatment of the individual refuse bag is enabled.

FIG. 30 shows a flow chart of an exemplary method 9500 for manufacturing refuse bags. In block 9510, a first and a second bag web are supplied in a production direction. The first bag web here has a sequence of first individual refuse bags connected to one another in a separable manner, while the second bag web correspondingly comprises second individual refuse bags connected to one another in a separable manner. The two bag webs are guided one above the other in the same direction, wherein the longitudinal axes of both webs are aligned with one another. This precise alignment enables high dimensional accuracy in the subsequent connection. For example, the respective individual refuse bags are located one above the other such that their filling openings are arranged congruently.

This applies not only to configurations having individual refuse bags of equal size, but also to variants in which the first bag web has larger individual refuse bags and the second bag web has smaller individual refuse bags, the volume of which for example is only one half, one third, one quarter, or some other fraction of the size of the larger individual refuse bags. In such cases, the bag webs are guided one above the other such that the filling openings of a plurality of small individual refuse bags on the second bag web—for example two, three, or four filling openings—are arranged together above the filling opening of a larger individual refuse bag on the first bag web in such a way that their total area substantially corresponds to the area of the filling opening of the larger individual refuse bag. The smaller filling openings thus complement one another with respect to area to form an equivalent opening unit, whereby a functional and effective connection between bag areas of different size is enabled. The geometric arrangement of the bag webs and in particular of the filling openings is consequently selected such that, even in the case of different size ratios of the bag areas, an equal-area, corresponding connection can be produced.

In block 9520, the superposed bag webs are connected section by section, whereby in each case a combined refuse bag is produced from two separable individual refuse bags. The connection takes place via a releasable connecting seam which extends optionally wholly or partially in the region of the filling openings and/or the adjoining side regions.

A first part of the connecting seam is generated by applying pressure by means of a stamp inserted into the filling opening of one of the individual refuse bags. This on the one hand enables precise placement of the connection and on the other hand prevents undesired connection of the inner walls of an individual refuse bag. This is achieved in that the stamp is used selectively for generating the releasable connecting seam—such as by pressure, heat sealing, or cold sealing—and at the same time acts as a spacer within the filling opening. The physical presence of the stamp prevents the inner walls of that individual refuse bag into which the stamp is inserted from connecting to one another. As a result, a selective connection is generated exclusively between the outer walls of the superposed bag areas, while fillability via the filling openings is maintained. Alternatively or additionally, a second part of the connecting seam is produced by a roller which exerts pressure on the side regions of the bag webs adjoining the filling opening. For this purpose, the roller could for example be equipped with corresponding pressure-applying elements.

The connection between the individual refuse bags can in each case be realized in different ways. Thus, for example, a positive-fit interlocking of the bag webs can be realized, for example by targeted deformation of material sections while creating defined recesses. In this case, for example circular or elongated openings are introduced into one bag web, into which corresponding projections, tabs, or pegs of the respectively other bag web engage. This connection principle is functionally comparable to a ring binder perforation in which superposed elements are connected to one another via punched openings and inserted holding elements. The positive fit generated in this way permits a stable, yet releasable connection, the separation force of which can be set in a targeted manner via the form and arrangement of the engagements.

Alternatively, the connection can be produced by heat sealing under the action of heat, wherein in particular a liquid-tight and gas-tight connection can be generated. This method is particularly suitable for applications involving moist, liquid, or odour-intensive refuse, since it permits permanent tight closure of the seam regions. Heat sealing is moreover widespread in the industrial manufacture of film bags. It could therefore be integrated particularly easily into existing continuous manufacturing processes—such as roll-to-roll processes—without extensive conversions or process adaptations being required.

In addition, the connection can also be produced by cold sealing by means of an adhesive previously applied. In this case, the connecting seam is produced by contact of the outer side of one bag provided with adhesive with the surface facing the other bag. The adhesive formulation can here be selected in a targeted manner such that, under defined conditions—such as by contactless energy input by action of UV, IR, or heat radiation—it loses its adhesive effect.

It is likewise conceivable that, during the application of pressure for producing the connecting seam, material of one of the bag webs is selectively removed or weakened, in particular by a punching or penetrating method, in order to facilitate later separability of the connection. In this way, a defined predetermined breaking point can already be produced within the connecting seam during manufacture, which enables low separation resistance together with secure hold in the unseparated state.

In optional block 9530, after connection of the bag webs, a defined number of manufactured refuse bags could be separated and wound up into a manageable unit. This could create an economical packaging form which can be stored, transported, and further processed easily in automated systems.

FIG. 31 shows an example of an apparatus 9600 for manufacturing refuse bags, each having two separable individual refuse bags with associated filling openings. The apparatus comprises a feed module 9610, a roller 9640, a stamp module 9660, and optionally a heat shield 9650. The apparatus is for example suitable for carrying out, fully or partially automatically, the steps described within the scope of method 9500.

The feed module 9610 is configured to transport two bag webs 9620, 9620′ in a production direction such that they are guided one above the other in the same direction and their longitudinal axes are aligned with one another. The bag webs 9620, 9620′ each consist of a sequence of individual refuse bags connected to one another in a separable manner, wherein the filling openings 9112 and 9112′, respectively (filling opening 9112′ not shown in FIG. 31), of the superposed bag areas are selectively aligned.

The roller 9640 is configured to exert pressure on the bag webs transported one above the other by the feed module 9610 in order to generate a releasable connecting seam in the side regions. This seam can in particular be produced by extensive, thermal, or mechanical action in sections in which no filling openings are present. Optionally, in conjunction with the roller, a heat shield 9650 can be provided which protects surrounding components and the bag webs against undesired heat input.

The stamp module 9660 has at least one stamp 9662 which is inserted into the filling opening of one of the bag webs. The stamp 9662 is configured to exert targeted pressure on the superposed bag webs in order to generate the releasable connecting seam between the individual refuse bags. The stamp can furthermore be embodied as heatable, so that a defined connection is achieved by the action of heat—for example heat sealing. At the same time, the inserted stamp serves as a spacer in order to avoid undesired connection of the inner walls.

It is likewise conceivable that the roller 9640 and/or the stamp 9662 is additionally equipped with a punching element, wherein the punching element is configured to selectively remove or pierce material from one of the bag webs. In this way, targeted weakening of the connecting seam can already take place during manufacture in order to form a defined separation point between the individual refuse bags. Such a preformed predetermined breaking point permits later force-optimized and controlled separation of the connected bag areas without impairing their function or tightness in the unseparated state.

Alternatively or additionally, the roller 9640 and/or the stamp 9662 can be equipped with a forming element which is configured to produce a positive-fit connection by interlocking deformation of material sections of the superposed bag webs. This can take place in particular in conjunction with generation of recesses in the bag webs, so that material tongues or tabs engage into corresponding openings.

Additionally, for example the connected bag webs could be severed at defined intervals in order to produce individual sections each having a certain number of connected refuse bags. These sections could subsequently be wound up into rolls or bundled in another manner, whereby a manageable form suitable for storage and transport is produced, which is particularly suitable for automated dispensing systems. Separation can here take place mechanically, thermally, or by an integrated cutting module and is preferably carried out such that it does not impair the previously produced connecting seams.

The apparatus 9600 illustrated in the non-limiting example of FIG. 31 is equipped with two respectively functionally identical or complementarily acting rollers 9640 and stamp modules 9660 arranged symmetrically to one another, whereby a particularly effective continuous manufacturing process in the sense of a roll-to-roll method could be realized. It is however likewise conceivable that connection of the bag webs is carried out alternatively by only one roller 9640 in combination with a passive counterpart, for example a pressure plate or a guide unit. Likewise, instead of a second heated stamp 9662, a pure spacer can be introduced into the filling openings of the second bag web in order to avoid undesired connection of the inner walls without itself contributing to generation of the connection.

The functional sections of the apparatus illustrated in FIG. 31—feeding, connecting, folding, and winding up-identify different process sections which could be continuously passed through by the bag webs. These process sections are visually delimited from one another in the illustration by the highlighted labels beneath the apparatus 9600 and illustrate the sequence of processing in successive segments.

FIG. 32 shows a schematic illustration of a further exemplary refuse bag in the filled state, in which the refuse bag areas are partially separated from one another. This example is comparable to that from FIG. 24, wherein the refuse bag shown in FIG. 32 could for example have been manufactured by an apparatus according to the example in FIG. 31. In FIG. 32, the refuse bag areas are released from one another in the upper half of their longitudinal axis, while the releasable connecting seam 9120 continues to exist in the lower half and connects the refuse bag areas to one another.

In the example shown, the releasable connecting seams 9120 have been produced by positive-fit interlocking. In this case, corresponding recesses and engagement structures have been created in the refuse bag areas—analogously to the principle of a ring binder perforation—by the interlocking deformation of which the releasable connecting seam 9120 was formed.

After partial separation of the refuse bag areas from one another, residual structures 9122, 9122′ therefore remain in the upper region on the individual refuse bags, which result from the previously positive-fit-produced connecting seam 9120. These residual structures arise when the deformed connection is torn apart and identify the former connecting line between the refuse bag areas.

A “thermolabile component”, as used within the framework of the present application, is to be understood, without limitation of generality, to mean a chemical or physical constituent structure of an adhesive which, in response to supply of thermal energy, loses its adhesive effect at least partially. The thermolabile component can for example be activated by softening, dewettability, molecular degradation, or phase transformation as a result of a temperature increase.

A “photolabile component”, as used within the framework of the present application, is to be understood, without limitation of generality, to mean a constituent of an adhesive which, upon irradiation with electromagnetic radiation, in particular light of a defined wavelength, undergoes a structural or functional change which leads to a reduction or elimination of the adhesive force. Such components typically contain photoreactive groups which, upon irradiation, trigger photochemical cleavage, rearrangement, or depolymerization reactions. A “UV-labile component” is a special embodiment of such a photolabile component in which the light-induced structural change is specifically triggered by irradiation in the UV range, typically at wavelengths between about 200 and 400 nm.

A “refuse disposal installation”, as used within the framework of the present application, is to be understood, without limitation of generality, to mean a refuse container, a refuse transporter, a refuse sorting installation, a recycling plant, or a refuse incineration plant. Likewise, stationary or mobile capture systems, automatic refuse acceptance stations, recyclable-material collection points, sorting installations, or interim storage installations for waste may also be understood thereby.

A “smartphone”, as used within the framework of the present application, is to be understood, without limitation of generality, such that the term “smartphone” comprises all electronic communication devices such as tablets or so-called wearable computers or wearables, such as smartwatches or smart glasses.

A “QR code”, as used here, is to be understood without limitation of generality as meaning that the term “QR code” includes all information carriers such as barcodes or NFC tags. The phrases “scanning a QR code”/“capturing a QR code” are also generally understood to mean reading an information carrier.

The terms “refuse” and “waste” are to be understood as synonymous within the framework of the present application.

Although the invention has been illustrated and described in detail in the drawings and in the foregoing description, such illustration and description are to be considered illustrative and not restrictive; the invention is not limited to the disclosed examples.

Other variations of the disclosed examples can be understood and effected by those skilled in the art in carrying out the claimed invention from a study of the drawings, the description, and the appended claims. In the claims, the word “comprising” does not exclude other elements or steps, and the indefinite article “a” does not exclude a plurality. The mere fact that certain features are mentioned in mutually different dependent claims does not indicate that a combination of these features cannot be advantageous. Any reference signs in the claims should not be construed as limiting the scope of protection.

Various examples may possibly be described by one or more of the following features in the following numbered clauses:

Clause A1. A refuse bag roll (1) with a plurality of refuse bags (10-1, 10-2; 10, 10′, 10″, 10′″, 10^{IV}) rolled up one after the other, which are separable from one another by material weakenings (12) extending in the transverse direction of the refuse bag roll, and wherein each of the refuse bags (10-1, 10-2; 10, 10′, 10″, 10′″, 10^{IV}, 10^{V}, 10^{VI}) has at least one filling opening for refuse and at least three refuse bag areas (16-1, 16-2; 16′-1, 16′-2; 16″-1, 16″-2; 16′″-1, 16′″-2, 16′″-3; 16^{IV}-1, 16^{IV}-2, 16^{IV}-3, 16^{IV}-4, 16^{V}-1, 16^{V}-2, 16^{V}-3, 16^{VI}-1, 16^{VI}-2, 16^{VI}-3, 16^{VI}-4), which are fillable via the at least one filling opening for the at least three refuse bag areas, wherein refuse bags lie in the refuse bag roll transversely to the longitudinal extension thereof, so that the opening side of the refuse bags points to one side, and wherein the refuse bag areas (16-1, 16-2; 16′-1, 16′-2; 16″-1, 16″-2; 16′″-1, 16′″-2, 16′″-3; 16^{IV}-1, 16^{IV}-2, 16^{IV}-3, 16^{IV}-4, 16^{V}-1, 16^{V}-2, 16^{V}-3, 16^{VI}-1, 16^{VI}-2, 16^{VI}-3, 16^{VI}-4) are each separable from the refuse bag non-destructively, so that the refuse bag areas (16-1, 16-2; 16′-1, 16′-2; 16″-1, 16″-2; 16′″-1, 16′″-2, 16′″-3; 16^{IV}-1, 16^{IV}-2, 16^{IV}-3, 16^{IV}-4, 16^{V}-1, 16^{V}-2, 16^{V}-3, 16^{VI}-1, 16^{VI}-2, 16^{VI}-3, 16^{VI}-4) form separate refuse bags after separation from the refuse bag.

Clause A2. The refuse bag roll according to clause A1, wherein each refuse bag (10, 10″) has a main bag wall (14, 14′) on which at least one connecting wall (22-1, 22-2) is provided, by means of which refuse bag areas (16-1, 16-2; 16′-1, 16′-2; 16″-1, 16″-2) are formed, wherein the at least one connecting wall extends at least in sections in the longitudinal direction, and wherein a material weakening (20, 20′, 20″) for non-destructive separation is formed on the at least one connecting wall.

Clause A3. The refuse bag roll according to clause A2, wherein the main bag wall is an outer wall and the connecting wall comprises two layers (22-1, 22-2), one of which, after separation, belongs to a first separate refuse bag and another of which belongs to a second separate refuse bag.

Clause A4. The refuse bag roll according to clause A2, wherein all connecting walls are provided side by side on one side of the main bag wall (14′).

Clause A5. The refuse bag roll according to clause A1, wherein each refuse bag (10^{IV}) comprises a plurality of individual bags (16^{IV}-1, 16^{IV}-2, 16^{IV}-3, 16^{IV}-4) providing the refuse bag areas, wherein the individual bags are attached at one side to a common strip (30).

Clause A6. The refuse bag roll according to clause A5, wherein material weakenings (20IV) are formed on the strip.

Clause A7. The refuse bag roll according to any one of clauses A1 to A6, wherein the refuse bag areas of the refuse bags are formed differently.

Clause A8. The refuse bag roll according to clause A7, wherein at least two refuse bag areas of a refuse bag are provided in different sizes.

Clause A9. The refuse bag roll according to clause A7 or A8, wherein at least two refuse bag areas of each refuse bag are provided in different colours.

Clause A10. The refuse bag roll according to any one of clauses A7 to A9, wherein at least two refuse bag areas of each refuse bag comprise different materials.

Clause A11. The refuse bag roll according to clause A10, wherein the different materials comprise at least two of plastic film, recycled plastic, compostable plastic, aluminium, paper, cellulose and hemp.

Clause A12. The refuse bag roll according to any one of the preceding clauses, wherein at least one refuse bag is different from other refuse bags.

Clause A13. The refuse bag roll, according to any one of the preceding clauses, wherein each refuse bag (10^{V}) comprises a plurality of individual bags (16^{VII}-1, 16^{VII}-2, 16^{VII}-3, 16^{VII}-4), which provide the refuse bag areas, wherein the individual bags are connected to a material projection (32) at least in a region on a side adjacent to the filling opening.

Clause A14. The refuse bag roll according to clause A13, wherein at least one of the individual bags has a folded bottom or a cross bottom on the side opposite the filling opening.

Clause A15. The refuse bag roll according to any one of clauses A13 or A14, wherein the outer and/or the inner individual bag in the rolled-up form of the refuse bag roll has a connecting element which is configured to be able to releasably connect the outer and the inner individual bag to one another, in particular one of the two individual bags has an adhesive surface, in particular provided with a removable protective layer.

Clause A16. The refuse bag roll according to any one of clauses A13 to A15, wherein at least one of the individual bags has a hole formed on the side opposite the connection to the material protrusion or a fastening element is provided, in particular an adhesive surface or a loop.

Clause A17. The refuse bag roll according to any one of clauses A13 to A16, wherein the material projection on the side of the filling openings has a handle element, in particular a loop.

Clause A18. The refuse bag roll according to any one of the preceding clauses, wherein at least one refuse bag and/or at least one refuse bag area has a device-readable information carrier, wherein the information carrier is in particular a QR code.

Clause A19. The refuse bag roll according to clause A18, wherein the information carrier is configured to be able to cause a device reading the information carrier to output text information, to install or execute a software, to call up a website, or to execute combinations thereof.

Clause A20. A refuse disposal system comprising a refuse bag roll according to any one of clauses A18 or A19 and a portable electronic communication device, in particular a smartphone, wherein the portable electronic communication device comprises means for reading the information carrier and means for outputting information, and wherein the portable electronic communication device is configured to be prompted, by reading the information carrier, to output text information and/or to install or execute a software and/or to call up a website.

Clause A21. The refuse disposal system according to clause A20, wherein by outputting the text information and/or executing the software and/or calling up the website, information on regulations on refuse disposal and/or information on refuse collection is output.

Clause A22. The refuse disposal system according to any one of clauses A20 or A21, wherein the portable electronic communication device has means for determining a device location and is configured to determine the device location before outputting the regulations for refuse disposal and/or the instructions for refuse collection and to be able to output the instructions for regulations for refuse disposal and/or the instructions for refuse collection depending on the determined device location.

Clause A23. The refuse disposal system according to any one of clauses A20 to A22, wherein the calling up of the website and/or the execution of the software initiated by reading the information carrier also comprises the entry of a value in a database.

Clause A24. The refuse disposal system according to any one of clauses A20 to A23, wherein calling up the website and/or executing the software also comprises executing a refuse disposal analysis application, wherein the refuse disposal analysis application is configured to be able to analyze the disposal of the refuse, in particular on the basis of user information or the entries in the database, depending on the regulations for refuse disposal.

Clause A25. The refuse disposal system according to any one of clauses A20 to A24, wherein calling up the website and/or executing the software also comprises executing a visual identification application, wherein the visual identification application is configured to be able to identify refuse items located on visual images.

Clause A26. The refuse disposal system according to clause A25, wherein, in the event that calling up the website and/or executing the software also comprises executing a refuse disposal analysis application, the disposal of the refuse is alternatively or additionally analyzed using the identified refuse items.

Clause A27. A method for disposing of refuse, comprising the steps of:
providing a refuse bag (10, 10′, 10″, 10″′, 10IV) having at least two compartments (16-1, 16-2; 16′-1, 16′-2; 16″-1, 16″-2; 16″′-1, 16″′-2, 16″′-3; 16^{IV}-1, 16^{IV}-2, 16^{IV}-3, 16^{IV}-4) of the refuse bag roll according to any one of clauses A1 to A19,
filling at least one of the compartments,
separating the filled compartment from the rest of the refuse bag,
feeding the filled compartment to a refuse disposal facility, in particular by placing it in a disposal container.

Clause A28. The method according to clause A27 with the additional steps of:
providing a refuse disposal system according to any one of clauses A20 to A26,
reading the information carrier,
wherein the filled compartment is fed to a refuse disposal system depending on the regulations for refuse disposal and/or the instructions for refuse collection.

Clause A29. The method for providing a refuse bag roll according to any one of clauses A1 to A19, in which a user group and/or a usage period is determined, for the user group and/or the usage period it is estimated on the basis of measurements which types of refuse occur in which quantities and a manufacturing instruction for a refuse bag roll is specified from at least two possible manufacturing instructions for different refuse bag rolls according to any one of clauses A1 to A19, in such a way that the refuse bag areas of the refuse bags have colours and/or dimensions matching the estimated quantities, and the refuse bag roll (1) is manufactured according to the specified manufacturing instruction.

Clause B1. Refuse bag (100) having at least one filling opening for refuse and at least two refuse bag areas (110, 110′), which are fillable via the at least one filling opening for the at least two refuse bag areas (110, 110′), wherein the refuse bag areas (110, 110′) are each separable from the refuse bag (100) non-destructively, so that the refuse bag areas (110, 110′) each form separate individual refuse bags (111, 111′) after separation from the refuse bag (100), wherein a plurality of the at least two refuse bag areas (110, 110′) each have a device-readable information carrier (120, 120′), wherein at least one of the device-readable information carriers (120, 120′) is readable only after at least partial separation of one of the refuse bag areas (110, 110′).

Clause B2. Refuse bag (100) according to clause B1, wherein the one of the device-readable information carriers (120, 120′) is non-volatilely writable only after at least partial separation of one of the refuse bag areas (110, 110′).

Clause B3. Refuse bag (100) according to either of clauses B1 or B2, wherein the one of the device-readable information carriers (120, 120′) is arranged on an outer wall of one of the refuse bag areas (110, 110′) that faces another of the refuse bag areas (110, 110′).

Clause B4. Refuse bag (100) according to clause B3, wherein the one of the device-readable information carriers (120, 120′) is arranged in a cavity formed by a wall of the one refuse bag area (110, 110′) and/or a wall of the other refuse bag area (110, 110′), in particular wherein the cavity has an opening on a side facing away from the filling opening or is closed on all sides.

Clause B5. Refuse bag (100) according to any one of the preceding clauses, having a read and/or write protection element (130), wherein the read and/or write protection element (130) shields the one of the device-readable information carriers (120, 120′) against optical and/or magnetic and/or electromagnetic read-out.

Clause B6. Refuse bag (100′) having a device-readable information carrier (120, 120′, 120″), in particular a contactlessly writable information carrier, wherein the information carrier (120, 120′, 120″) is configured to receive and non-volatilely store data regarding the contents of the refuse bag (100) from a user device (140), in particular wherein the information carrier (120, 120′, 120″) is an RFID transponder, in particular an NFC chip.

Clause B7. Refuse bag (100″) having a device-readable information carrier (120, 120′, 120″), in particular an optically readable information carrier, wherein the information carrier (120, 120′, 120″) is configured to cause a user device (140), as a result of reading the information carrier (120, 120′, 120″), to store data regarding the contents of the refuse bag (100) in a database, in particular wherein the device-readable information carrier (120, 120′, 120″) is a barcode, in particular a QR code.

Clause B8. Refuse bag (100″′) according to either of clauses B6 or B7, having at least one filling opening for refuse and at least two refuse bag areas (110, 110′), which are fillable via the at least one filling opening for the at least two refuse bag areas (110, 110′), wherein the refuse bag areas (110, 110′) are each separable from the refuse bag (100″′) non-destructively, so that the refuse bag areas (110, 110′) each form separate individual refuse bags (111, 111′) after separation from the refuse bag (100″′), wherein the device-readable information carrier (120, 120′, 120″) is arranged on a first of the at least two refuse bag areas (110, 110′), and wherein additionally at least one further of the at least two refuse bag areas (110, 110′) has a device-readable information carrier (120, 120′, 120″).

Clause B9. Method (200) for disposing of refuse, comprising:
providing a refuse disposal installation (150) having a reading device (152),
providing a refuse bag (100′) according to clause B6,
providing a user device (140), wherein the user device (140) has means for sending data regarding the contents of the refuse bag (100) to the information carrier (120, 120′, 120″),
filling the refuse bag (100′) by a user with refuse,
sending data regarding the contents of the refuse bag (100′) by the user device (140) to the information carrier (120, 120′, 120″),
receiving the data regarding the contents of the refuse bag (100′) by the information carrier (120, 120′, 120″),
non-volatilely storing the received data on the information carrier (120, 120′, 120″),
supplying the filled refuse bag (100′) to the refuse disposal installation (150),
reading the information carrier (120, 120′, 120″) of the supplied refuse bag (100′) by the refuse disposal installation (150) with the aid of the reading device (152) in order to determine the data stored in the information carrier (120, 120′, 120″) regarding the contents of the refuse bag (100′),
processing the supplied refuse bag (100′) by the refuse disposal installation (150), wherein the processing takes place depending on the determined data regarding the contents of the refuse bag (100′).

Clause B10. Method for disposing of refuse, comprising:
providing a refuse disposal installation (150) having a reading device (152),
providing a refuse bag (100″) according to clause B7, wherein a unique identifier is stored in the information carrier (120, 120′, 120″),
providing a user device (140), wherein the user device (140) has means for reading the information carrier (120, 120′, 120″) and means for storing data regarding the contents of the refuse bag (100″) in a database,
filling the refuse bag (100″) with refuse by a user,
reading the information carrier (120, 120′, 120″) by the user device (140) in order to determine the unique identifier stored in the information carrier (120, 120′, 120″),
storing data regarding the contents of the refuse bag (100″) in a database by the user device (140) using the determined unique identifier as a database access key, in particular wherein the database is a distributed ledger, in particular a blockchain,
supplying the filled refuse bag (100″) to the refuse disposal installation (150),
reading the information carrier (120, 120′, 120″) by the refuse disposal installation (150) with the aid of the reading device (152) in order to determine the unique identifier stored in the information carrier (120, 120′, 120″),
retrieving the data stored in the database regarding the contents of the refuse bag (100″) by the refuse disposal installation (150) on the basis of the determined unique identifier,
processing the refuse bag (100″) by the refuse disposal installation (150), wherein the processing takes place depending on the data retrieved from the database.

Clause B11. Method according to either of clauses B9 or B10, wherein in the step of providing the refuse bag, a refuse bag (100″′) according to clause B8 is provided, wherein in the step of filling the provided refuse bag (100″′),the first of the at least two refuse bag areas (110, 110′) is filled, wherein the first refuse bag area (110, 110′) is separated in order to form a separate individual refuse bag (111, 111′), and wherein the data regarding the contents of the refuse bag are data regarding the contents of the separate individual refuse bag (111, 111′) formed by the separation, and wherein the refuse bag (111, 111′) that is supplied to the refuse disposal installation (150), the data of which are retrieved from the database, and which is processed by the refuse disposal installation (150), is the separate individual refuse bag (111, 111′).

Clause B12. Method according to any one of clauses B9 to B11, comprising the additional steps of:
providing an electronic account system, wherein in the electronic account system a user account is uniquely assigned to a user and wherein the electronic account system is connected to the refuse disposal installation (150),
identifying the user by the refuse disposal installation (150) in order to determine the user account uniquely assigned to the user in the account system,
assigning the refuse bag (100) supplied to the refuse disposal installation (150) and the data regarding its contents to the determined user account by the refuse disposal installation (150) by means of an entry in the electronic account system,
in particular the method comprises the following:
outputting a message to the user by the user device (140) or the refuse disposal installation (150) indicating that the supplied refuse bag (100) has been assigned to the user account, in particular wherein the message contains information as to which contents have been assigned to the refuse bag (100).

Clause B13. Method according to clause B12, wherein the electronic account system comprises a distributed ledger, in particular a blockchain, wherein the entry in the electronic account system is generated or secured using a cryptographically secured token.

Clause B14. Refuse bag roll (160, 700) having a plurality of refuse bags (100-1, 100-2) rolled up one after the other according to any one of clauses B1 to B8, wherein the refuse bags (100-1, 100-2) are separable from one another by material weakenings (710) extending in the transverse direction of the refuse bag roll (160, 700) and wherein the refuse bags (100-1, 100-2) lie in the refuse bag roll (160, 700) transversely to the longitudinal extension thereof, so that the opening side of the refuse bags (100-1, 100-2) points to one side.

Clause B15. Refuse disposal system (170, 800) comprising a refuse bag (100, 100′, 100″, 100″′) according to any one of clauses B1 to B8 and a user device (140), wherein the user device (140) has means for reading the information carrier (120, 120′, 120″) and additionally has means for sending data regarding the contents of the refuse bag (100) to the information carrier (120, 120′, 120″) and/or additionally has means for storing data regarding the contents of the refuse bag (100, 100′, 100″, 100′″) in a database, in particular wherein the database is a distributed ledger, in particular a blockchain.

Clause C1 Refuse bag (100) having at least one filling opening (111) for refuse and at least two refuse bag areas (110, 110′), which are fillable via the at least one filling opening (111) for the at least two refuse bag areas (110, 110′), wherein the refuse bag areas (110, 110′) are each separable from the refuse bag (100) non-destructively, so that the refuse bag areas (110, 110′) each form separate individual refuse bags after separation from the refuse bag (100), wherein the refuse bag areas (110, 110′) are connected to one another by a releasable adhesive bond (120), which comprises an adhesive, wherein the releasable adhesive bond (120) is releasable by contactless energy input, in particular by action of electromagnetic radiation, in particular UV, IR, or microwave radiation, wherein the contactless energy input causes a chemical reaction with at least partial degradation of the adhesive and/or a phase transition and/or a reduction in viscosity and/or a change in crystallinity and/or a change in surface tension of the adhesive.

Clause C2 Refuse bag according to clause C1, wherein the releasable adhesive bond (120) is arranged in a section of that side of the refuse bag areas (110, 110′) on which their filling opening (112, 112′) is located and/or wherein the releasable adhesive bond (120) is arranged in a section of one of those sides of the refuse bag areas (110, 110′) which adjoin the side on which the filling opening (112, 112′) is located.

Clause C3 Refuse bag according to any one of clauses C1 or C2, wherein the adhesive comprises a thermolabile component and/or a photolabile component, in particular a UV-labile component.

Clause C4 Refuse bag according to clause C3, wherein the thermolabile component comprises a polymer selected from the group consisting of polyvinyl acetate, polycaprolactone, polyethylene, ethylene-vinyl acetate, polypropylene, polystyrene, polylactide, polybutylene adipate-co-terephthalate, and polyurethane, and/or wherein the photolabile component comprises a polymer having a functional group selected from the group consisting of o-nitrobenzyl, o-nitroveratryl, p-hydroxyphenacyl, cinnamate, coumarin, benzoin ester, and/or azo groups.

Clause C5 Refuse bag according to any one of clauses C1 or C2, wherein the adhesive comprises a polymeric adhesive component based on polyurethanes and/or polyureas and/or epoxy resins and an additive component, wherein the additive component comprises a functional group that is activatable by energy input such that a chemical reaction with the polymeric adhesive component takes place with at least partial degradation of the polymeric adhesive component.

Clause C6 Refuse bag (200) having at least one filling opening (111) for refuse and at least two refuse bag areas (210, 210′), which are fillable via the at least one filling opening (111) for the at least two refuse bag areas (110, 110′), wherein the refuse bag areas (110, 110′) are each separable from the refuse bag (200) non-destructively, so that the refuse bag areas (210, 210′) each form separate individual refuse bags after separation from the refuse bag (200), wherein the refuse bag areas (210, 210′) are connected to one another by magnetically acting elements (220, 220′).

Clause C7 Refuse bag according to clause C6, wherein the magnetically acting elements (220, 220′) are each arranged in a section of that side of the refuse bag areas (210, 210′) on which their filling opening (112, 112′) is located and/or wherein the magnetically acting elements (220, 220′) are arranged in a section of one of those sides of the refuse bag areas (210, 210′) which adjoin the side on which the filling opening (112, 112′) is located.

Clause C8 Refuse bag according to any one of clauses C6 or C7, wherein the magnetically acting elements (220, 220′) are formed by a layer which comprises magnetic particles and which is applied at least in sections to the refuse bag areas (210, 210′), or wherein the magnetically acting elements (220, 220′) are formed by magnetic particles which are contained at least in sections in the material of which the refuse bag areas (110, 110′) consist.

Clause C9 Method for disposing of refuse, comprising:
providing a refuse bag according to any one of clauses C1 to C5,
filling the refuse bag with refuse by a user, wherein the at least two refuse bag areas are each filled with refuse of a different type,
supplying the filled refuse bag to a refuse disposal installation,
releasing the adhesive bond by contactless energy input, in particular by action of UV radiation, IR radiation, or microwave radiation,
separating the at least two refuse bag areas to obtain separate individual refuse bags,
processing the separate individual refuse bags by the refuse disposal installation, wherein the processing is performed depending on the type of refuse with which the respective individual refuse bag is filled.

Clause C10 Method for disposing of refuse, comprising:
providing a refuse bag according to any one of clauses C1 to C8, wherein at least one of the at least two refuse bag areas has a device-readable information carrier, wherein a unique identifier is stored in the information carrier,
filling the refuse bag with refuse by a user,
supplying the filled refuse bag to a refuse disposal installation having a reading device and separating the at least two refuse bag areas by the refuse disposal installation in order to obtain that separate individual refuse bag which has the device-readable information carrier, or separating the at least two refuse bag areas by the user in order to obtain that separate individual refuse bag which has the device-readable information carrier, and supplying this separate individual refuse bag to a refuse disposal installation having a reading device,
reading the information carrier by the reading device of the refuse disposal installation in order to determine the unique identifier stored in the information carrier,
determining the amount of refuse contained in the individual refuse bag, in particular by weighing, volume measurement, or image-based analysis,
storing data regarding the determined amount of refuse in a database using the determined unique identifier as a database access key,
processing the individual refuse bag by the refuse disposal installation, wherein the processing is performed depending on the stored data regarding the amount of refuse.

Clause C11 Method according to clause C10, further comprising the additional steps of:
providing a user device, wherein the user device has means for reading the information carrier and means for storing data regarding the type of contents of the individual refuse bag in a database, and
reading the information carrier by the user device in order to determine the unique identifier stored in the information carrier, and
storing data regarding the contents of the individual refuse bag by the user in a database by means of the user device using the determined unique identifier as a database access key,
   and/or
determining the type of contents of the individual refuse bag by the refuse disposal installation, in particular by image-based analysis or sensor-based material recognition, in particular by spectroanalytic methods, and
storing data regarding the determined type of contents of the individual refuse bag by the refuse disposal installation in a database using the determined unique identifier as a database access key,
wherein the individual refuse bag is processed by the refuse disposal installation, wherein the processing is performed depending on the stored data regarding the amount of refuse and the type of contents of the individual refuse bag.

Clause C12 Method for manufacturing refuse bags which have a first and a second individual refuse bag, wherein the first and the second individual refuse bag are separable from one another non-destructively and each have a filling opening, comprising:
feeding a first bag web and a second bag web in a production direction, wherein the first bag web comprises first individual refuse bags connected to one another in a separable manner and the second bag web comprises second individual refuse bags connected to one another in a separable manner, wherein the two bag webs are guided one above the other in the same direction and the longitudinal axes of the bag webs are aligned with one another,
connecting the bag webs section by section by a releasable connecting seam, wherein a first part of the releasable connecting seam extends in a section of that side of the individual refuse bags on which their filling opening is located, wherein the first part of the releasable connecting seam is generated by applying pressure by means of a stamp, wherein the stamp is inserted into the filling opening of one of the individual refuse bags,
   and/or
wherein a second part of the releasable connecting seam extends in a section of one of those sides of the individual refuse bags which adjoin the side on which the filling opening is located, wherein the second part of the connecting seam is generated by applying pressure by means of a roller,
wherein the application of pressure in each case
causes interlocking deformation of material sections of the superposed bag webs, thereby producing a positive-fit connection, in particular in conjunction with generating recesses in the bag webs, and/or
is performed under the action of heat, and/or
is performed using an adhesive which is applied before connecting to the outer wall of one of the individual refuse bags that faces the other individual refuse bag.

Clause C13 Method according to clause C12, wherein, during the application of pressure, material of one of the bag webs is removed or pierced, in particular by punching, in order to weaken the releasable connecting seam.

Clause C14 Apparatus (600) for manufacturing refuse bags which have a first and a second individual refuse bag, wherein the first and the second individual refuse bag are separable from one another non-destructively and each have a filling opening, comprising:
a feed module (610), wherein the feed module (610) is configured to be able to transport first and second bag webs (620, 620′) in a production direction such that the bag webs (620, 620′) are guided one above the other in the same direction and the longitudinal axes of the bag webs (620, 620′) are aligned with one another, wherein each bag web (620, 620′) comprises individual refuse bags connected to one another in a separable manner,
a roller (640), wherein the roller (640) is configured to be able to exert pressure on the superposed bag webs (620, 620′) transported by the feed module (610) in order to generate a releasable connecting seam (120) section by section between the bag webs (620, 620′), and
a stamp module (660), wherein the stamp module (660) is configured to be able to insert a stamp (662) into the filling opening (112, 112′) of one of the individual refuse bags and to be able to exert pressure via the stamp (662) on the superposed bag webs (620, 620′) transported by the feed module (610), in particular wherein the stamp (662) is heatable.

Clause C15 Apparatus according to clause C14, wherein the roller (640) and/or the stamp (662) additionally comprises a punching element, wherein the punching element is configured to remove or pierce material from a bag web (620, 620′), and/or wherein the roller (640) and/or the stamp (662) additionally comprises a forming element, wherein the forming element is configured to produce a positive-fit connection by interlocking deformation of material sections of the superposed bag webs (620, 620′), in particular in conjunction with generating recesses in the bag webs (620, 620′).

1. A refuse bag having at least one filling opening for refuse and at least two refuse bag areas that are fillable via the at least one filling opening, wherein the refuse bag areas are each separable from the refuse bag non-destructively, such that the refuse bag areas form separate refuse bags after separation from the refuse bag.

2. The refuse bag of claim 1, wherein a plurality of the at least two refuse bag areas each have a device-readable information carrier, and wherein at least one of the device-readable information carriers is readable only after at least partial separation of one of the refuse bag areas from the refuse bag.

3. The refuse bag of claim 2, wherein the at least one device-readable information carrier that is readable only after at least partial separation of one of the refuse bag areas from the refuse bag is arranged in a cavity formed by a wall of one of the refuse bag areas and a wall of another one of the refuse bag areas.

4. The refuse bag of claim 3, wherein the cavity has an opening on a side facing away from the filling opening or is closed on all sides.

5. The refuse bag of claim 2, further comprising a read and/or write protection element, wherein the read and/or write protection element prevents optical, magnetic, or electromagnetic read-out of, or write access to, at least one of the device-readable information carriers.

6. The refuse bag of claim 1, further comprising a writable information carrier configured to receive and non-volatilely store data regarding contents of the refuse bag from a user device.

7. The refuse bag of claim 1, further comprising a contactlessly readable information carrier configured to cause a user device, in response to reading the information carrier, to store data regarding contents of the refuse bag in a database.

8. The refuse bag of claim 1, wherein the refuse bag areas are connected by a releasable adhesive bond comprising an adhesive, wherein the releasable adhesive bond is releasable by contactless energy input, and wherein the contactless energy input causes at least one of the following: a chemical reaction resulting in at least partial degradation of the adhesive, a phase transition, a reduction in viscosity, a change in crystallinity, or a change in surface tension of the adhesive.

9. The refuse bag of claim 8, wherein the adhesive comprises at least one of: a thermolabile component; or a photolabile component.

10. The refuse bag of claim 9, wherein the thermolabile component comprises a polymer selected from the group consisting of polyvinyl acetate, polycaprolactone, polyethylene, ethylene-vinyl acetate, polypropylene, polystyrene, polylactide, polybutylene adipate-co-terephthalate, and polyurethane, or the photolabile component comprises a polymer having a functional group selected from the group consisting of o-nitrobenzyl, o-nitroveratryl, p-hydroxyphenacyl, cinnamate, coumarin, benzoin ester, and azo groups.

11. The refuse bag of claim 1, wherein the refuse bag areas are connected by magnetically acting elements.

12. A refuse disposal system comprising:
a refuse bag of claim 6 and a user device comprising means for sending data regarding contents of the refuse bag to the information carrier; or
a refuse bag of claim 7 and a user device comprising means for reading the information carrier and for storing data regarding contents of the refuse bag in a database.

13. The refuse disposal system of claim 12, wherein the user device comprises the means for reading the information carrier and the means for storing data regarding contents of the refuse bag in the database, and wherein the database comprises a distributed ledger.

14. A method for disposing of refuse, comprising:
providing a refuse bag according to any one of claims 1 to 11;
providing a refuse disposal installation;
filling the refuse bag with refuse by a user, wherein the at least two refuse bag areas are each filled with refuse of a different type;
separating the at least two refuse bag areas to obtain separate refuse bags;
processing the separate refuse bags by the refuse disposal installation, wherein the processing is performed depending on the type of refuse with which the respective separate refuse bag is filled.

15. The method of claim 14, further comprising:
providing a refuse disposal system according to claim 12, the refuse disposal system comprising a refuse bag of claim 7 and a user device comprising means for reading the information carrier and for storing data regarding contents of the separate refuse bag in a database;
wherein the refuse disposal installation comprises means for retrieving data stored in the database regarding contents of the separate refuse bag,
reading the information carrier by the user device in order to determine a unique identifier stored in the information carrier;
storing data regarding contents of the separate refuse bag in the database by the user device using the determined unique identifier as a database access key;
reading the information carrier of the supplied separate refuse bag by the refuse disposal installation;
determining the unique identifier stored in the information carrier, and retrieving the data stored in the database regarding contents of the separate refuse bag on the basis of the determined unique identifier;
wherein the type of refuse with which the respective separate refuse bag is filled is determined from the data retrieved from the database.

16. The method of claim 14, further comprising:
providing a refuse disposal system according to claim 12, the refuse disposal system comprising a refuse bag of claim 6 and a user device comprising means for sending data regarding contents of the separate refuse bag to the information carrier;
wherein the refuse disposal installation comprises means for reading the information carrier,
sending data regarding contents of the separate refuse bag by the user device to the information carrier;
receiving the data regarding contents of the separate refuse bag by the information carrier;
non-volatilely storing the received data on the information carrier, reading the information carrier of the supplied separate refuse bag by the refuse disposal installation;
determining the data stored in the information carrier regarding contents of the separate refuse bag,
wherein the type of refuse with which the respective separate refuse bag is filled is determined from the data stored in the information carrier.

17. The method of claim 14, further comprising:
providing an electronic account system, wherein in the electronic account system a user account is uniquely assigned to a user and wherein the electronic account system is connected to the refuse disposal installation;
identifying the user by the refuse disposal installation in order to determine the user account uniquely assigned to the user in the account system;
assigning the refuse bag supplied to the refuse disposal installation and the data regarding its contents to the determined user account by the refuse disposal installation by means of an entry in the electronic account system.

18. Method according to claim 17, wherein the electronic account system comprises a distributed ledger, wherein the entry in the electronic account system is generated or secured using a cryptographically secured token.

19. The method of claim 14, wherein a refuse bag according to any one of claims 8 to 10 is provided, wherein the filled refuse bag is supplied to the refuse disposal installation, and wherein the adhesive bond is released by the refuse disposal installation by contactless energy input.

20. The method of claim 19, wherein the contactless energy input is performed by action of UV radiation, IR radiation, or microwave radiation.
